(19) United States
(12) Patent Application Publication
(10) Pub. No.: US 2016/0364683 A1
(43) Pub. Date: Dec. 15, 2016

(54) Parts Validation and Mobile Sales Application

(71) Applicant: Caterpillar Inc., Peoria, IL (US)

(72) Inventors: Andrea Lyons, Dunlap, IL (US); Patrick Kozlowski, Peoria, IL (US); Ryan Rochel, Metamora, IL (US); Edward Betts, Chillicothe, IL (US)

(73) Assignee: Caterpillar Inc., Peoria, IL (US)

(21) Appl. No.: 14/739,174

(22) Filed: Jun. 15, 2015

(51) Int. Cl. G06Q 10/08; G06Q 30/00

(52) U.S. Cl. CPC G06Q 10/087; G06Q 30/018

(57) ABSTRACT

A system and method for identifying and validating compatible ground engaging tool parts, the system and method including an electronic device operable to execute computer instructions in order to receive a first user data input including at least a work machine type, retrieve machine attachment parts information associated with the work machine type in response to the first user data input, and display the machine attachment parts information associated with the work machine type. The electronic device is further operable to execute computer instructions in order to receive a second user data input based on a selection of one button of the at least one button representing the one attachment part; retrieve ground engaging tool parts associated with the one attachment part in response to the second user data input; and display the ground engaging tool parts information associated with the one attachment part.

### TECHNICAL FIELD

The present disclosure relates generally to identifying and validating wear parts, and more particularly, to systems, methods, and user interfaces for identifying and validating ground engaging tool parts that are compatible with an operator selected machine type and associated attachment for the selected machine type.

### BACKGROUND

Machines are made of up of various parts and components. Some of these parts or components wear down over time due to normal use, or due to damage, and may need to be replaced. For example, tips for an excavator bucket may wear down or chip due to repetitive use and may need to be replaced for optimal performance. However, manufacturers may produce and support a vast number of work machines with different product types, models, and configurations, leading to a complex catalog of replacement parts.

Due to the nature of wear components, part numbers are typically not legible after the part has been used and equipment owners may not know which parts or tool attachments came with their original equipment. Due to the vast catalog of machines and associated parts, dealer networks may not have the bandwidth or capacity to fully support and assist each and every equipment owner with identification of compatible parts or tools for their machines. This may result in incorrect parts being purchased, less than optimal parts being selected and used for a particular work machine, or extended down time of the work machine while proper parts are identified and validated.

### SUMMARY

According to one aspect, the disclosure describes a method of identifying and validating a replacement part with an electronic device. The method may include a step of receiving, via an input of the electronic device, a first user data input including at least a work machine type; a step of retrieving, using a processor of the electronic device, machine attachment parts information associated with the work machine type in response to the first user data input; and a step of displaying, using an output of the electronic device, the machine attachment parts information associated with the work machine type, the displaying of the machine attachment parts information includes generating and showing at least one button representing at least one attachment part of the retrieved machine attachment parts information. The method may include a step of receiving, via the input of the electronic device, a second user data input based on a selection of one button of the at least one button representing the one attachment part; a step of retrieving, using the processor of the electronic device, ground engaging tool parts associated with the one attachment part in response to the second user data input; and a step of displaying, using the output of the electronic device, the ground engaging tool parts information associated with the one attachment part, the displaying of the ground engaging tool parts information includes generating and showing at least one button representing one ground engaging tool part.

According to another aspect, the disclosure describes an electronic device for identifying and validating a replacement part. The electronic device may include an input unit to receive inputs from an operator, an output unit to display information, a storage unit or memory to store computer instructions, and a processor coupled with the input unit, the output unit, and the storage unit or memory. The processor of the electronic device may be configured to execute the computer instructions to: receive, via the input unit, a first user data input including at least a work machine type; retrieve, from the storage unit or memory, machine attachment parts information associated with the work machine type in response to the first user data input; and display, using an output unit, the machine attachment parts information associated with the work machine type, wherein the displaying of the machine attachment parts information includes generating and showing at least one button representing at least one attachment part of the retrieved machine attachment parts information. The processor of the electronic device may be configured to: receive, via the input unit, a second user data input based on a selection of one button of the at least one button representing the one attachment part; retrieve, from the storage unit or memory, ground engaging tool parts associated with the one attachment part in response to the second user data input; and display, using the output unit, the ground engaging tool parts information associated with the one attachment part, wherein the displaying of the ground engaging tool parts information includes generating and showing at least one button representing one ground engaging tool part.

### BRIEF DESCRIPTION OF THE DRAWINGS

FIG. 1 shows a parts validation and mobile sales application system in accordance with aspects of the present disclosure.

FIG. 2 shows a block diagram of a computing system associated with a server of the parts validation and mobile sales application system in accordance with aspects of the present disclosure.

FIG. 3 shows a block diagram of a computing system associated with a user device of the parts validation and mobile sales application system in accordance with aspects of the present disclosure.

FIG. 4 shows a block diagram of a computing system associated with a dealer device of the parts validation and mobile sales application system in accordance with aspects of the present disclosure.

FIG. 5 shows a flowchart of an exemplary method of performing parts validation and sales in accordance with aspects of the present disclosure.

FIGS. 6-35 show GUI displays configured for a landscape viewing orientation in accordance with aspects of the present disclosure.

FIGS. 36-68 show GUI displays configured for a portrait viewing orientation in accordance with aspects of the present disclosure.

FIGS. 69-80 show GUI displays relating to excavator equipment in accordance with aspects of the present disclosure.

FIGS. 80-88 show GUI displays relating to the track type tractors equipment in accordance with aspects of the present disclosure.

FIGS. 89-97 show GUI displays relating to the motor grader equipment in accordance with aspects of the present disclosure.

FIGS. 98-109 show GUI displays relating to the wheel loader equipment in accordance with aspects of the present disclosure.

FIGS. 110 and 111 show GUI displays relating to an additional information feature.

### DETAILED DESCRIPTION

Aspects of the disclosure will now be described in detail with reference to the drawings, wherein like reference numerals refer to like elements throughout, unless specified otherwise.

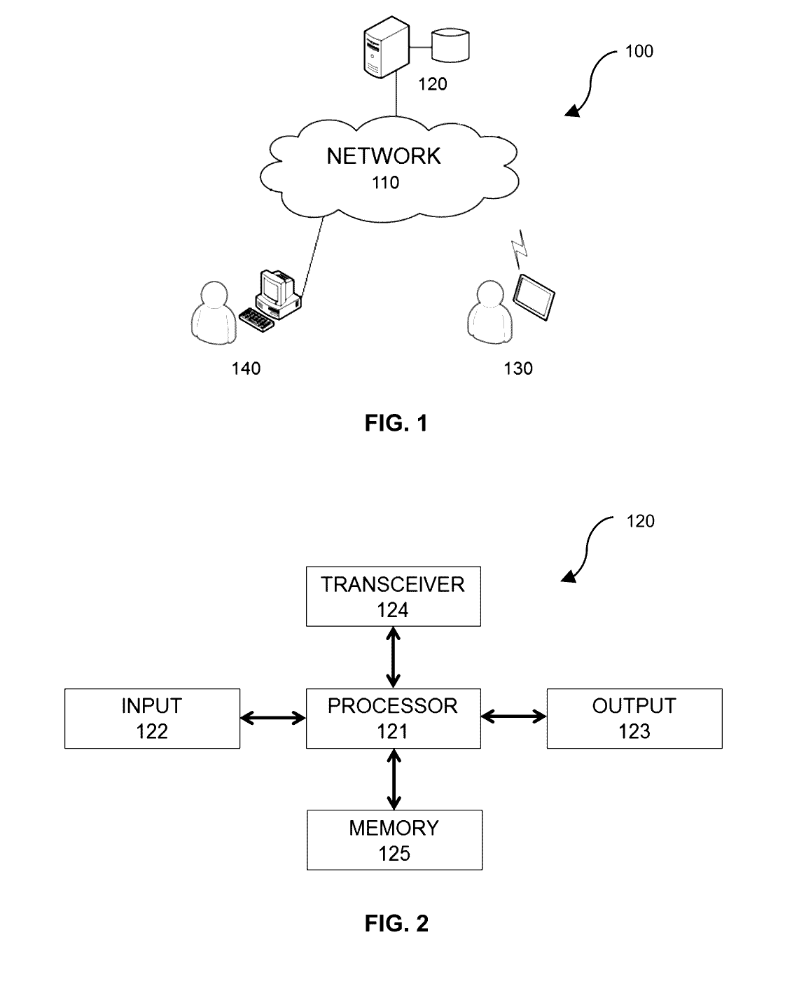

FIG. 1 shows a parts validation and mobile sales system 100, which may include one or more of a network 110, at least one server 120, at least one user device 130, and at least one dealer device 140. In one aspect, the at least one server 120, the at least one user device 130, and the at least one dealer device 140 may connect with one another via the network 110. The network 110 may comprise the Internet and connection to the network 110 may include one or more types of connection channels, including but is not limited to, cellular, wireless, optical, Ethernet, satellite, etc. The server 120 may serve as an application server and may enable the user device 130 to download computer instructions or executable applications stored on or hosted by the server 120. The user device 130 may be a mobile electronic device such as a mobile phone, a tablet, or a laptop computer. The server 120 may host a parts database with parts information which may be accessed remotely while the user device 130 is executing the computer instructions or the executable application. The server 120 may host parts data files which may be downloaded onto the user device 130 and usable while the user device 130 is executing the computer instructions or the executable application. The parts data files may include machine attachment parts information and/or ground engaging tool information. Of course, it is contemplated that multiple servers may be employed to serve separate functions, such as a dedicated server for hosting the downloadable computer instructions or software application, and a separate server for hosting the parts database or downloadable parts data files.

FIG. 2 is a block diagram of a computing system associated with the server 120 according to aspects of the disclosure. The server 120 may comprise a processor 121, one or more inputs 122, one or more outputs 123, one or more transceivers 124, and memory 125. The one or more inputs 122 may include a keyboard, mouse, touchscreen, microphone, or any other suitable input mechanism. The one or more outputs 123 may include a display screen and an audio speaker. The output 123 may display information relating to the computer instructions, the executable applications, the parts database and/or the parts data files, which may be stored on the memory 125 of the server 120. The memory 125 may comprise mass storage devices for storing data files. The mass storage devices may include magnetic disks, such as internal hard disks and removable disks; a magneto-optical disks; and optical disks. Suitable storage devices for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM disks.

In one aspect, the memory 125 may store instructions or data that the processor 121 may execute to carry out one or more aspects of the present disclosure. The transceiver 124 may transmit information such as the computer instructions, the executable applications, the parts database, and/or the parts data files to one or more of the user device 130 and the dealer device 140. The transceiver 124 may receive information from one or more of the user device 130 and the dealer device 140 to process requests. The transceiver 124 may transmit the requests to the processor 121, and the processor 121 may process the request information, store the request information in the memory 125, and/or output the request information using the output 123.

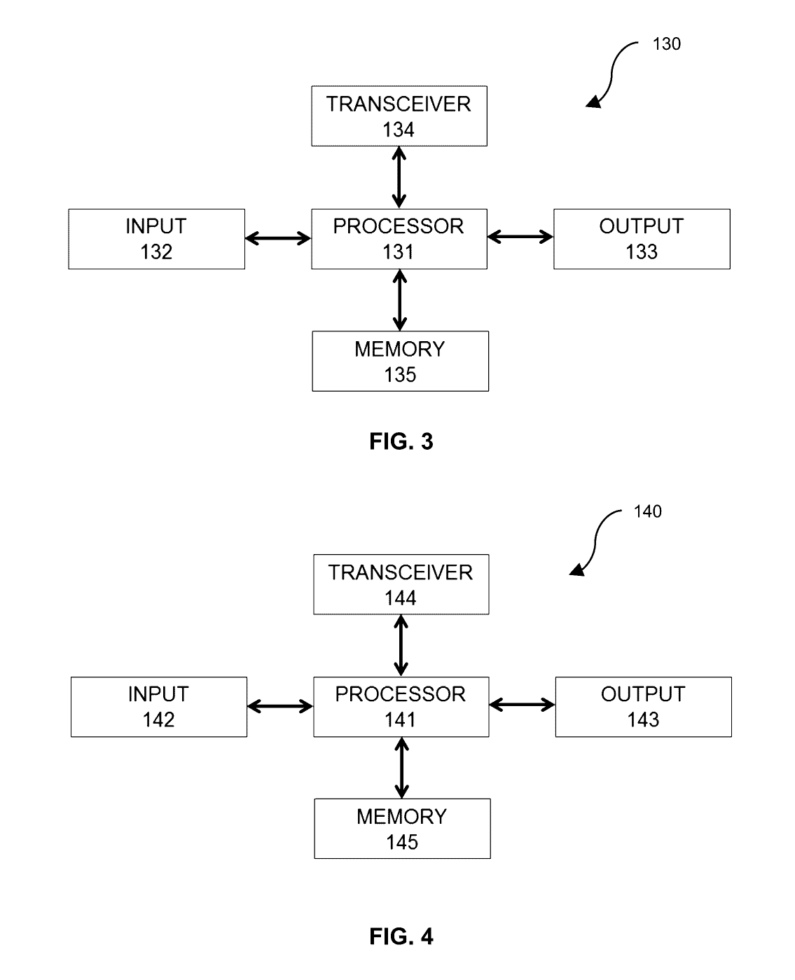

FIG. 3 is a block diagram of a computing system associated with the user device 130 according to aspects of the disclosure. The user device 130 may comprise a processor 131, one or more inputs 132, one or more outputs 133, one or more transceivers 134, and memory 135. The one or more inputs 132 may include a keyboard, mouse, touchscreen, camera, microphone, or any other suitable input mechanism. The one or more outputs 133 may include a display screen and an audio speaker. In one aspect, the output 133 of the user device 130 may display an interactive graphical user interface (GUI) and may display information relating to Ground Engaging Tool (GET) parts based on input selections received by the inputs 132. The transceiver 134 may be configured to receive the computer instructions, the executable applications, the parts database, and/or the parts data files, which may be stored and retrievable from the server 120. The memory 135 may store data received from the transceiver 134, store data to be output by the one or more outputs 133, and/or store input selections received by the inputs 132. In one aspect, the memory 135 may store instructions or data that the processor 131 may execute to carry out one or more aspects of the present disclosure. The memory 135 may include suitable storage devices for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM disks.

FIG. 4 is a block diagram of a computing system associated with the dealer device 140 according to aspects of the disclosure. The dealer device 140 may comprise a processor 141, one or more inputs 142, one or more outputs 143, one or more transceivers 144, and memory 145. The one or more inputs 142 may include a keyboard, mouse, touchscreen, camera, microphone, or any other suitable input mechanism. The transceiver 144 may be configured to receive inquiries, wishlists, and/or sales orders, which may be stored on the server 120 or transmitted direction from the user device 130. The one or more outputs 143 may include a display screen and an audio speaker. In one aspect, the output 143 of the dealer device 140 may display or print out the inquiries, the wishlists, and/or the sales orders received from the user device 130. The memory 145 may store data received from the transceiver 144, store data to be outputted by the one or more outputs 143, and/or store input selections received by the inputs 142. In one aspect, the memory 145 may store instructions or data the processor 141 may execute to carry out one or more aspects of the present disclosure. The memory 145 may include suitable storage devices for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM disks.

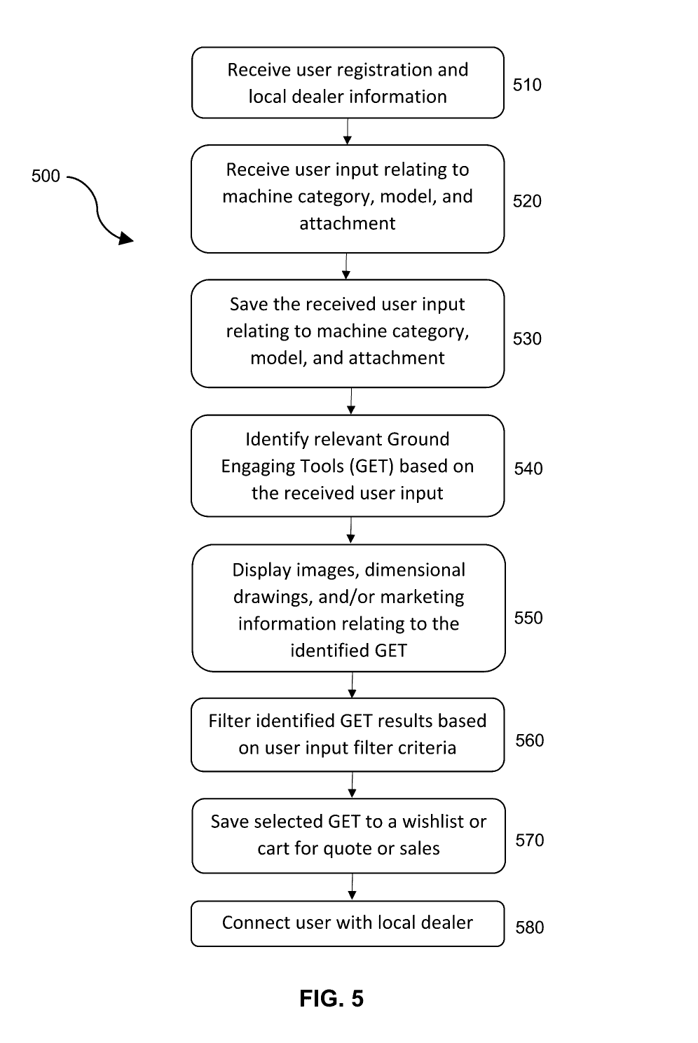

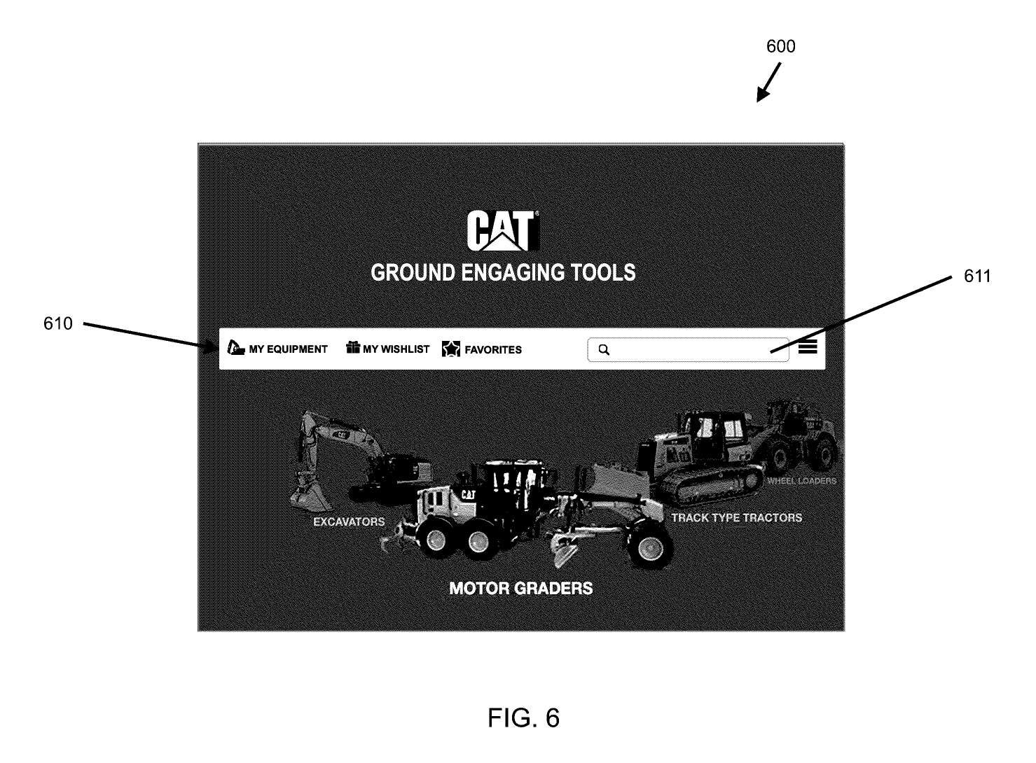

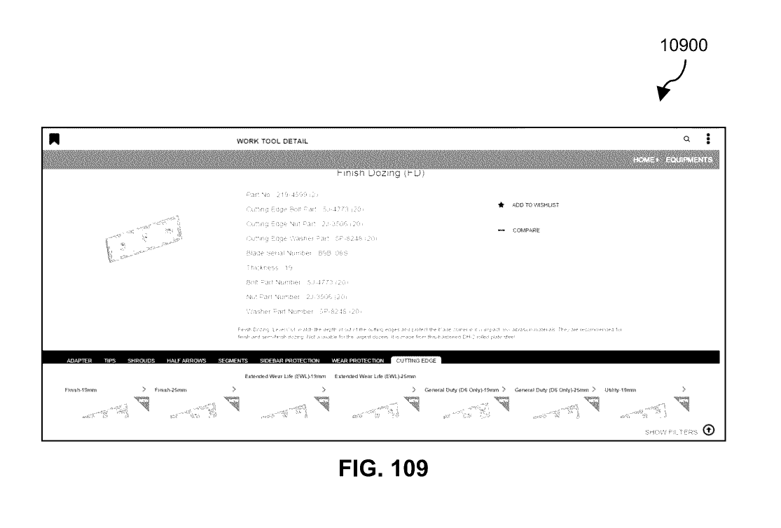

Turning to FIG. 5, a flowchart 500 shows a method of performing parts validation and sales relating to GET parts, or other parts. One or more of the steps described in the flowchart 500 may be executed on the computing system of the user device 130. For example, the user device 130 may be loaded with an executable application, such a “mobile app,” and the processor 131 of the user device 130 may execute the executable application to perform steps that may enable an operator to identify and validate GET parts, or other parts, which is compatible with a machine type and/or an attachment type selected by the operator. It will be appreciated by one skilled in the art that not all the steps described in the flowchart 500 need to be performed, and that the steps of the flowchart 500 need not be performed sequentially, but instead may be performed in a different order. In one aspect, the steps of the flowchart 500 may be performed in response to one or more inputs received by the operator interacting with the exemplary GUIs shown in FIGS. 6-109, which will be described in further detail below.

In step 510, the user device 130 may receive or access user registration and local dealer information. For example, a step of receiving user registration information may include the user device 130 receiving data from the input 132, and the data may be generated by having the operator type in or select objects using the input 132, which may include a touchscreen keyboard or drop-down selections displayed using graphical user interfaces via the output 133. The user registration information may be used to prevent unauthorized access or restrict access to certain information stored on the at least one server 120, the at least one user device 130, and/or the at least one dealer device 140.

In step 520, the user device 130 may receive or access user data input relating to a machine category, model, and/or attachment for which the operator is interested in identifying compatible GET parts. In step 530, the received inputs relating to the machine category, the model, and/or the attachment may be stored on the memory 135 of the user device 130. In one aspect, the received inputs relating to the machine category, the model, and/or the attachment may be saved temporarily on the memory 135 for a duration that the executable program is running in a single session, or they may be saved to the memory 135 for future use even after the executable program has been closed or terminated after the single session. In one aspect, the operator may store the machine category, the model, and/or the attachment information for future access using an “Add to Favorites” button, which will be described in detail further below,

In step 540, the processor 131 may receive or retrieve data relating to compatible GET parts based on the received inputs relating to the machine category, the model, and/or the attachment. Each of the machine category, the model, and/or the attachment may be associated with a unique identifier, such as a unique name variable, and may enable the processor 131 to sort, identify, and retrieve relevant data entries. The data relating to the compatible GET parts may be identified and retrieved from the memory 135. In one aspect, the data stored on the memory 135 may be data stored locally on the user device 130 in one or more parts data files. Additionally, or alternatively, the data may be retrieved on-demand from the parts database located on or hosted by the server 120.

In step 550, the data relating to the compatible GET parts, which were identified and retrieved in step 540, may be displayed textually and/or graphically using the output 133 of the user device 130. For example, images, technical and dimensional drawings, and marketing information, may be displayed to the operator, and the information may be presented within a graphical user interface that the operator can interact with. Depending on the size and type of mobile electronic device the operator may be using, the graphical user interface may be manipulated to show additional information. For example, a large block of text including information relating to a particular GET part may not all be displayed together on the screen of the user device 130. The operator may have to scroll up/down or left/right to reveal the additional text. Similarly, where there are multiple machine types, attachments, and/or GET parts displayed in response to operator selections, additionally machine types, attachments, and/or GET parts results may be revealed by scrolling up/down or left/right in a panel in which they are displayed.

In step 560, the data relating to the compatible GET parts, which may be identified and retrieved in step 540, and which may have been displayed in step 550, may be filtered down. In one aspect, the operator may provide additional inputs or parameters to more specifically narrow down GET parts to find an exact match for a worn part the operator might want to replace. Additionally, the operator may provide additional inputs or parameters to find other compatible GET parts based on the worn part the operator might want to replace. For example, additional parameters associated with GET parts may include, but is not limited to: bucket linkage type, bucket width, bucket edge thickness, bucket capacity, tip retention type, tip series, tip size, side bar protection type, side bar retention time, track type, blade part number, cutting edge attachment style, cutting edge end bit type, cutting edge thickness, shank configuration, shank retention type, number of shank holes, shank width, shank length, shank tip size, shank tip style, field repair kit type, general purpose sharp protector type, sharp retention type, sharp tip configuration, moldboard length, motor grader bolt hole size, moldboard cutting edge length, moldboard cutting edge width, and moldboard edge style. Each of the additional parameters may be associated with a unique identifier and may enable the processor 131 to sort, identify, and retrieve filtered data entries that match the additional parameters. Once the processor 131 has identified and retrieved the filtered data entries, the user device 130 may perform step 550 to display the filtered down data entries. In addition to narrowing down relevant GET parts, step 560 may retrieve “packages” of GET parts that are usable together. For example, a package may include a cutting edge for a moldboard and a specified quantity of nuts and bolts that may be necessary for a complete replacement.

In step 570, the user device 130 may save operator inputs relating to selected GET parts to store in a wishlist or shopping cart. The operator inputs relating to the selected GET parts may be stored on the memory 135 for future retrieval, and/or may be transmitted via the transceiver 134 to the dealer device 140 to request a quote or place a purchase order.

In step 580, the user device 130 may provide the operator with an option to connect with the dealer if they want to place an order directly with the dealer, or if they have questions regarding GET parts that are not detailed in the executable program. As discussed above, the steps shown in the flowchart 500 may be performed alone or in combination. Additionally, any of the steps shown in the flowchart 500 may be repeated or linked to another step as will be appreciated by one skilled in the art in view of the present disclosure. For example, step 550 may be performed after GET parts results have been filtered in step 560. Step 520 may also be executed at any point where the operator may want to restart the selection process, or if the operator has completed selection of GET parts for a first machine, such as in step 570, and the operator would like to select GET parts for a second machine.

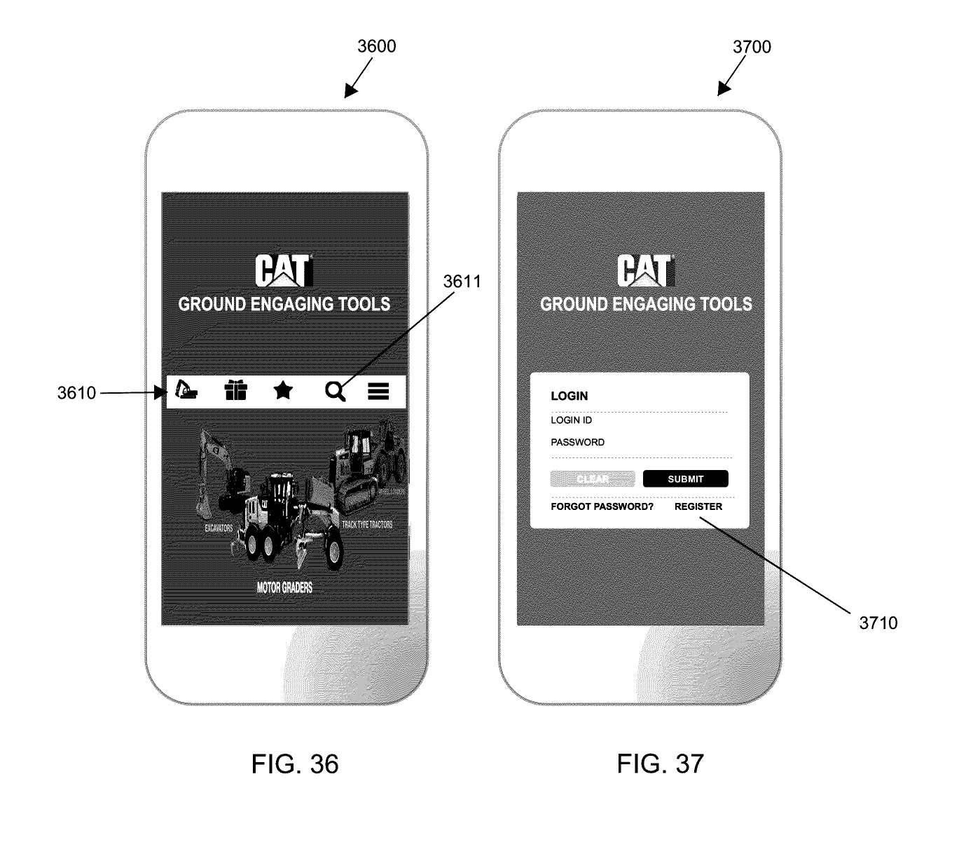

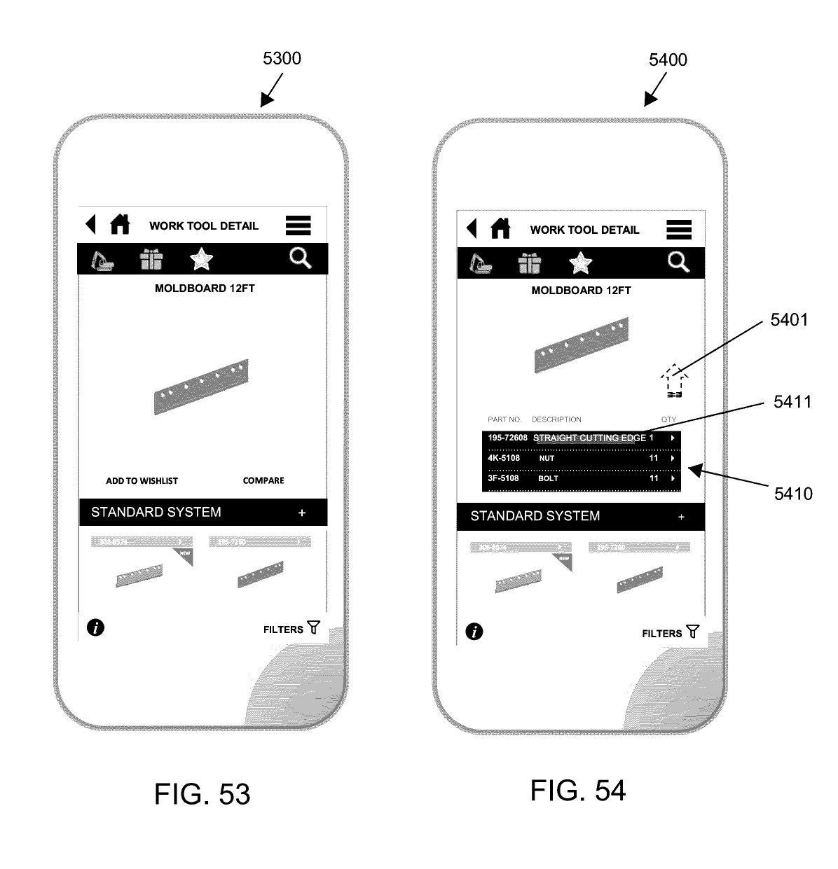

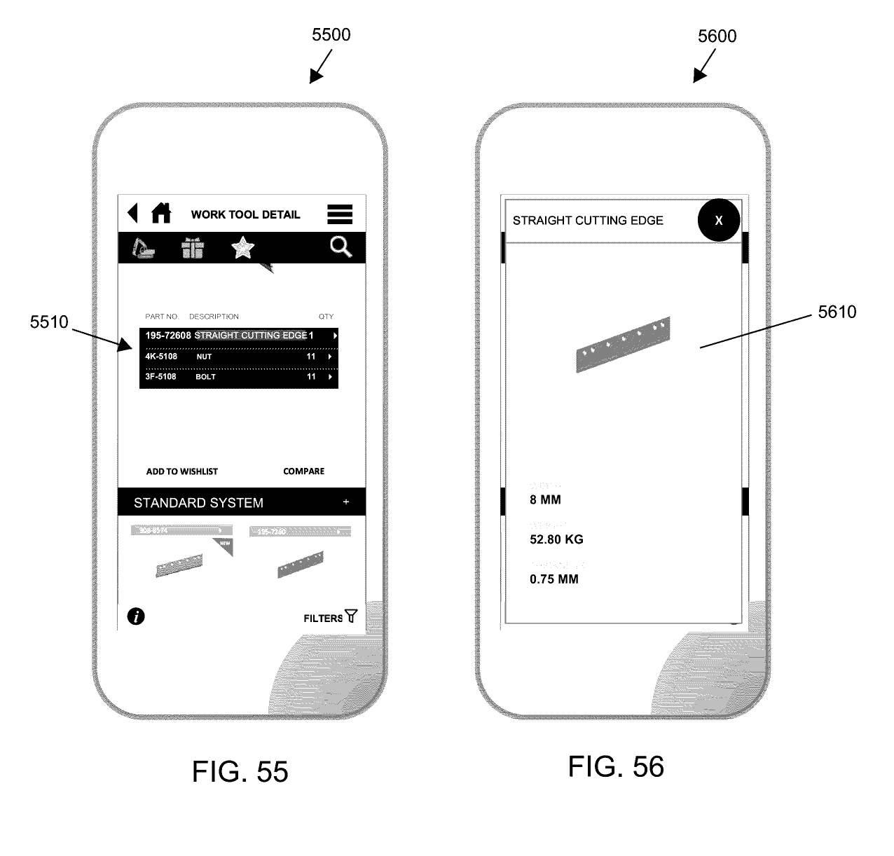

Turning to FIGS. 6-68, exemplary GUIs for interacting with the operator and displaying information will now be discussed. FIGS. 6-35 show GUIs configured for display in landscape mode and may be optimized for viewing on a display that is 6-inches or longer in a diagonal direction. In one aspect, the GUIs of FIGS. 6-35 may be adapted for display on mobile electronic devices such as laptops or tablets. FIGS. 36-68 show GUIs configured for display in portrait mode and may be optimized for viewing on a display that is 6-inches or shorter in a diagonal direction. In one aspect, the GUIs of FIGS. 36-68 may be adapted for display on mobile electronic devices such as smartphones or personal digital assistants (PDA). Of course other devices such as desktop computers, kiosks, etc., are contemplated for use with the exemplary GUIs of the present disclosure.

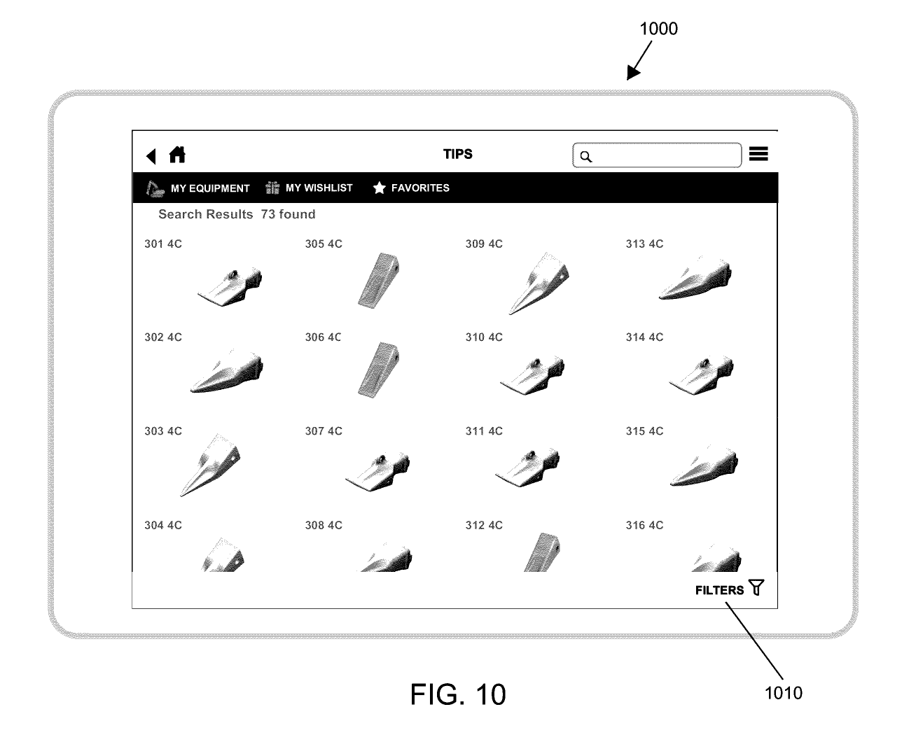

FIGS. 6 and 36 show home screen GUI displays 600 and 3600. In one aspect, the GUI displays 600 and 3600 may each include a selection bar 610, 3610 with selectable icons/text for one or more of “My Equipment,” My Wishlist,” and “Favorites.” The selection bar 610, 3610 may also include a search icon/input box 611, 3611 to enable the operator to input a text search query to identify and return specific parts, as generally shown in FIGS. 10, 40, and 41. In one aspect, the GUI displays 600 and 3600 may include selectable icons/text associated with machine types that have replaceable GET parts. For example, the machine types that may be evaluated for compatible GET parts may include, but is not limited to, excavators, motor graders, track type tractors, and wheel loaders.

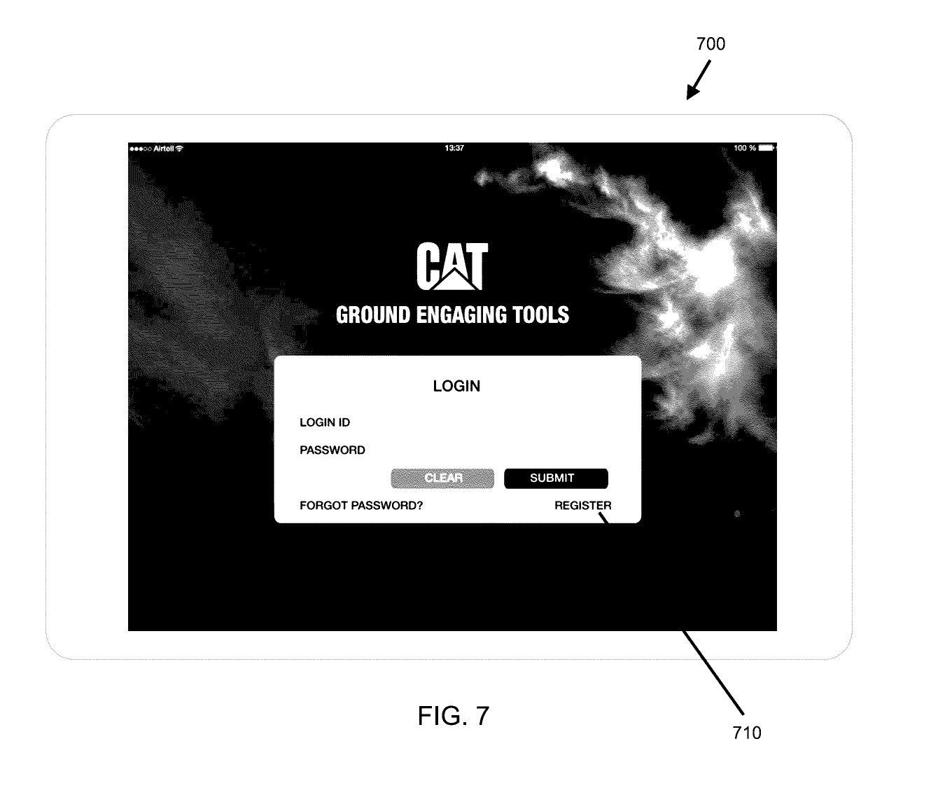

FIGS. 7 and 37 show GUI displays 700 and 3700, which may be associated with step 510 described above. In one aspect, a user login or registration page may be provided for the operator to create or validate an account in order to fully access the executable application on the user device 130, and/or for the user device 130 to interact with the server 120 or the dealer device 140. The GUI displays 700 and 3700 may each include fields for receiving a “Login ID” and a “password.” The GUI displays 700 and 3700 may each include buttons for clearing the above fields, or submitting the inputs of the fields for further processing. An icon or button for “Forgot Password?” may be provided to assist the operator with retrieving a lost password. An icon or button 710, 3710 may be provided to guide the operator through a registration process.

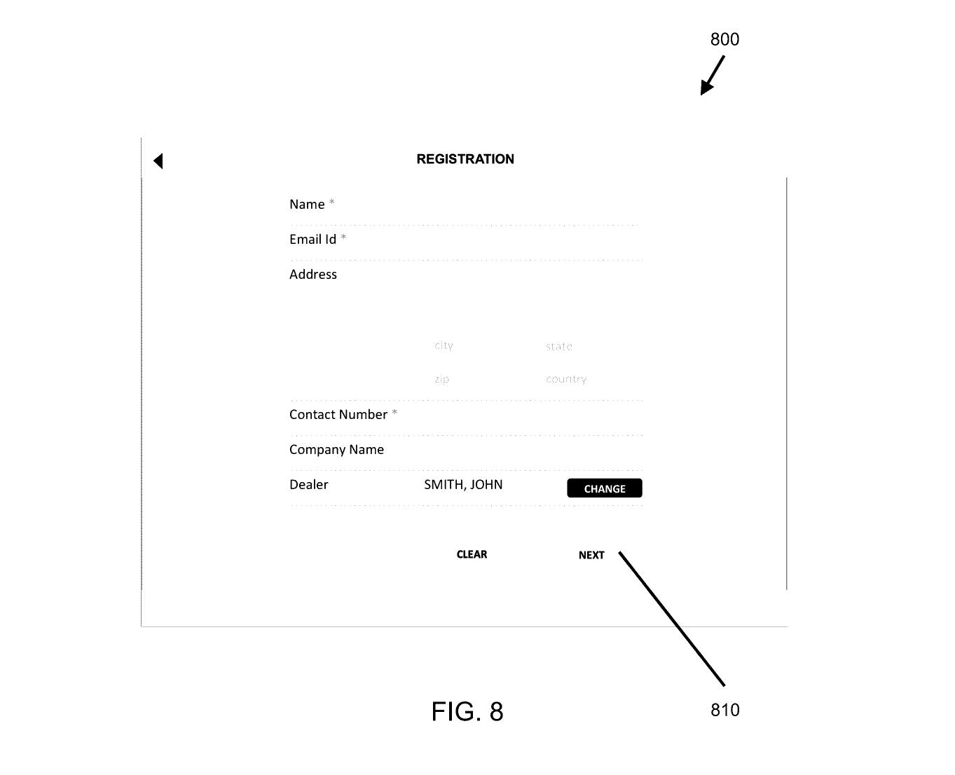

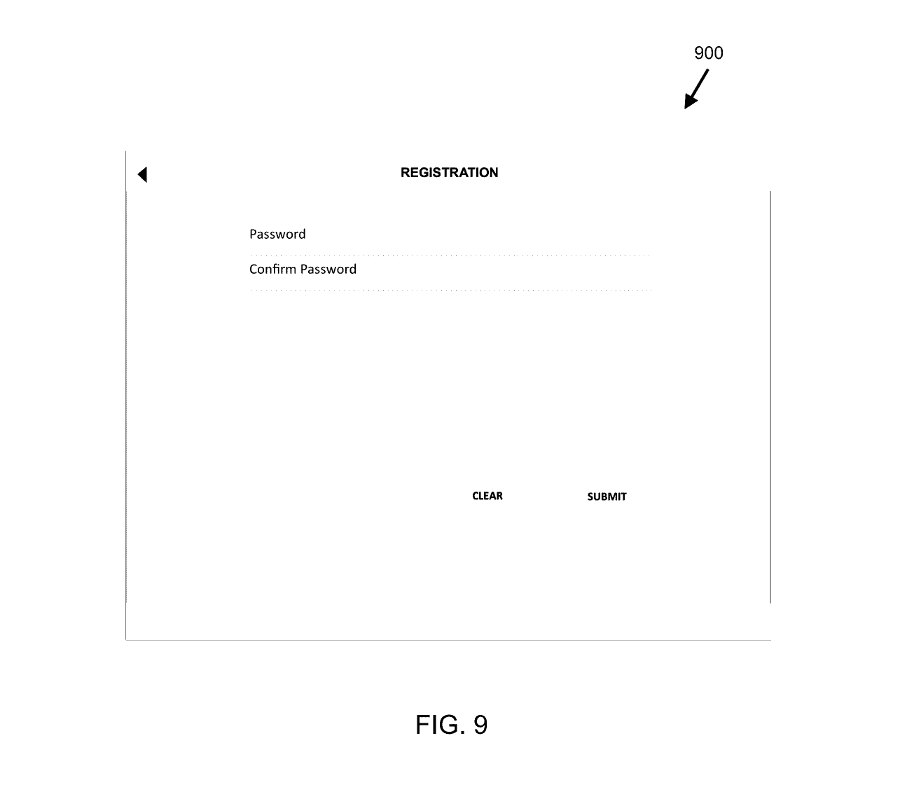

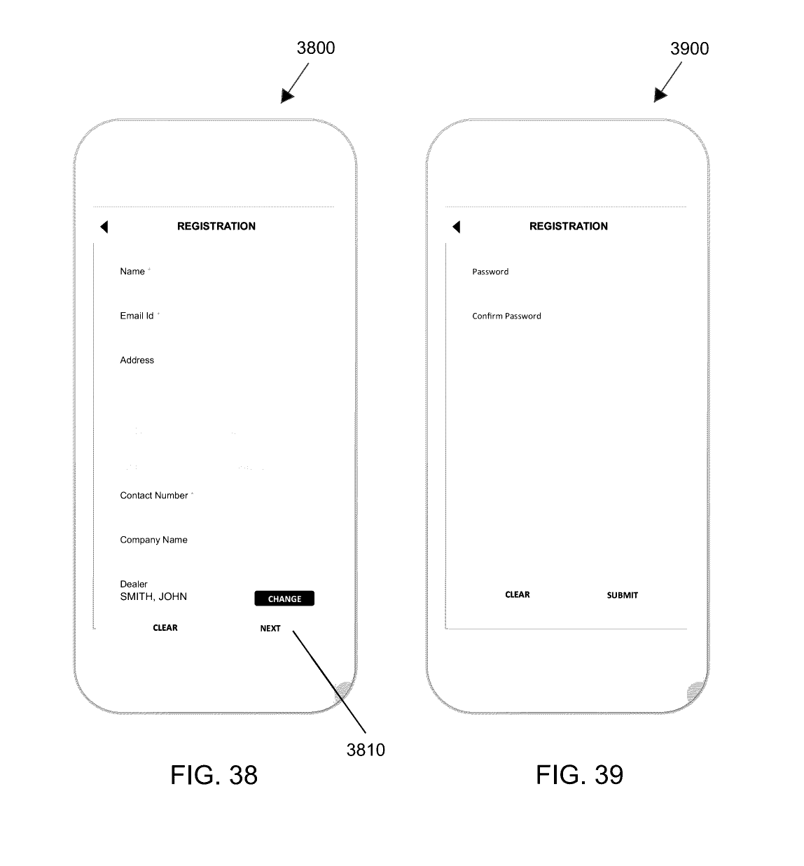

By clicking or selecting the button 710, 3710, the user device 130 may generate GUI displays 800 and 3800 of FIGS. 8 and 38, respectively. The GUI displays 800 and 3800 may have fields for identifying the owner and may include one or more of the following input fields: Name, Email ID, Address, Contact Number, and Company Name. The GUI displays 800 and 3800 may also include a local dealer section with a “Change” button to allow the operator to select a local or preferred dealer to be associated with in the parts validation and mobile sales system 100. The GUI displays 800 and 3800 may include a “Clear” button to clear all the fields discussed above, and may include a “Next” button 810, 3810. By clicking or selecting the “Next” button 810, 3810, the user device 130 may show GUI displays 900 and 3900 of FIGS. 9 and 39, respectively. The GUI displays 900 and 3900 may have fields for the operator to create and submit a password to be associated with their account.

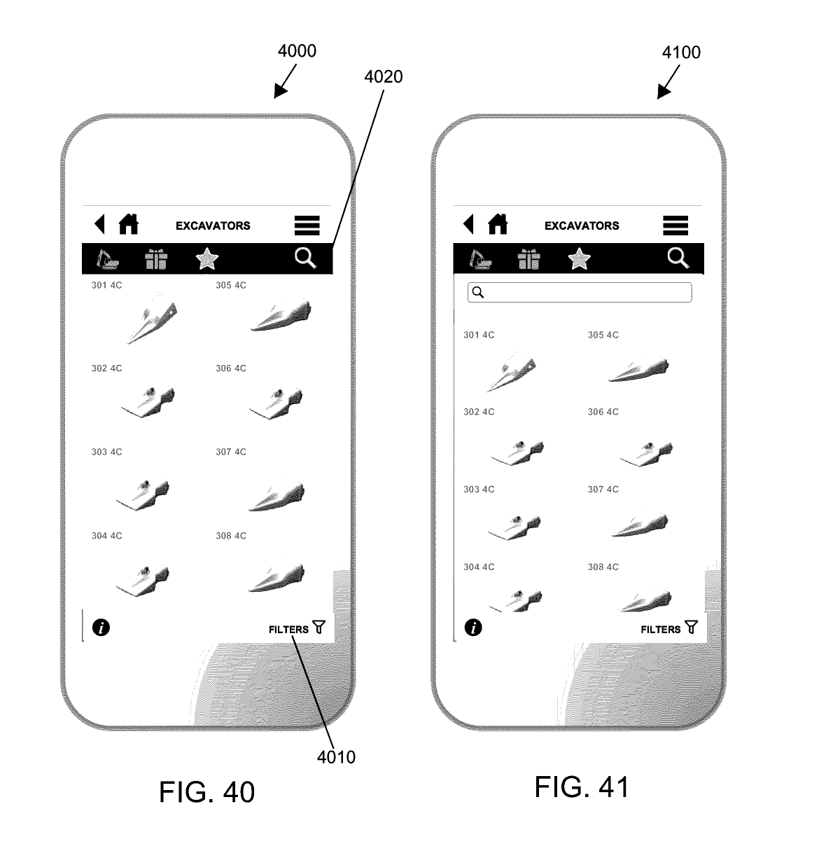

Referring back to FIGS. 6 and 36, the search icon/input box 611, 3611 may be used by the operator to enter a specific product or model number, if known, in order to find and retrieve information regarding a specific product, part, or component. By entering a query into the search icon/input box 611, 3611, the user device 130 may generate GUI displays 1000 and 4000 of FIGS. 10 and 40, respectively. A plurality of GET parts may be retrieved and displayed in response to a search input provided in the search icon/input box 611, 3611. Each of the GET parts may be shown as a graphical depiction together with a serial number or other textual identifying information. Each of the GET parts shown in GUI displays 1000 and 4000 may be selectable to show additional product detail. A filter button 1010, 4010 may be provided to further narrow down the displayed search results. In one aspect, the filter button 1010, 4010 may be located at a lower-right corner of the GUI displays 1000 and 4000. In one aspect, the GUI display 4000 may be further expanded to show a search field by clicking on the magnifying or search icon 4020, which may generate GUI display 4100 of FIG. 41.

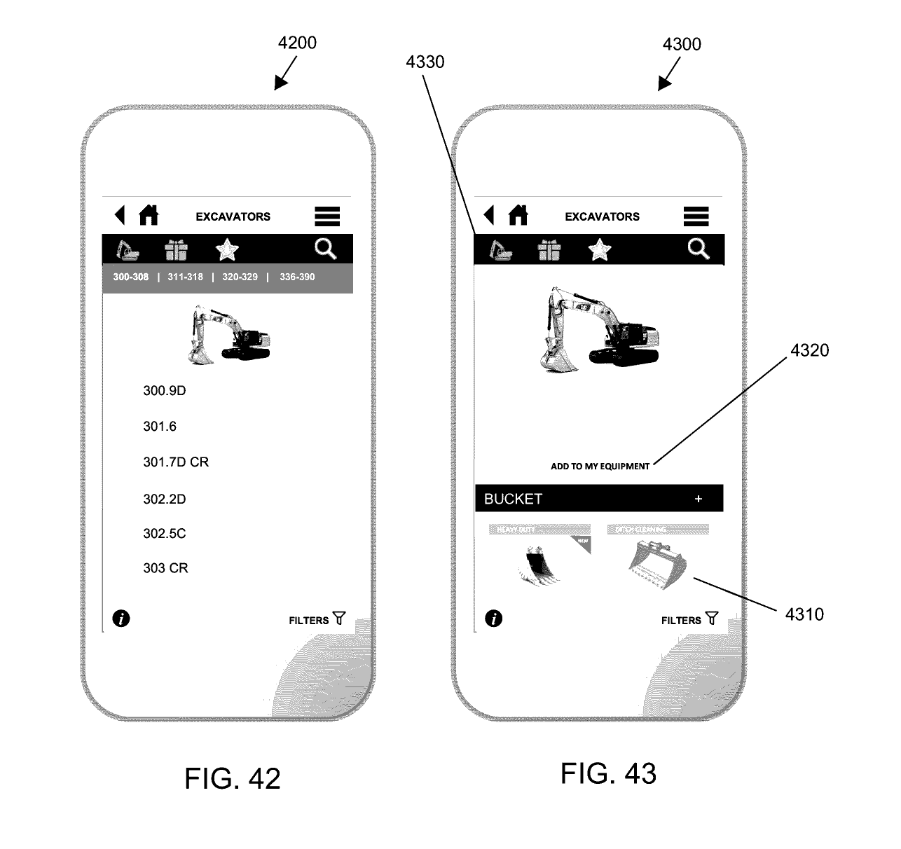

FIGS. 11 and 42 show GUI displays 1100 and 4200, which may include a graphical representation of a selected machine type. The GUI displays 1100 and 4200 may further display a list or grid of selectable model numbers which the operator may click or select to identify a piece of equipment that the operator is interested in finding compatible GET parts for.

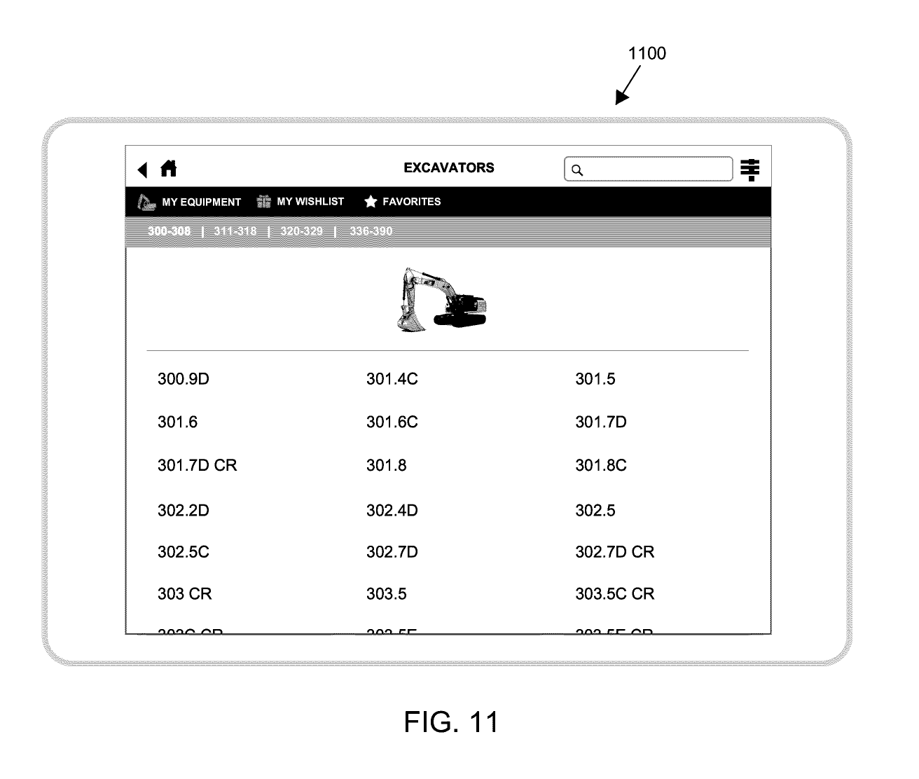

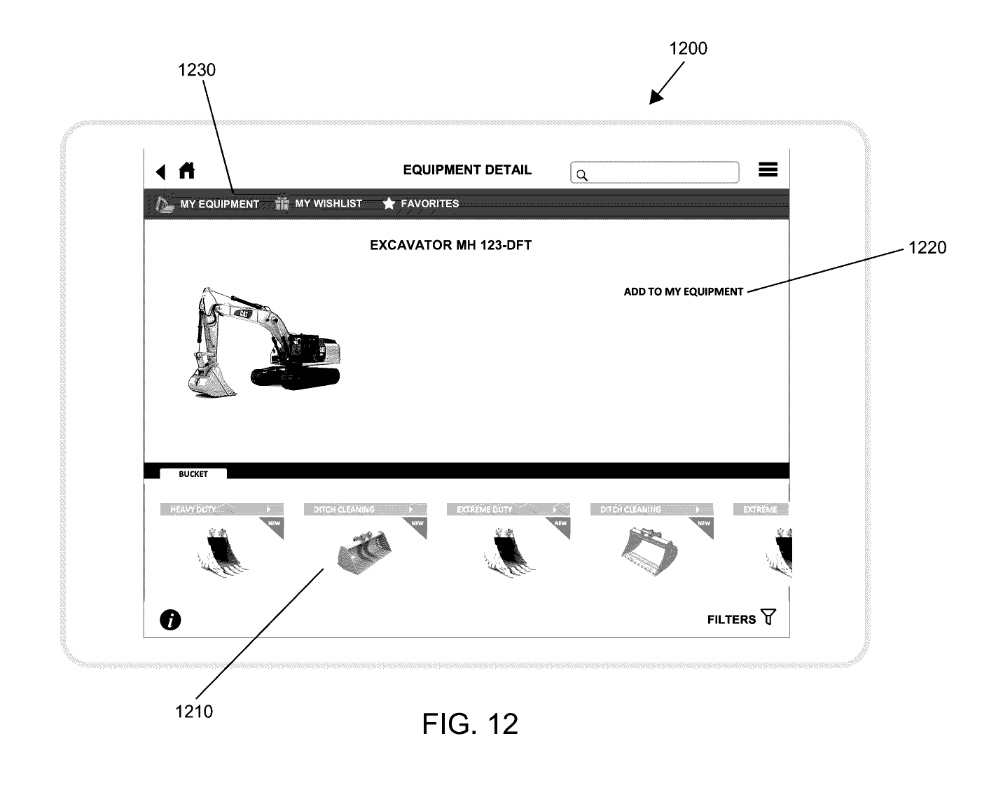

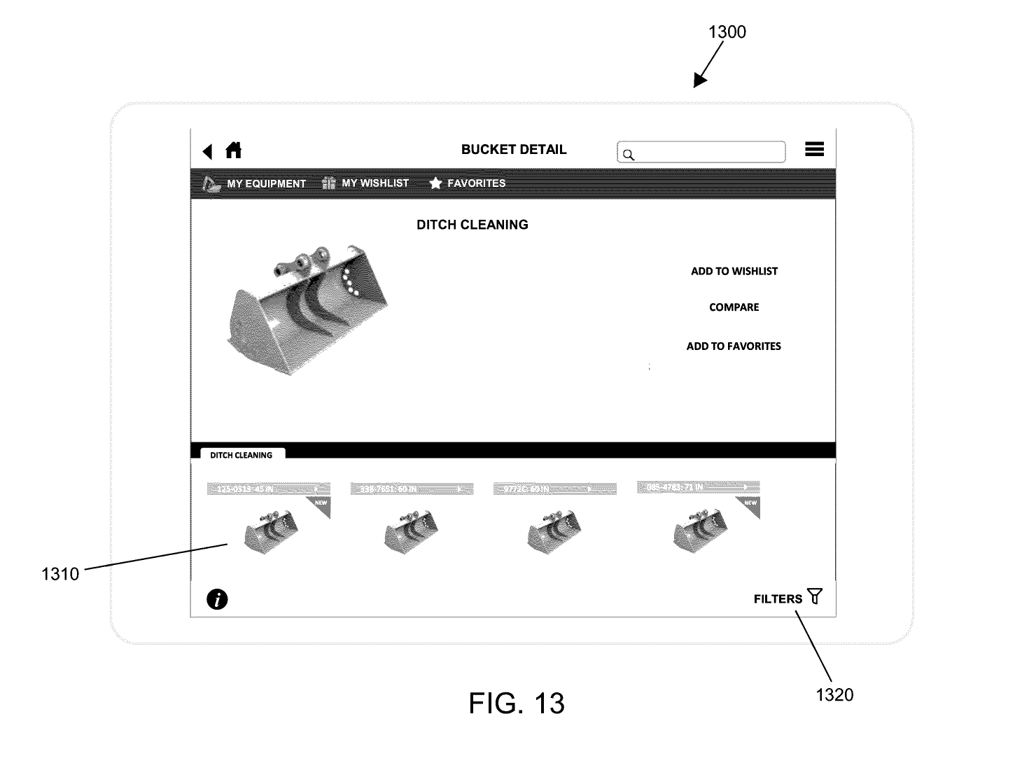

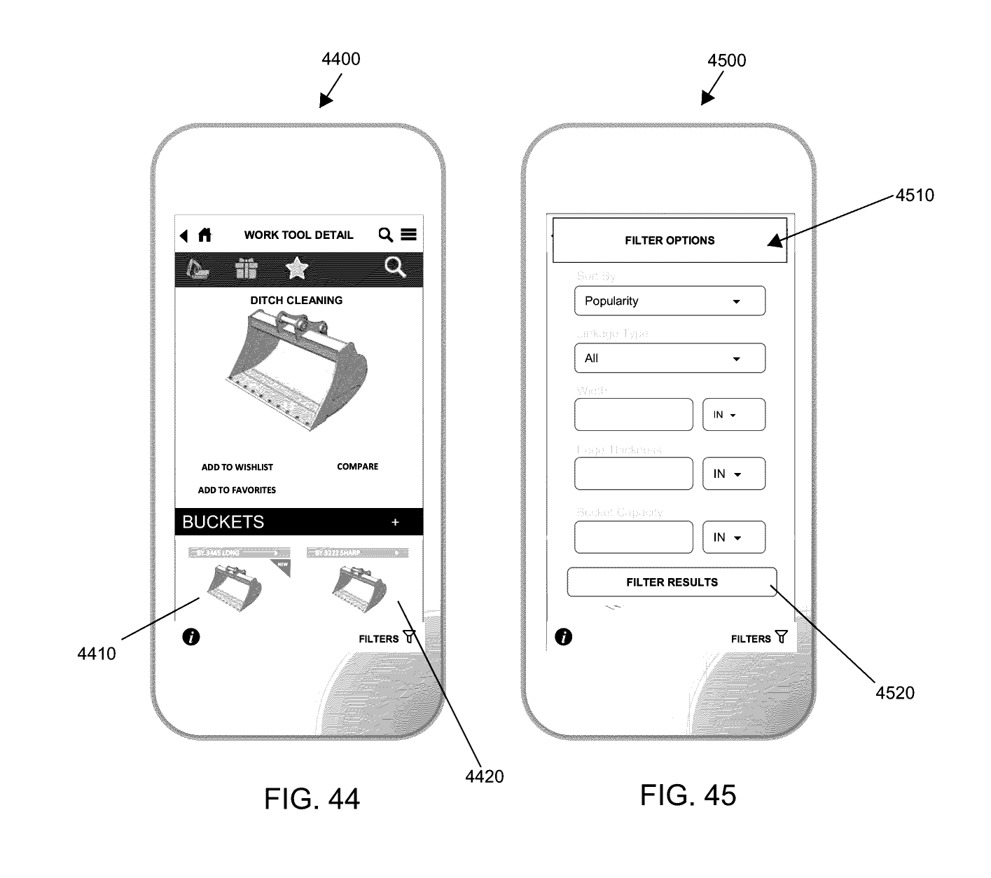

FIGS. 12 and 43 show GUI displays 1200 and 4300, which may show equipment detail associated with a selected machine type. In one aspect, the GUI displays 1200 and 4300 may be generated by selecting a work machine model number from GUI displays 1100 and 4200 of FIGS. 11 and 42, respectively, or they may be generated by selecting a machine type using the selectable icons/text associated with machine types at the bottom of FIGS. 6 and 36. The GUI displays 1200 and 4300 may show, in a lower panel or section of the display screen, a plurality of attachments or work tools associated with the selected type piece of equipment. Where the selected type of equipment is an excavator, a plurality of bucket attachments may be shown in the lower panel or section of the GUI displays 1200 and 4300. Each of the plurality of bucket attachments may be selectable, by clicking or tapping for example, to display additional information relating to the attachment and to display compatible GET parts. For example, a bucket attachment 1210, 4310 may be selected in GUI displays 1200 and 4300, respectively, in order to show additional information relating to the bucket attachment 1210, 4310, as will be discussed with reference to FIGS. 13 and 44 below. In one aspect, the GUI displays 1200 and 4300 may include an “Add to My Equipment” button 1220, 4320, which may save the currently selected type of equipment for later access via a “My Equipment” icon or tab 1230, 4330. The “Add to My Equipment” button 1220, 4320 may not be displayed if the currently selected type of equipment has been previously saved or added to “My Equipment.”

FIGS. 13 and 44 show GUI displays 1300 and 4400, which may be generated by clicking or selecting the bucket attachment 1210, 4310 in the GUI displays 1200 and 4300 of FIGS. 12 and 43, respectively. The GUI displays 1300 and 4400 may provide graphical and textual information relating to the selected attachment or work tool, which may be a bucket attachment for an excavator. In one aspect, the GUI displays 1300 and 4400 may show, in a lower panel or section of the display screen, a plurality of attachment or work tool representing different models or types of the selected attachment or work tool. For example, the depicted attachment parts in GUI displays 1300 and 4400 may be a variety of ditch cleaning buckets in various sizes that are attachable to a selected excavator machine. The depicted attachment parts, such as a 45-inch ditch cleaning bucket 1310, 4410, may further be selected to show compatible GET tools for the 45-inch ditch cleaning bucket 1310, 4410. In one aspect, the GUI displays 1300 and 4400 may further include a filter button 1320, 4420, which may be used by the operator to further narrow and identify the attachment used for their machine and/or relevant GET parts for their machine. In one aspect, the filter button 1320, 4420 may be located at a lower-right corner of the GUI displays 1300 and 4400.

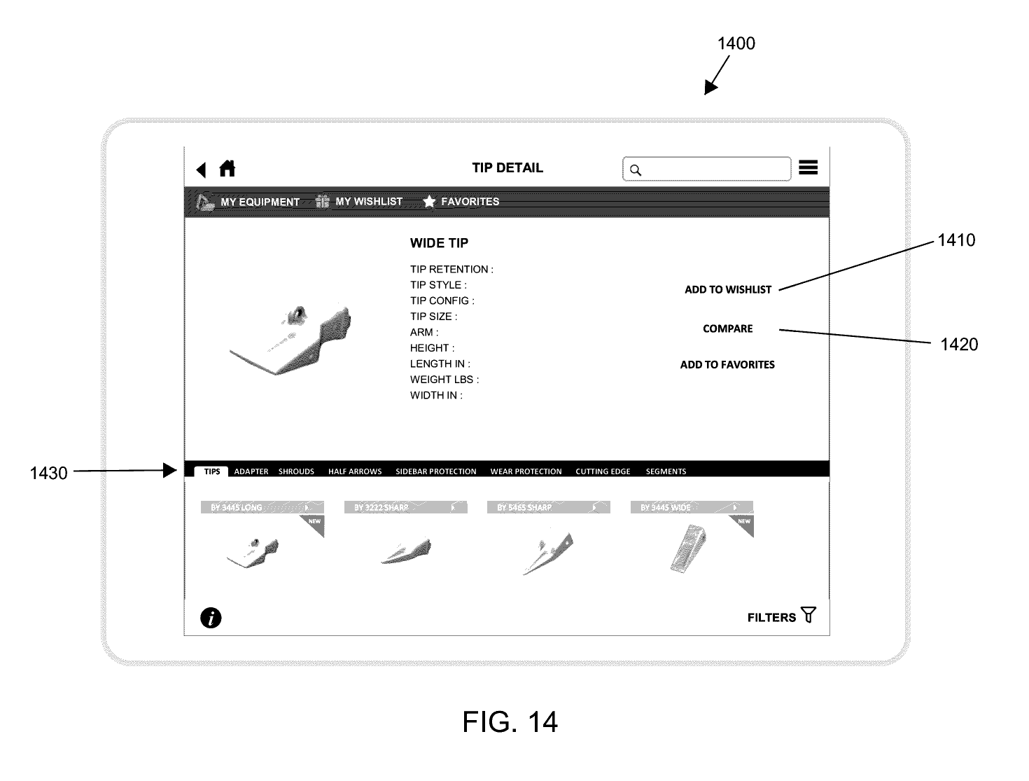

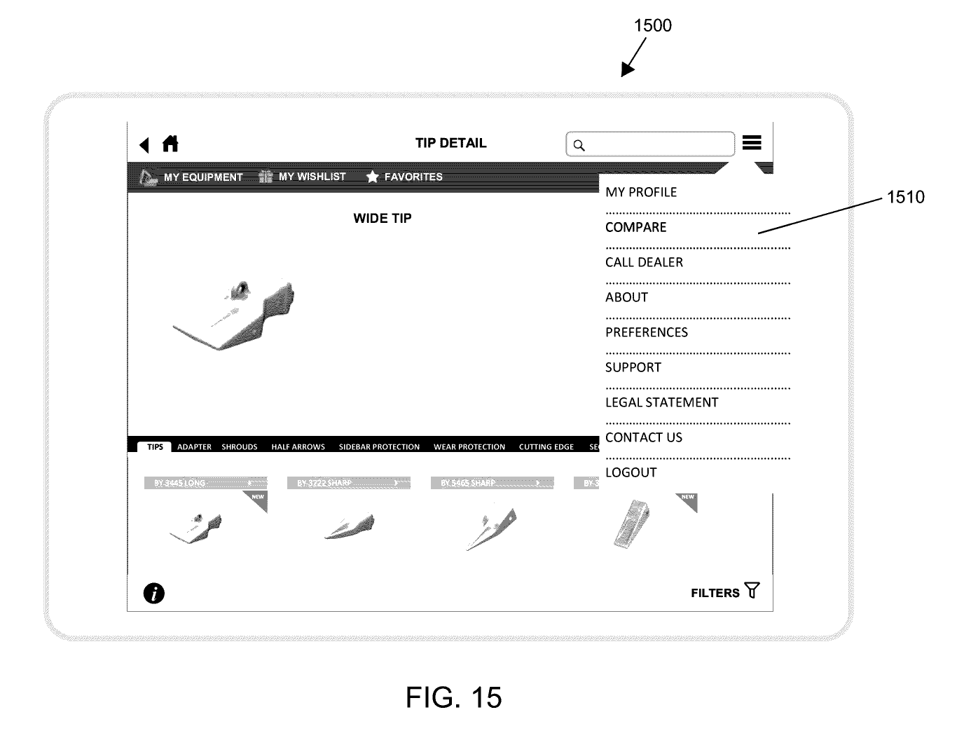

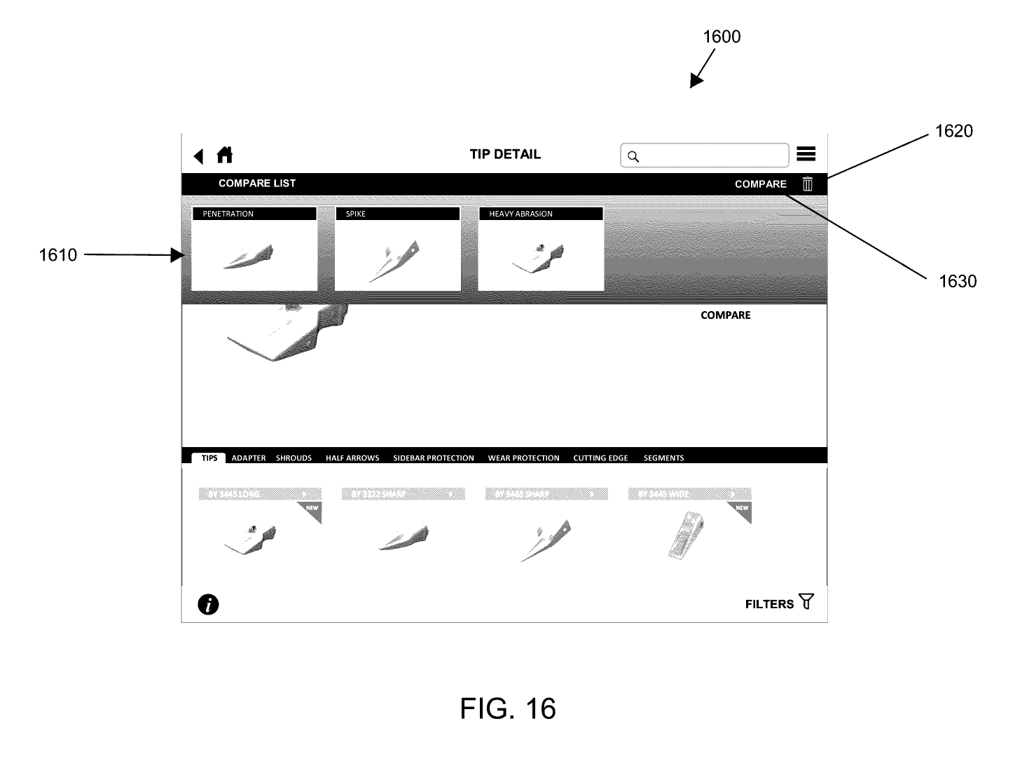

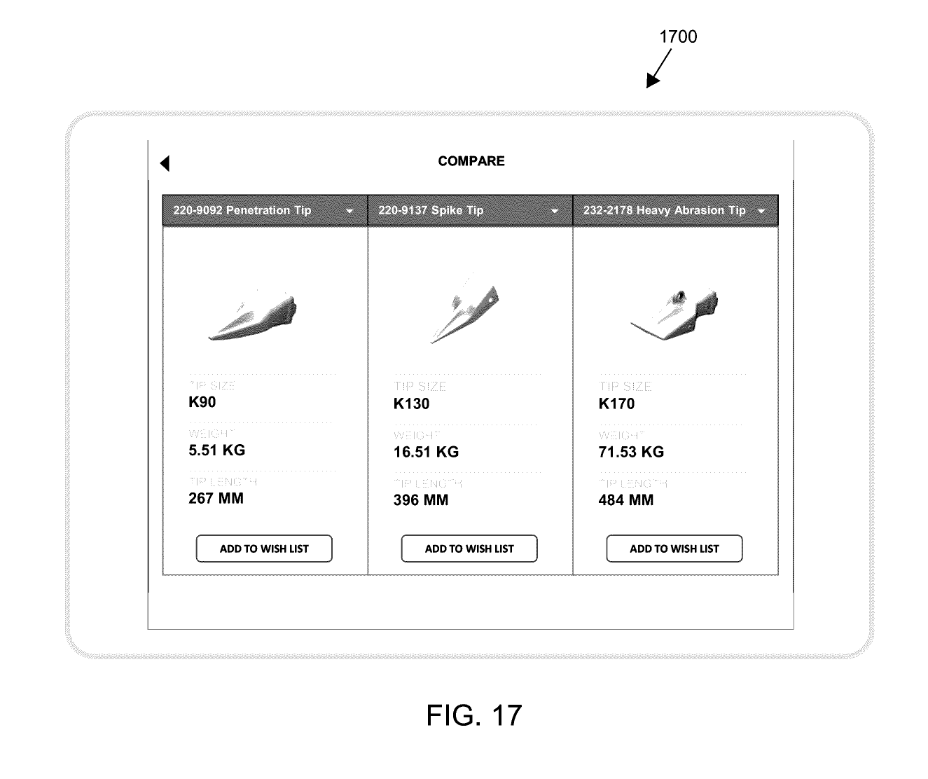

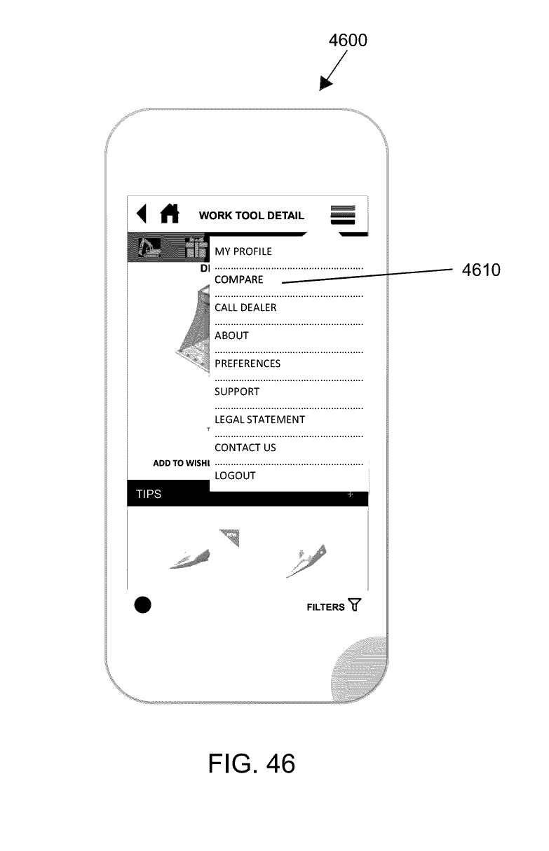

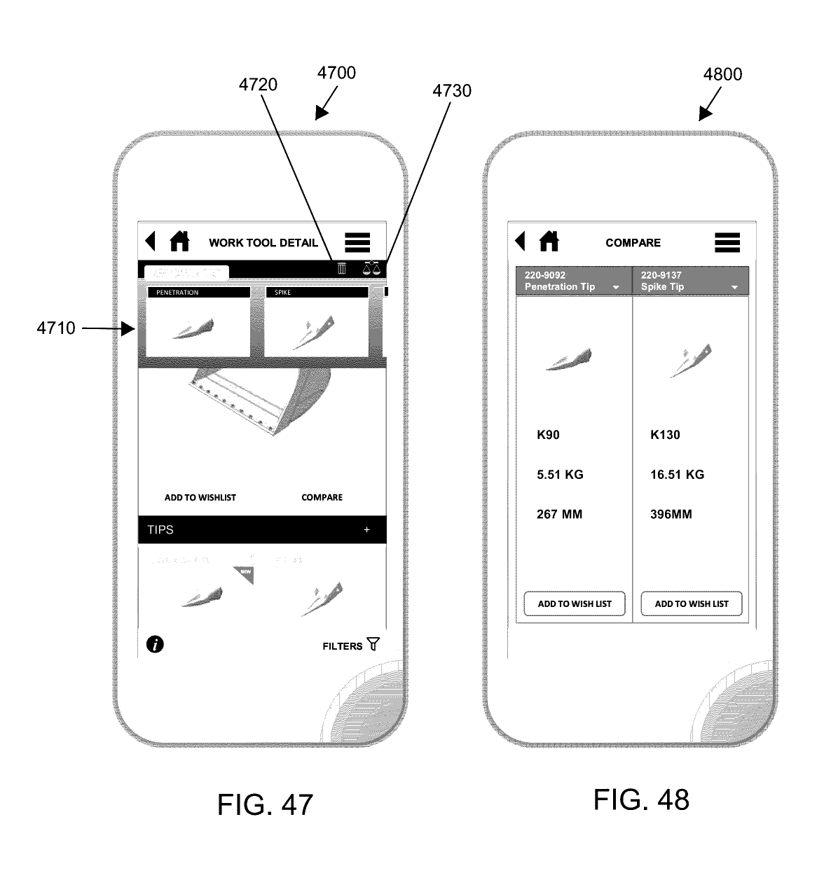

FIG. 14 shows GUI display 1400, which may be generated by clicking or selecting the ditch cleaning bucket 1310 in the GUI display 1300 from FIG. 13. In one aspect, the GUI display 1400 may include an “Add to Wishlist” button 1410, which may be selected to save a current GET tool for subsequent processing, such as requesting a quote or completing a purchase. In one aspect, the GUI display 1400 may include a “Compare” button 1420, which may be selected to tag the current GET tool for comparison. As shown in FIGS. 15-17 and 46-50, a plurality of GET parts, which have been previously tagged for comparison, may be compared side-by-side by selecting a “Compare” option 1510, 4610 from drop down menus, as shown in FIGS. 15 and 46, respectively. Once the “Compare” option 1510, 4610 has been selected, an upper pane or section 1610, 4710 including the tagged GET parts may be shown, as illustrated in GUI displays 1600, 4700 of FIGS. 16 and 47, respectively. The GUI displays 1600, 4700 may further include a delete button 1620, 4720 to remove one or more of the tagged GET parts. The GUI displays 1600, 4700 may further include a compare button 1630, 4730 to perform a comparison of the tagged GET parts. By selecting the compare button 1630, 4730, GUI displays 1700 and 4800, as depicted in FIGS. 17 and 48, may be generated to show additional details of the tagged GET parts in a side-by-side comparison. In one aspect, the side-by-side comparison may include a graphical representation of the GET parts and may include information relating to size, weight, and length.

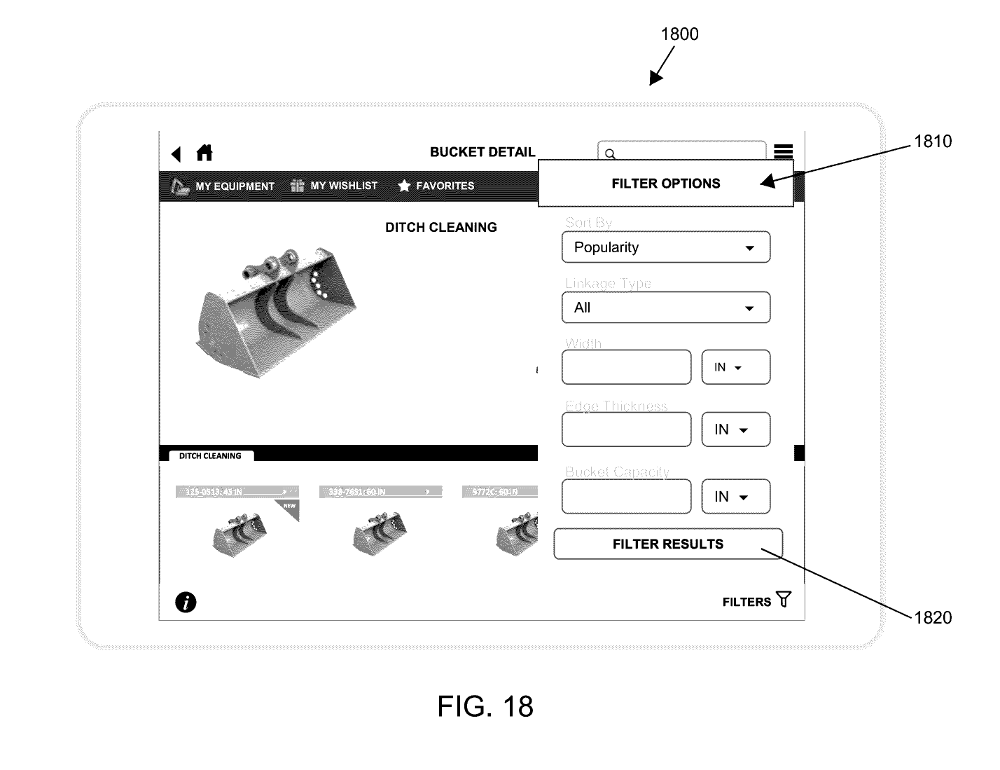

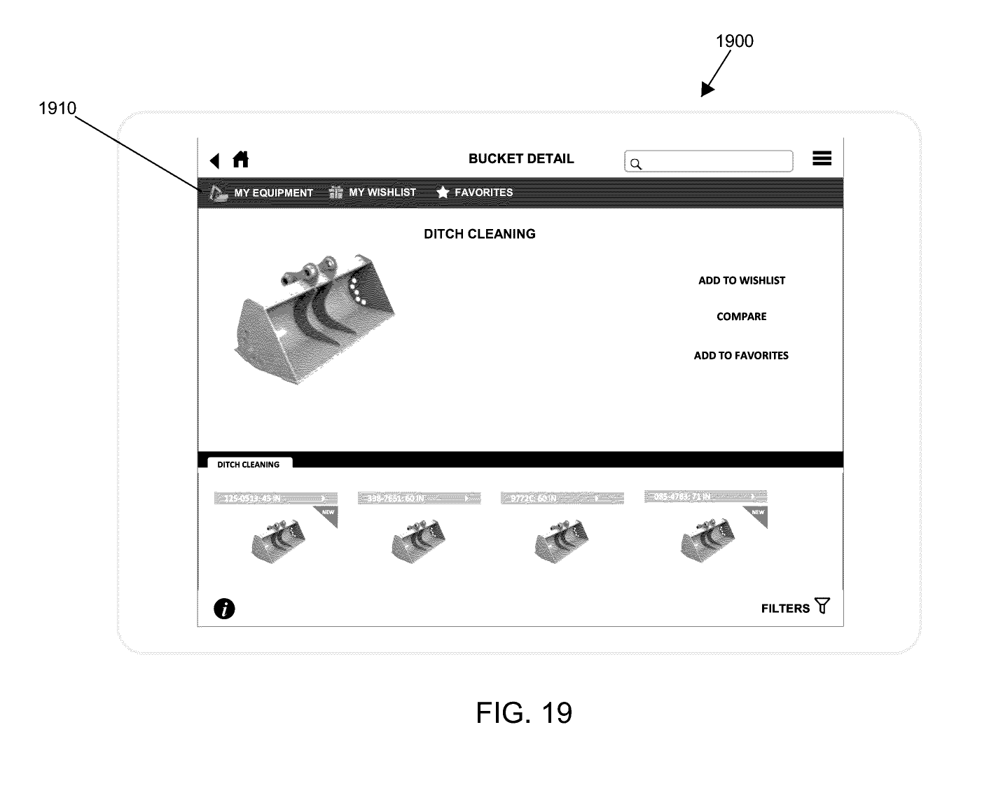

Referring back to FIGS. 13 and 44, the filter button 1320, 4420 may be selected to further refine the results to identify GET parts that will be compatible with the operator's machine. By selecting the filter button 1320, 4420, a filter options menu 1810, 4510 may be displayed as shown in GUI displays 1800, 4500 of FIGS. 18 and 45, respectively. In one aspect, the filter options menu 1810, 4510 may include text or selection input fields to further define a linkage type, width, edge thickness, and/or bucket capacity. These attributes may correspond with the measurements or specifications of a current GET tool that the operator may be trying to find a replacement for. Although the above text or selection input fields relate to GET parts for bucket attachments, other input fields pertinent to attachments for other types of selected machines are of course contemplated. In one aspect, the filter options menu 1810, 4510 may include text or selection input fields to further define attributes of the machine type, the attachments, and/or the GET parts. For example, additional filtering attributes may include: bucket linkage type, bucket width, bucket edge thickness, bucket capacity, tip retention type, tip series, tip size, side bar protection type, side bar retention type, track type, blade part number, cutting edge attachment style, cutting edge end bit type, cutting edge thickness, shank configuration, shank retention type, number of shank holes, shank width, shank length, shank tip size, shank tip style, field repair kit type, general purpose sharp protector type, sharp retention type, sharp tip configuration, moldboard length, motor grader bolt hole size, moldboard cutting edge length, moldboard cutting edge width, and moldboard edge style. These attributes may correspond with the measurements or specifications of a current GET tool that the operator may be trying to find a replacement for. Once the appropriate fields of the filter options menu 1810 has been entered by the operator, the “Filter Results” button 1820 may be selected for the refined GET parts results to be displayed, as generally shown in GUI display 1900 of FIG. 19.

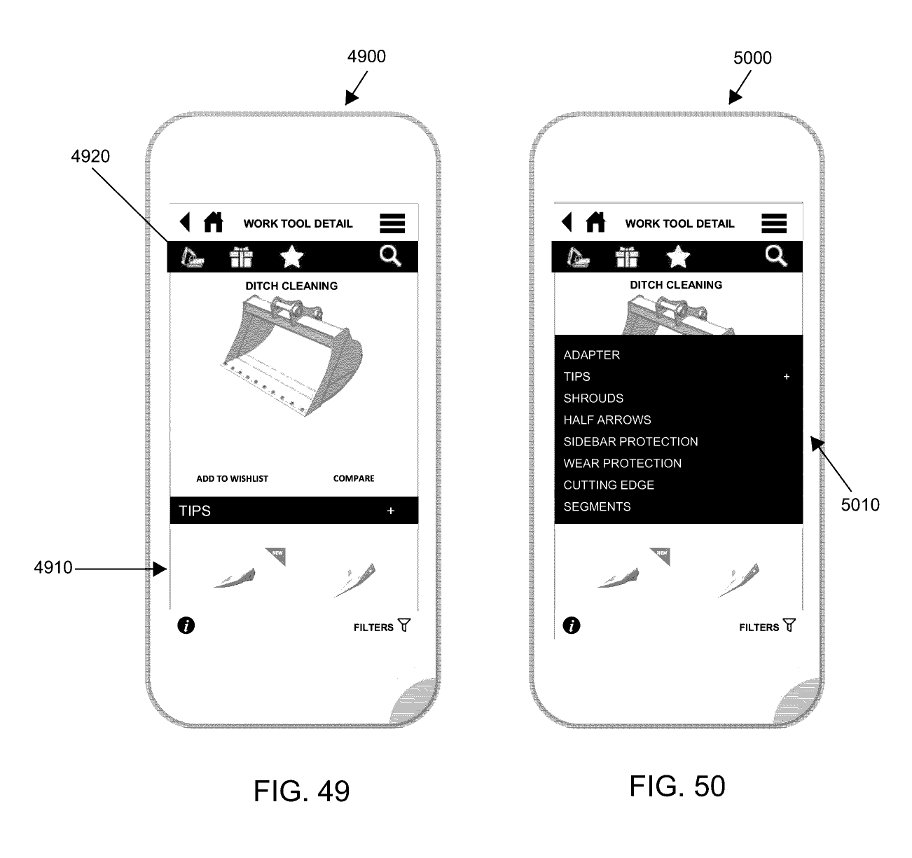

Turning to FIGS. 49 and 50, GUI display 4900 shows a dynamic GET tool category selection bar 4910 in a minimized state, while GUI display 5000 shows a dynamic GET tool category selection bar 5010 in an expanded state. In the minimized state, the dynamic GET tool category selection bar 4910 may display a currently selected type of GET tool. In the expanded state, the dynamic GET tool category selection bar 5010 may display a list of available types of GET parts for the current machine and work tool. By utilizing the dynamic GET tool category selection bar 4910, 5010, screen real estate may be preserved to show additional information relating to a selected machine, work tool, or GET tool. In one aspect, an entry from a list of the dynamic GET tool category selection bar 5010 may be selected in order for the GUI to be updated to display that particular category of GET parts. By comparison, the GUI display 1400 of FIG. 14 may include a row of selectable tabs 1430, which may include labels for displaying the list of available types of GET parts for the current machine and work tool, since more screen space may be available in this configuration to display additional information concurrently. In the case of the GUI display 1400, each tab of the selectable tabs 1430 may be selected in order for the GUI to be updated to display that particular category of GET parts.

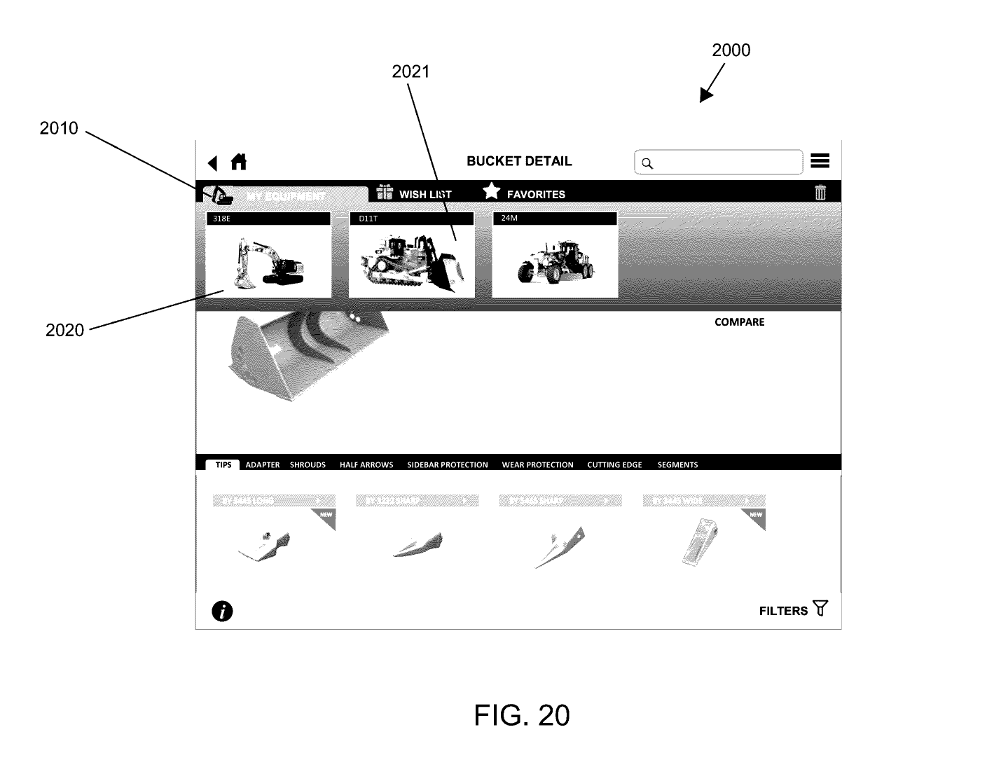

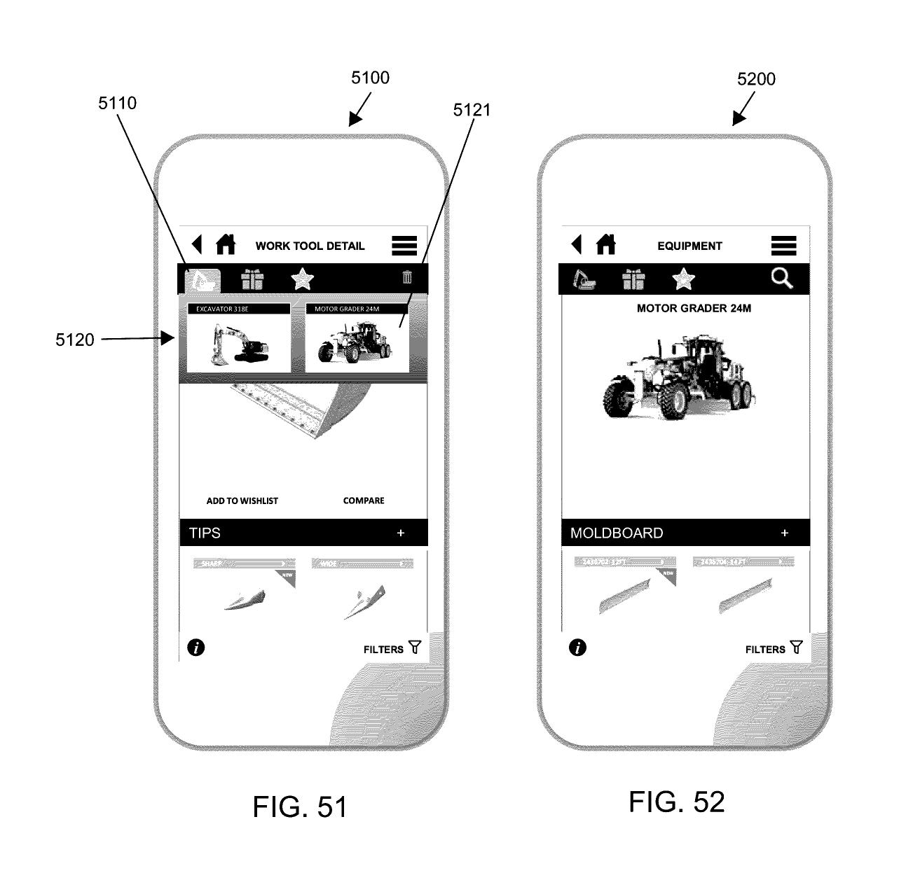

FIGS. 20 and 51 show GUI displays 2000 and 5100, which may be generated by selecting a “My Equipment” icon or tab 1910, 4920 located near an upper pane or section of the GUI displays 1900 and 4900 of FIGS. 19 and 49, respectively. By selecting the “My Equipment” icon or tab 1910, 4920 (in FIGS. 19 and 49), an equipment selection panel 2020, 5120 may expand or drop down from a “My Equipment” icon or tab 2010, 5110 (in FIGS. 20 and 51). The equipment selection panel 2020, 5120 may include one or more machine types, which may be selectable by the operator to identify GET parts that will be compatible with that particular machine type. In one aspect, the one or more machine types may include: excavator, motor grader, wheel loader, and track type tractors.

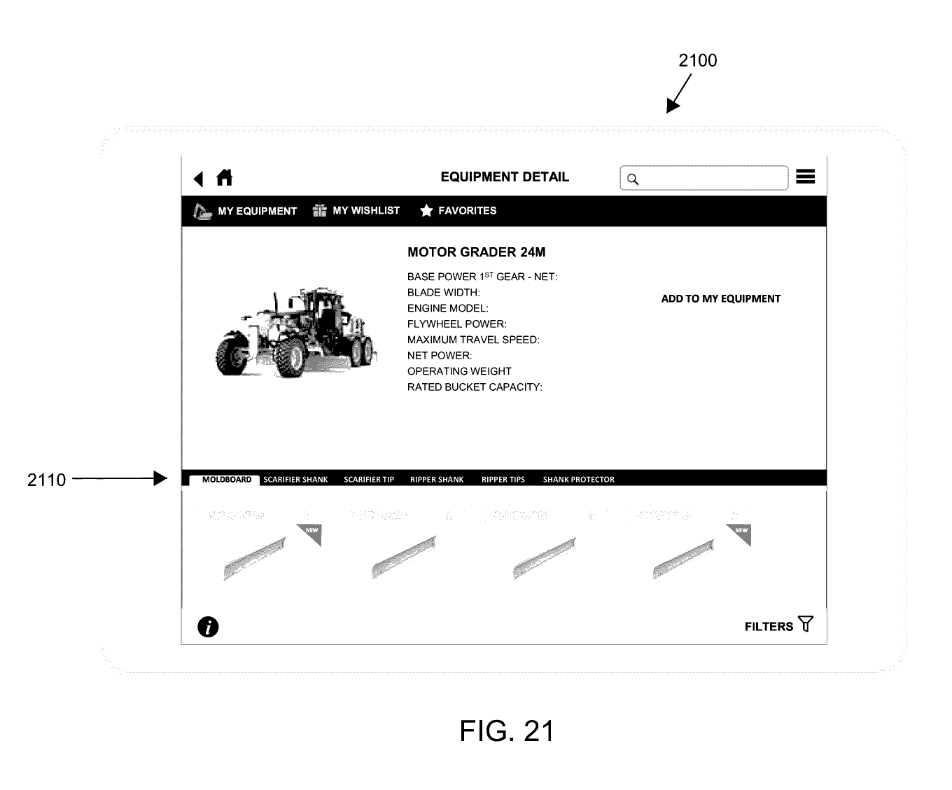

FIGS. 21 and 52 show GUI displays 2100 and 5200, which may be generated by selecting a motor grader icon 2021, 5121 from the equipment selection panel 2020, 5120. The GUI displays 2100, 5200 may include graphical and textual information relating to the motor grader, and attachments associated with the motor grader. In one aspect, GUI display 2100 may include a plurality of tabs 2110, which may be selected to retrieve and display different types of motor grader attachments, such as, moldboard, scarifier shank, ripper shank, ripper tips, and shank protector. Similar to the GUI displays 1300 and 4400 of FIGS. 13 and 44, respectively, a plurality of related attachments may be selectable in a bottom panel or section of the GUI displays 2100, 5200.

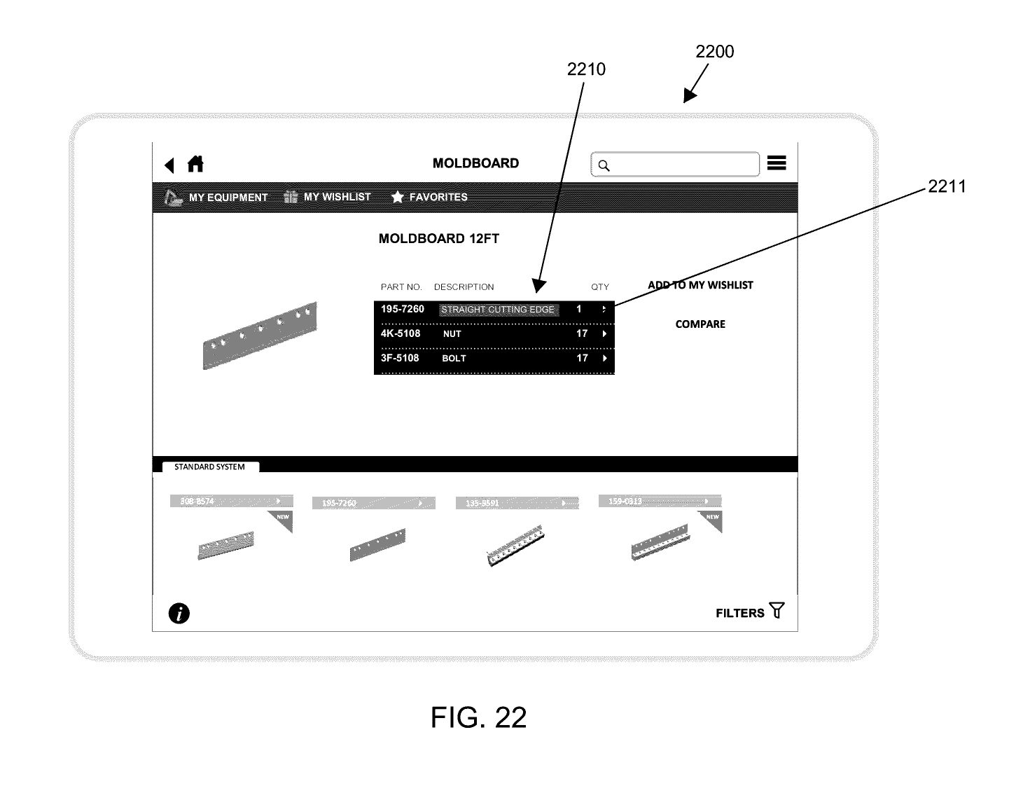

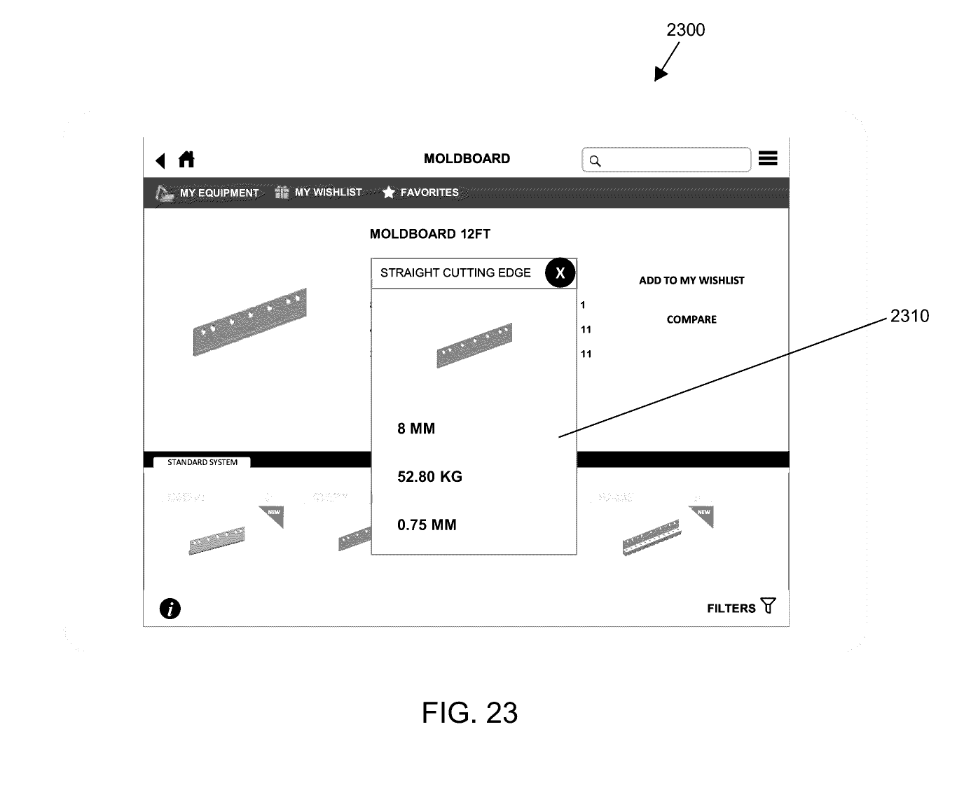

FIGS. 22, 23, and 53-58 show GUI displays 2200, 5300, 5400, and 5500, which may be generated by selecting an attachment in the bottom panel or section of the GUI displays 2100, 5200 of FIGS. 21 and 52, respectively. The GUI displays 2100, 5200 may include graphical and textual information relating to the selected attachment. As shown in the GUI display 2200, and as shown in the GUI displays 5400 and 5500, which may include portions of the interface scrolled upwards relative to GUI display 5300 as indicated by arrow 5401 in FIG. 54, a chart 2210, 5410, 5510 of compatible GET parts may be displayed. Each of the parts listed in the chart 2210, 5410 may be selectable to display additional information relating to that part. For example, if a first part 2211, 5411, 5511 is selected, a popup box 2310, 5610 may be generated and displayed, as shown in GUI displays 2300, 5600 of FIGS. 23 and 56, respectively. The popup box 2310, 5610 may display graphical and textual information relating to the selected part.

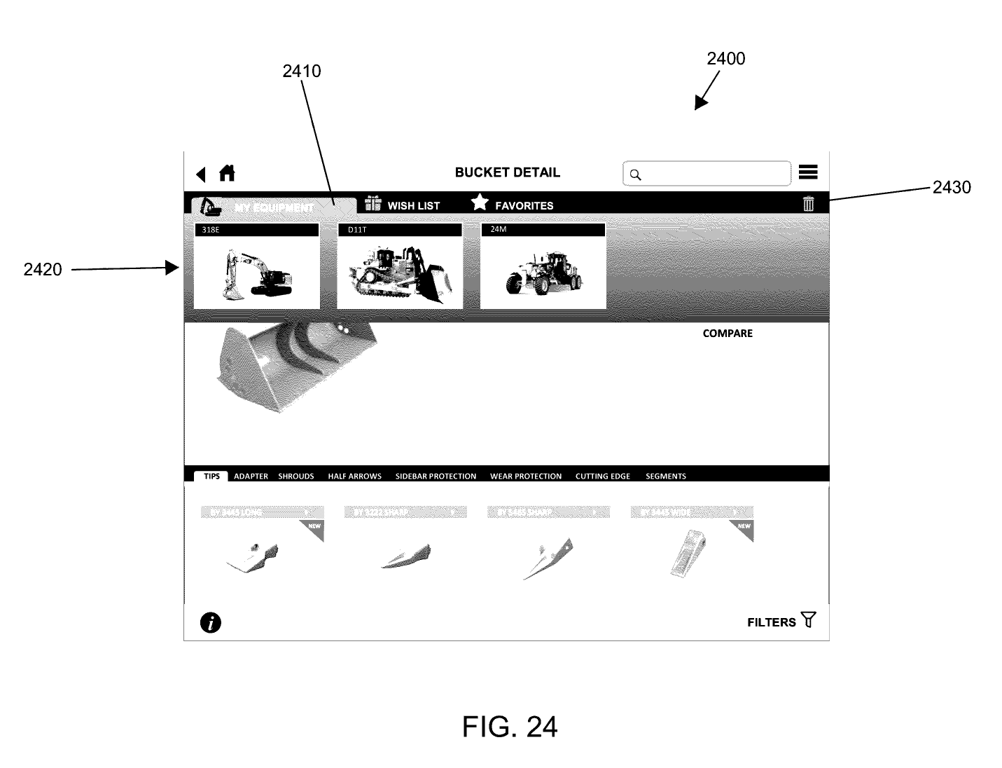

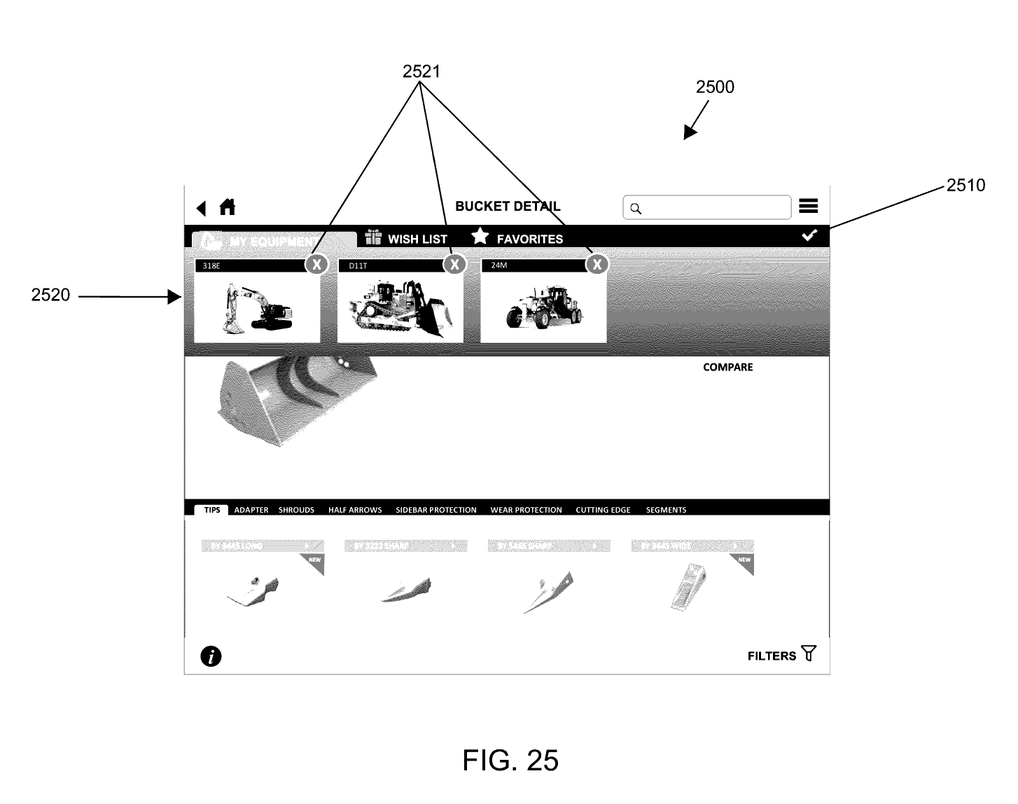

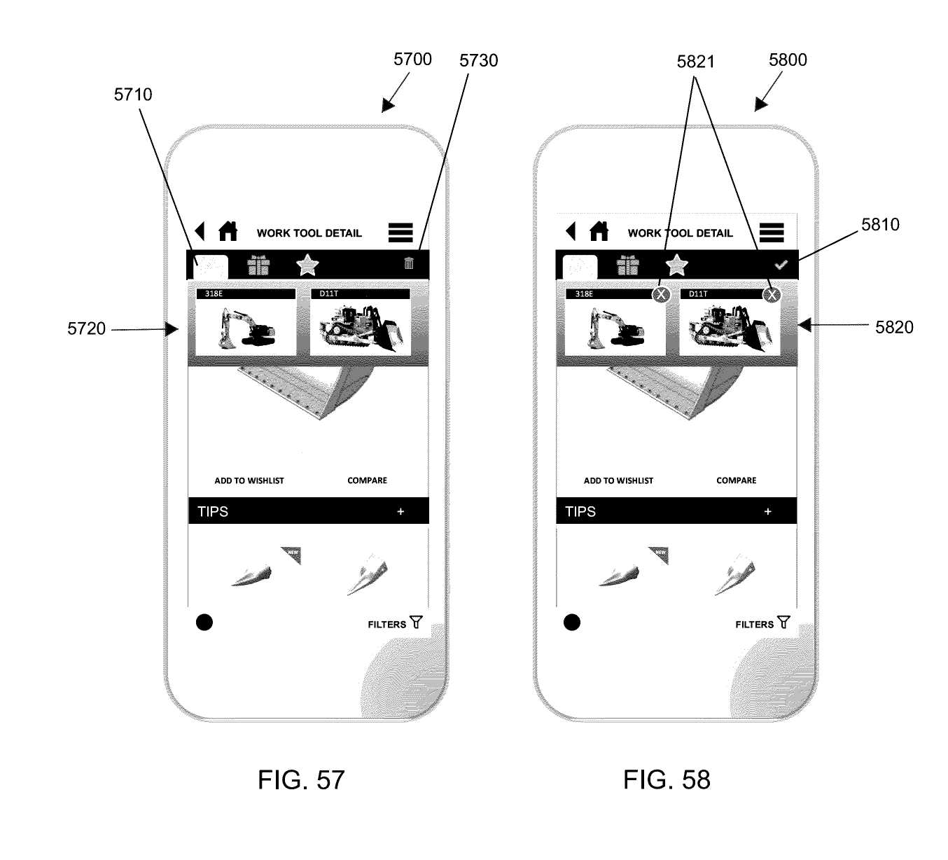

FIGS. 24 and 57 show GUI displays 2400 and 5700, which may be generated by selecting a “My Equipment” icon or tab 2410, 5710 located near an upper pane or section of the screen. By selecting the “My Equipment” icon or tab 2410, 5710, an equipment selection panel 2420, 5720 may expand or drop down from the “My Equipment” icon or tab 2410, 5710. The equipment selection panel 2020, 5120 may include one or more machine types, which may be selectable by the operator to identify GET parts that will be compatible with that particular machine type. In one aspect, a delete or trash icon 2430, 5730 may be selected to remove equipment or machine type from the equipment selection panel 2420, 5720. Turning to FIGS. 25 and 58, GUI displays 2500 and 5800 may be generated by selecting the delete or trash icon 2430, 5730 of FIGS. 24 and 57, respectively. The GUI displays 2500 and 5800 may include a modified equipment selection panel 2520, 5820 where each of the displayed equipment or machine types may include a remove button 2521, 5821. If the remove button 2521, 5821 associated with one of the displayed equipment or machine types is selected, that particular equipment or machine type would be removed from the modified equipment selection panel 2520, 5820. In one aspect, the remove button 2521, 5821 may include an “X” symbol. Other symbols or icons are of course contemplated. Once all adjustments or deletions have been made, if any, a confirmation button 2510, 5810 may be selected to end the equipment editing process.

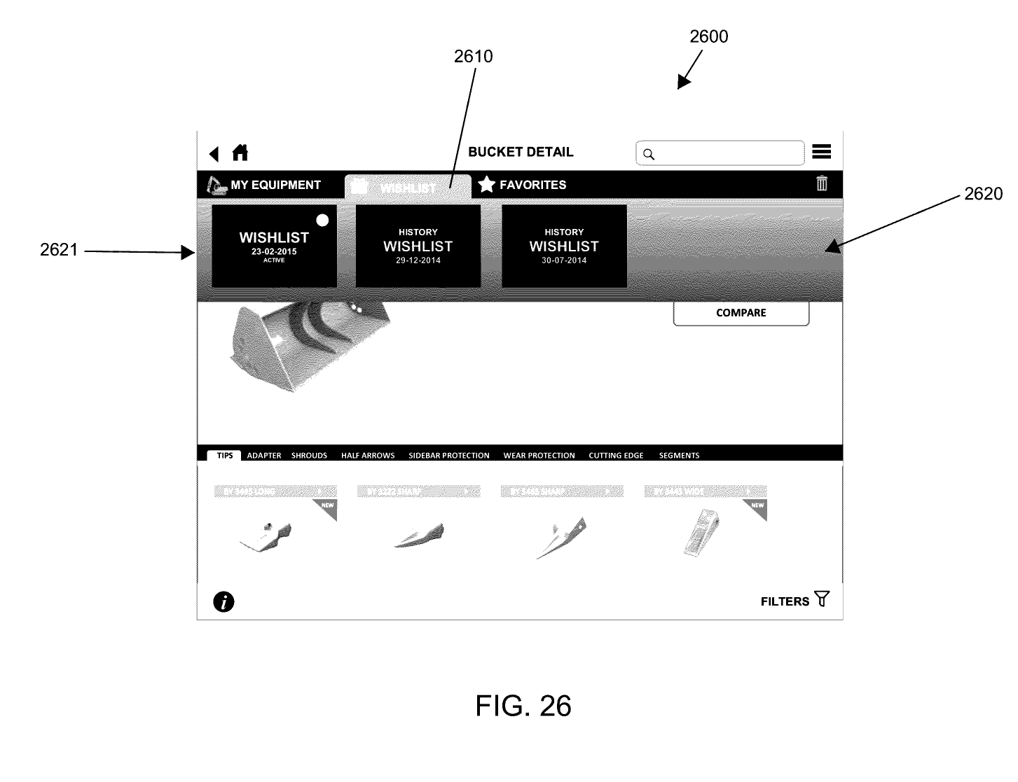

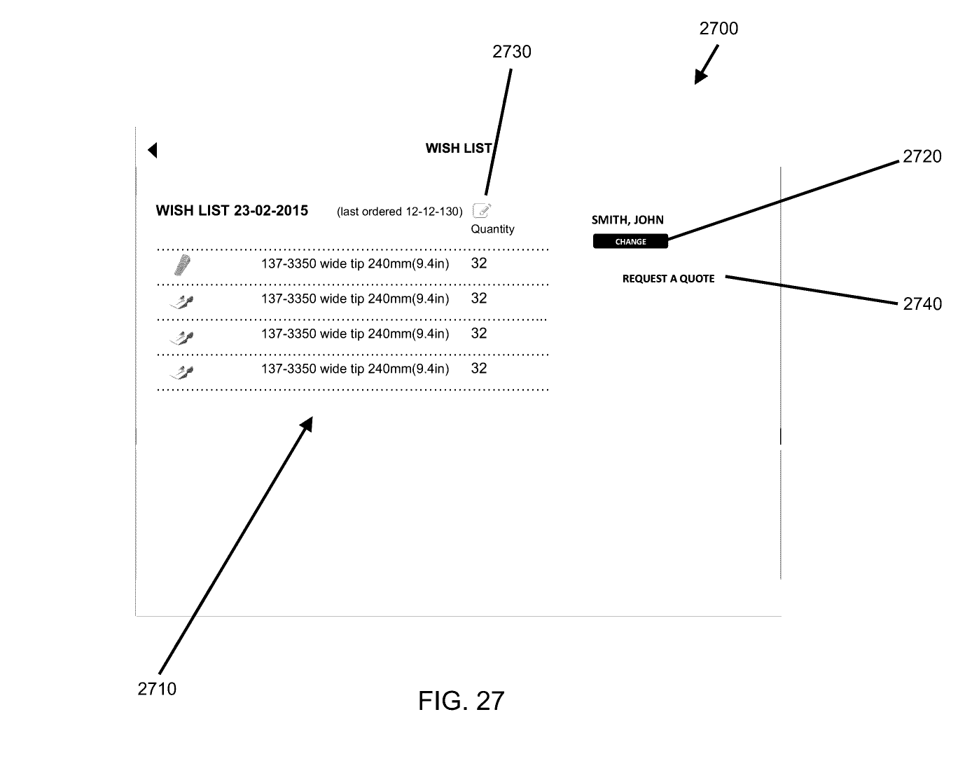

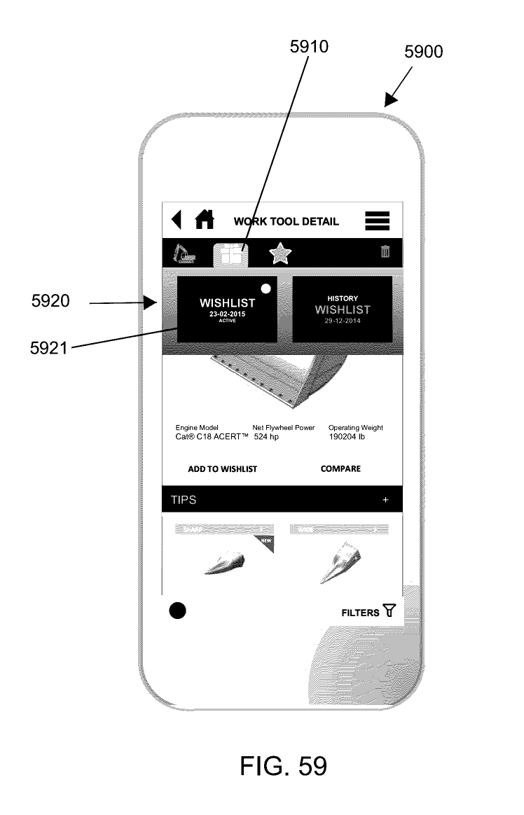

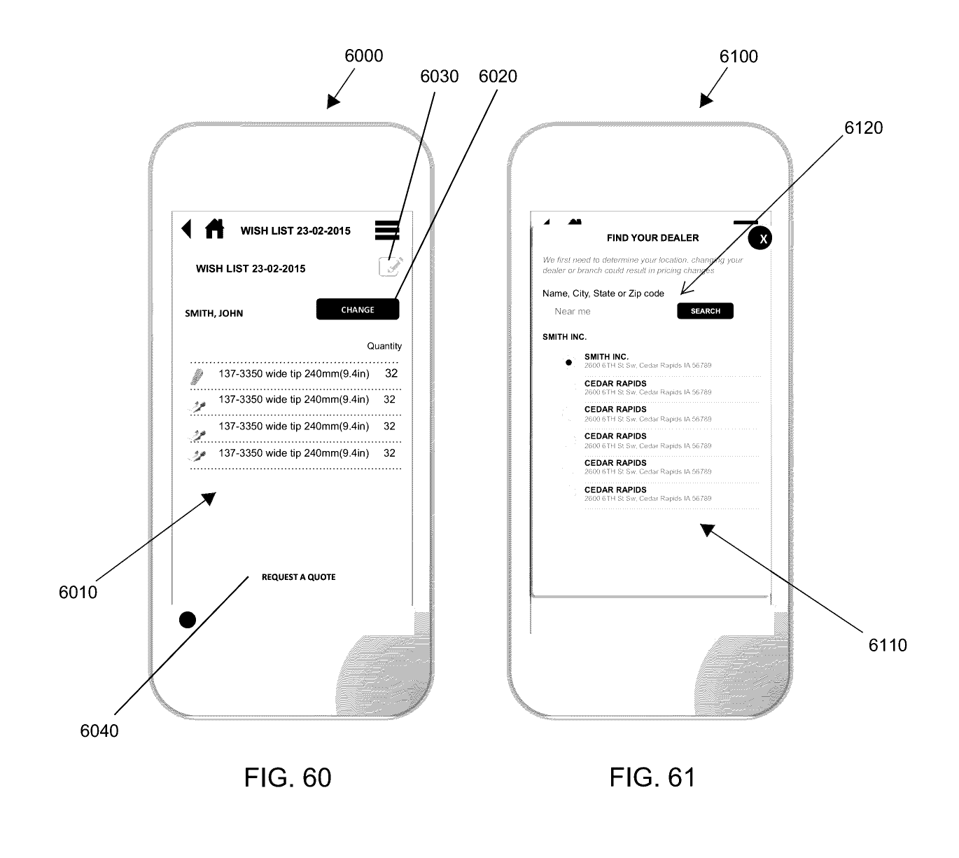

FIGS. 26 and 59 show GUI displays 2600 and 5900, which may be generated by selecting a “Wishlist” icon or tab 2610, 5910 located near a top pane or section of the screen. By selecting the “Wishlist” icon or tab 2610, 5910, a wishlist panel 2620, 5920 may expand or drop down from the “Wishlist” icon or tab 2610, 5910. GET parts which may have been previous added using an “Add to Wishlist” button may appear in one or more wishlist entries 2621, 6121 appearing in the wishlist panel 2620, 5920. The wishlist entries 2621, 5921 may be selected to display a list of the GET parts that have been added and associated with that wishlist. In one aspect, FIGS. 27 and 60 show GUI displays 2700 and 6000 which may be generated by selecting the wishlist entries 2621, 5921 in FIGS. 26 and 59, respectively. The GUI displays 2700 and 6000 may show a chart 2710, 6010 of GET parts previously added to the selected wishlist. The chart 2710, 6010 may include a graphical representation, textual information, and quantity relating to the GET parts listed in the charts 2710, 6010.

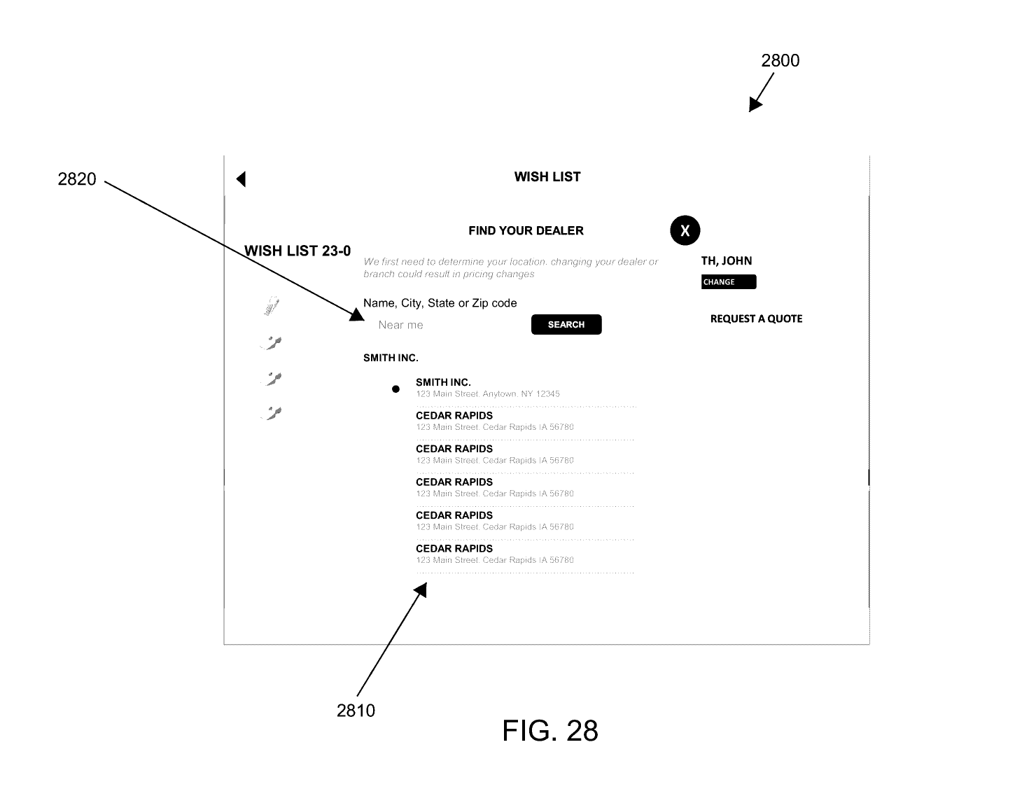

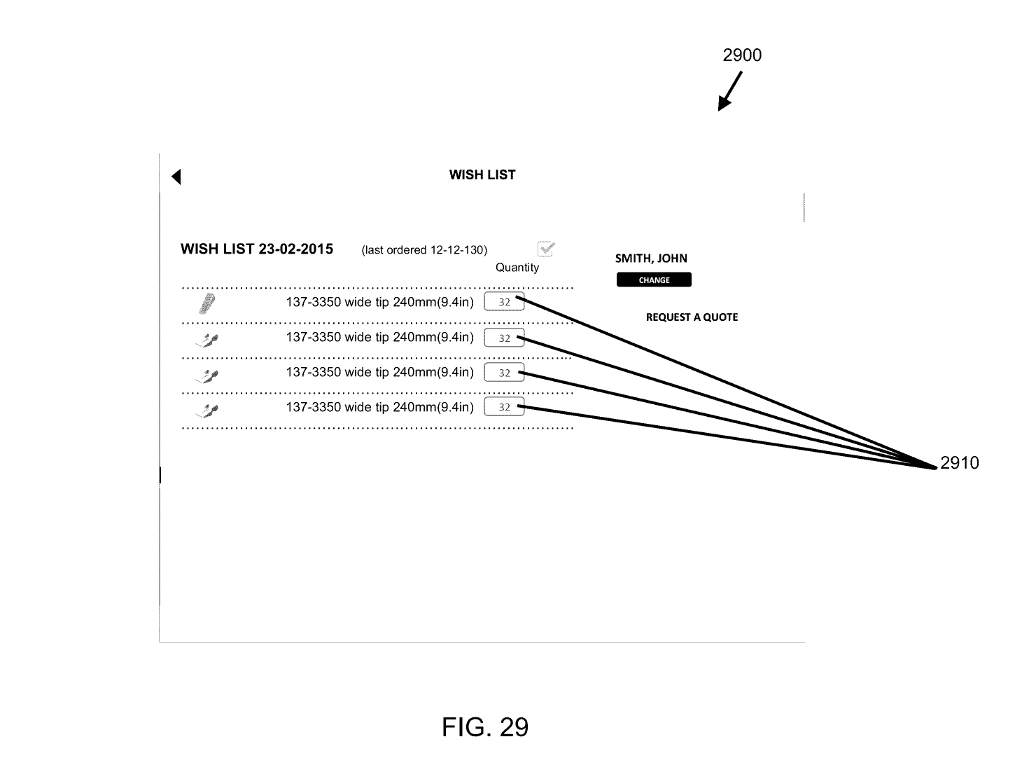

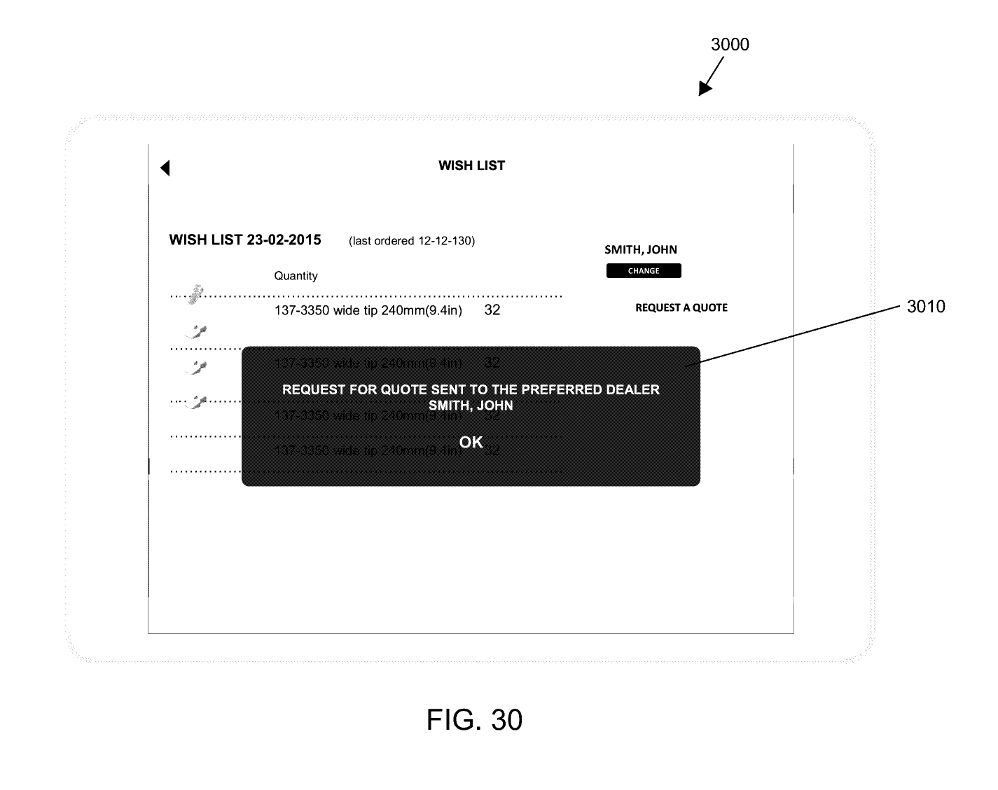

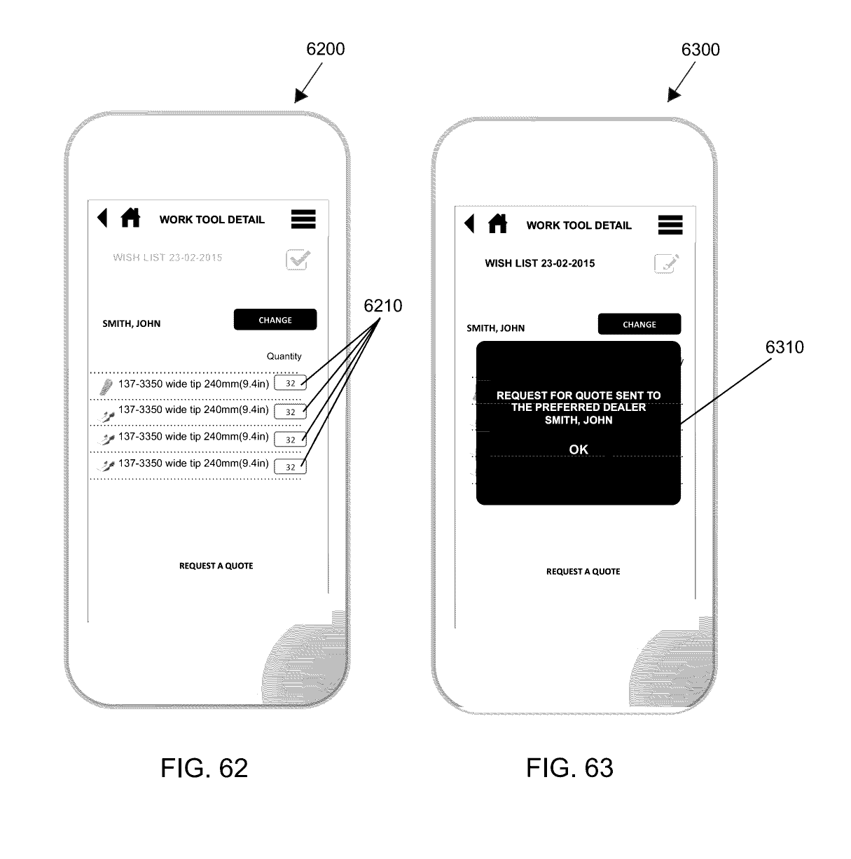

In one aspect, FIGS. 28 and 61 show GUI displays 2800 and 6100 which may be generated by selecting a “Change” dealer button 2720, 6020 in FIGS. 27 and 60, respectively. The GUI displays 2800 and 6100 may populate a list 2810, 6110 of nearby dealers from which the GET parts may be ordered from. Additionally or alternatively, a search tool 2820, 6120 may be used by inputting a name, city, state, and/or zip code into a text box to search for nearby dealers. In one aspect, FIGS. 29 and 62 show GUI displays 2900 and 6200 which may be generated by selecting an edit quantity button 2730, 6030 in FIGS. 27 and 60, respectively. The GUI displays 2900 and 6200 may enable a quantities field 2910, 6210 of the GET parts to be changed and updated. In one aspect, FIGS. 30 and 63 show GUI displays 3000 and 6300 which may be generated by selecting a “Request a Quote” button 2740, 6040 in FIGS. 27 and 60, respectively. The GUI displays 3000 and 6300 may display a confirmation message 3010, 6310 that a quote request has been sent to the dealer after the “Request a Quote” button 2740, 6040 in FIGS. 27 and 60 has been selected. In one aspect, the quote request may be sent to the dealer device 140 via the network 110.

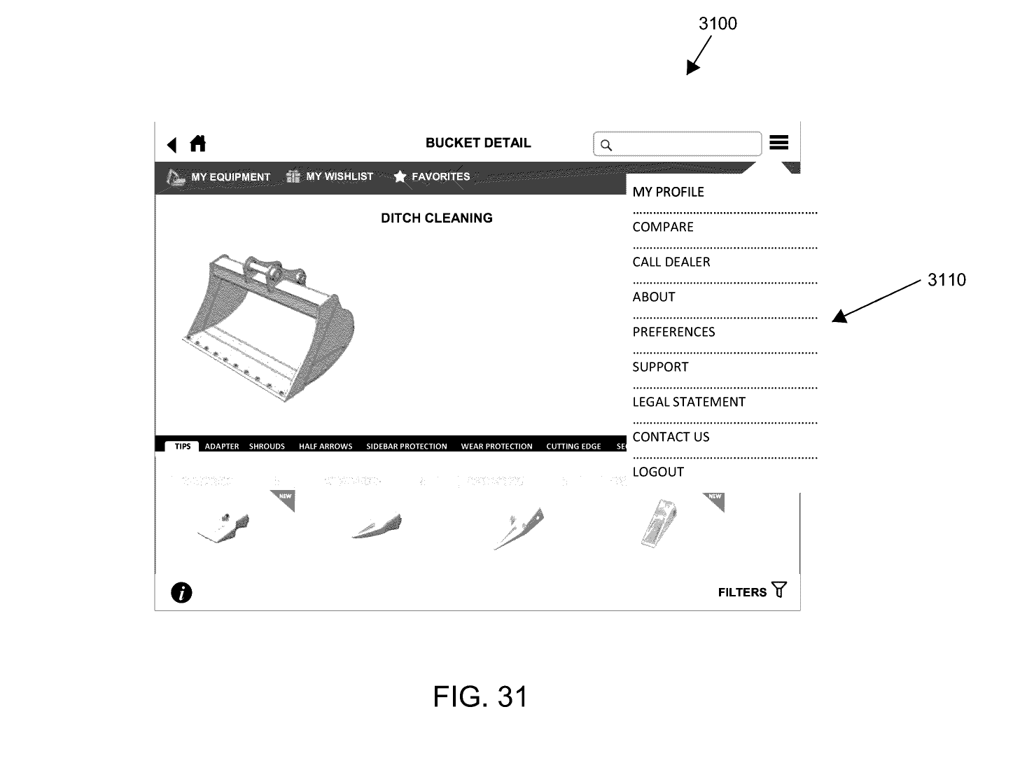

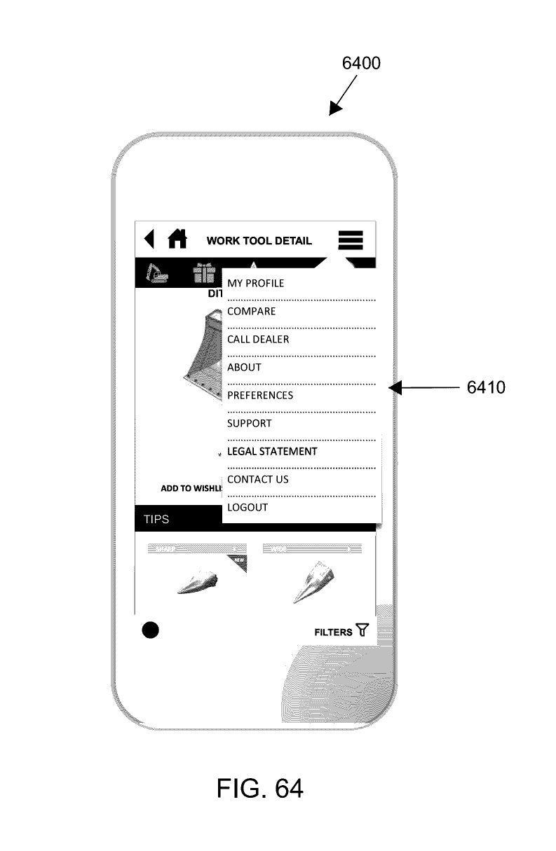

FIGS. 31 and 64 show GUI displays 3100 and 6400 with a main menu 3110, 6410 expanded. The main menu 3110, 6410 may be expanded by selecting a menu button 3111, 6411 to show various menu options. In one aspect, the menu button 3111, 6411 may be located at a upper-right corner of the display. The main menu 3110, 6410 may include one or more of the following menu options: “My Profile,” “Compare,” “Call Dealer,” “About,” “Preferences,” “Support,” “Legal Statement,” “Contact Us,” and “Logout.”

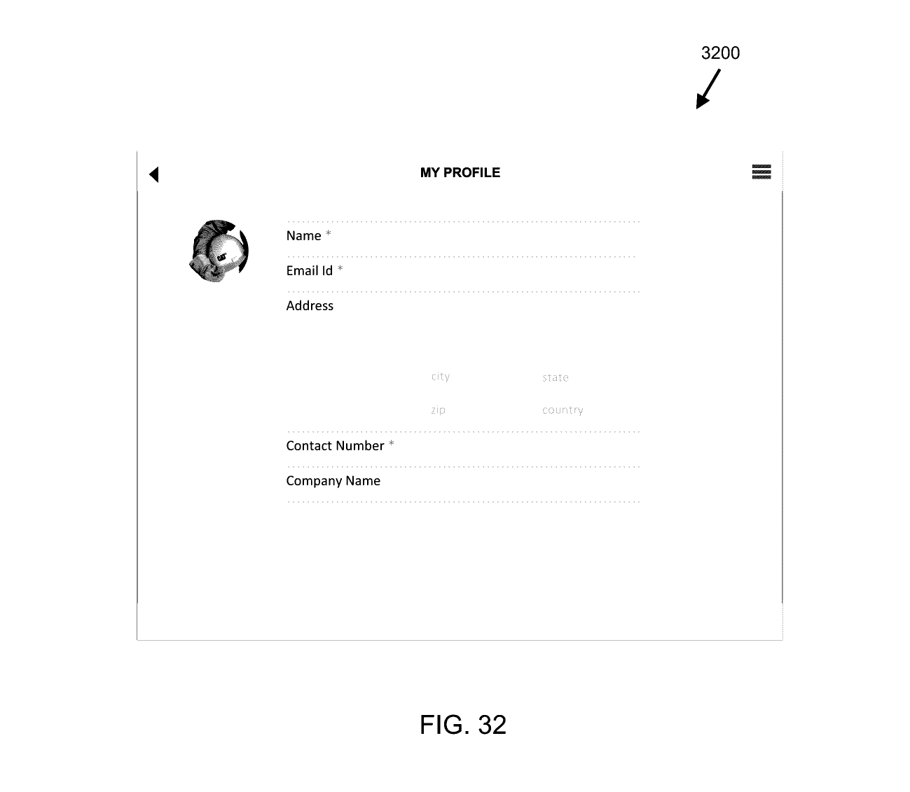

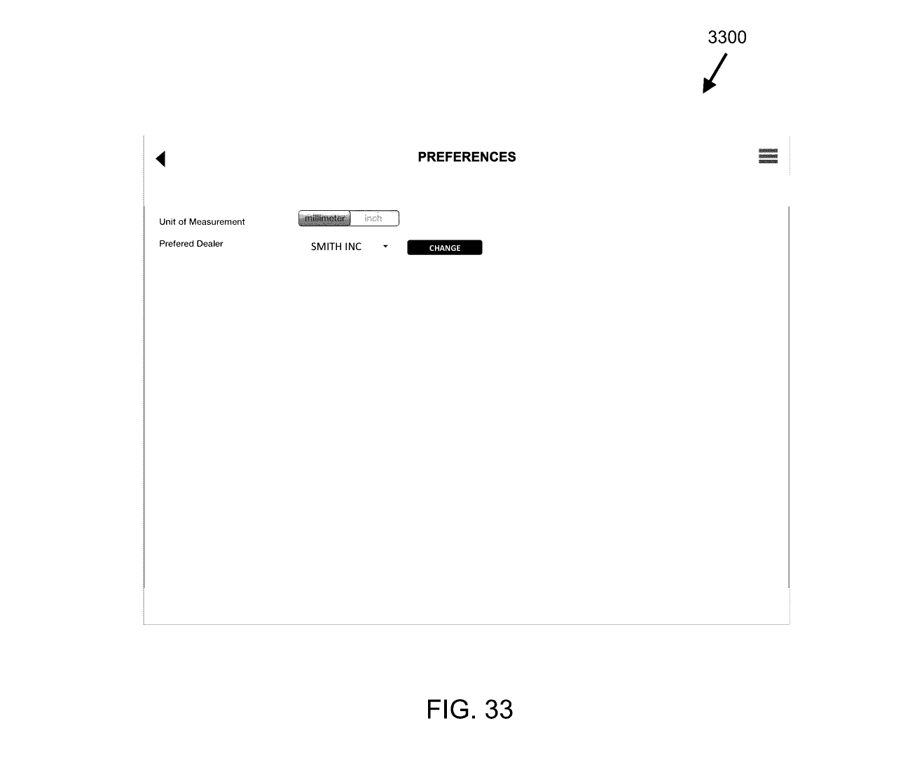

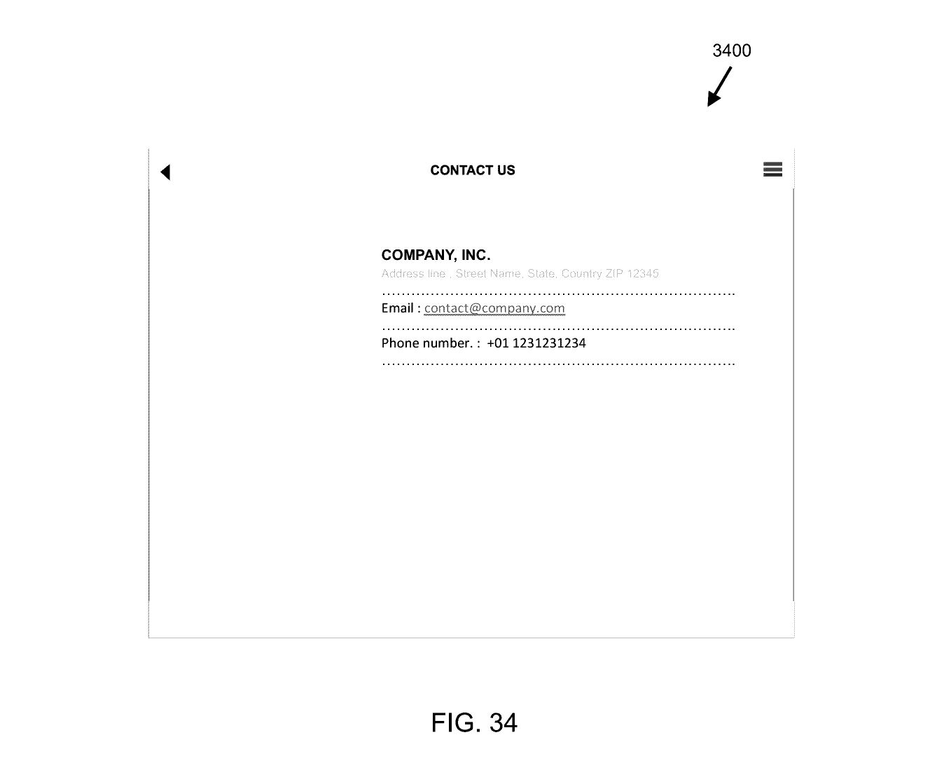

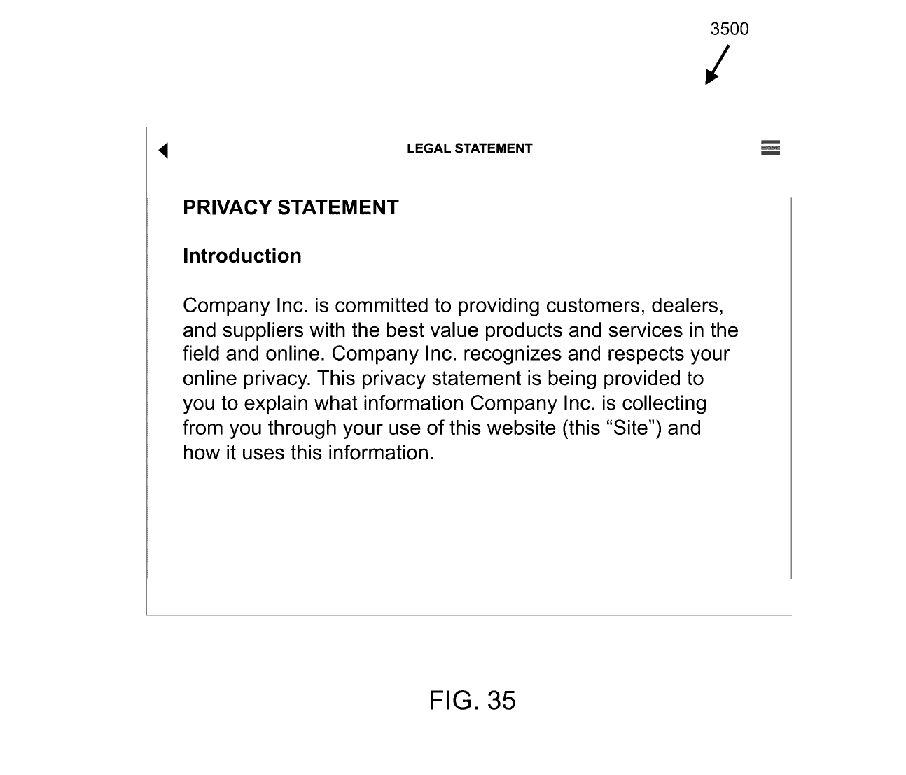

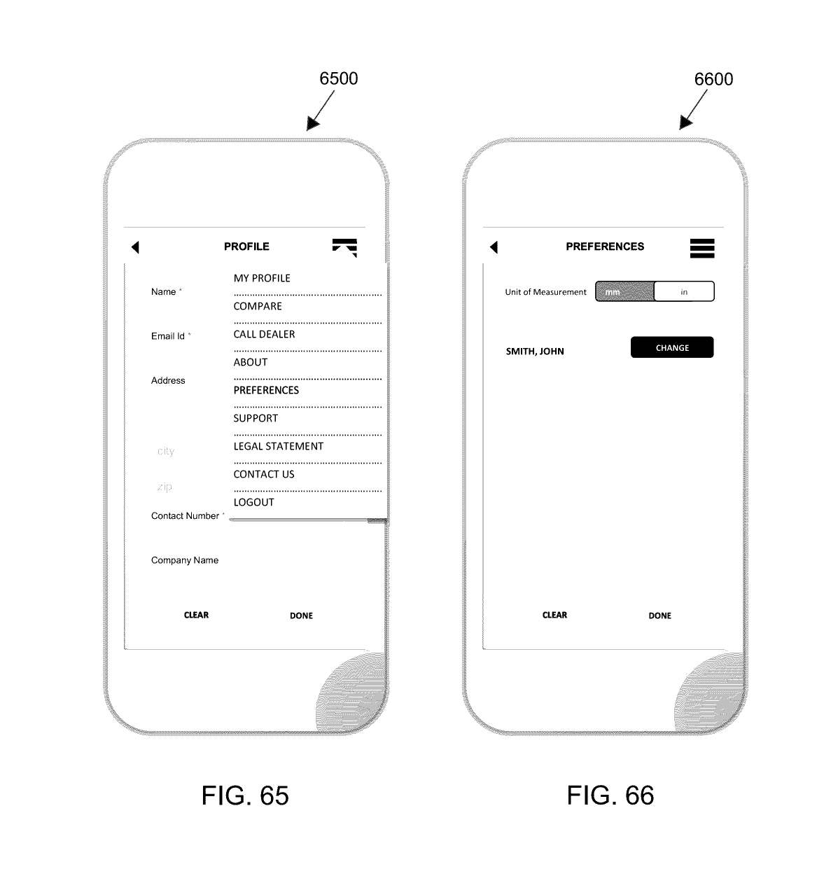

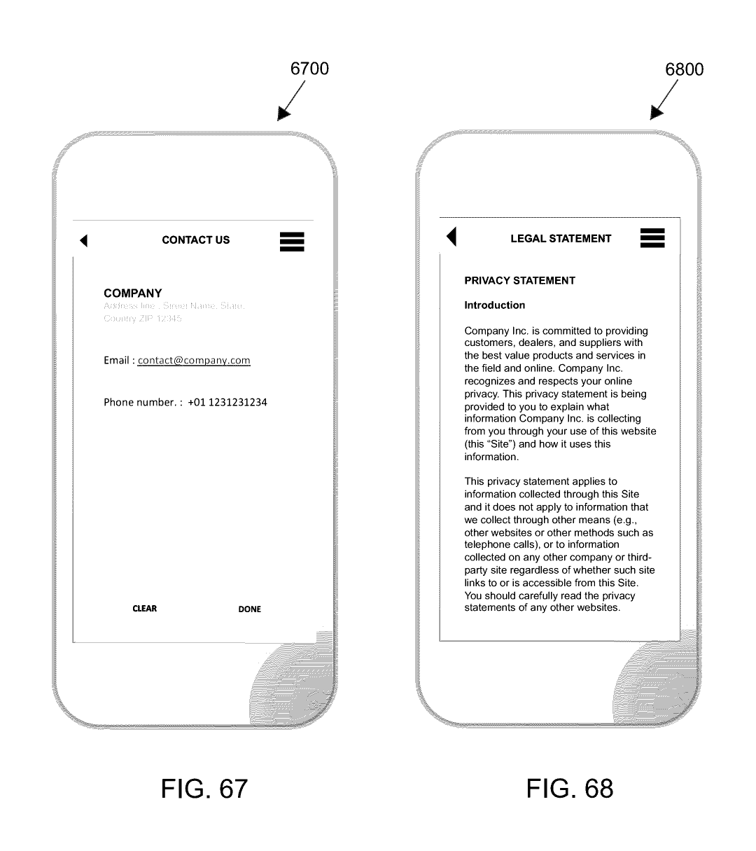

FIGS. 32 and 65 show GUI displays 3200 and 6500 when the “My Profile” option is selected from main menu 3110, 6410, respectively. FIGS. 33 and 66 show GUI displays 3300 and 6600 when the “Preferences” option is selected from main menu 3110, 6410, respectively. FIGS. 34 and 67 show GUI displays 3400 and 6700 when the “Contact Us” option is selected from main menu 3110, 6410, respectively. FIGS. 35 and 68 show GUI displays 3500 and 6800 when the “Legal Statement” option is selected from main menu 3110, 6410, respectively.

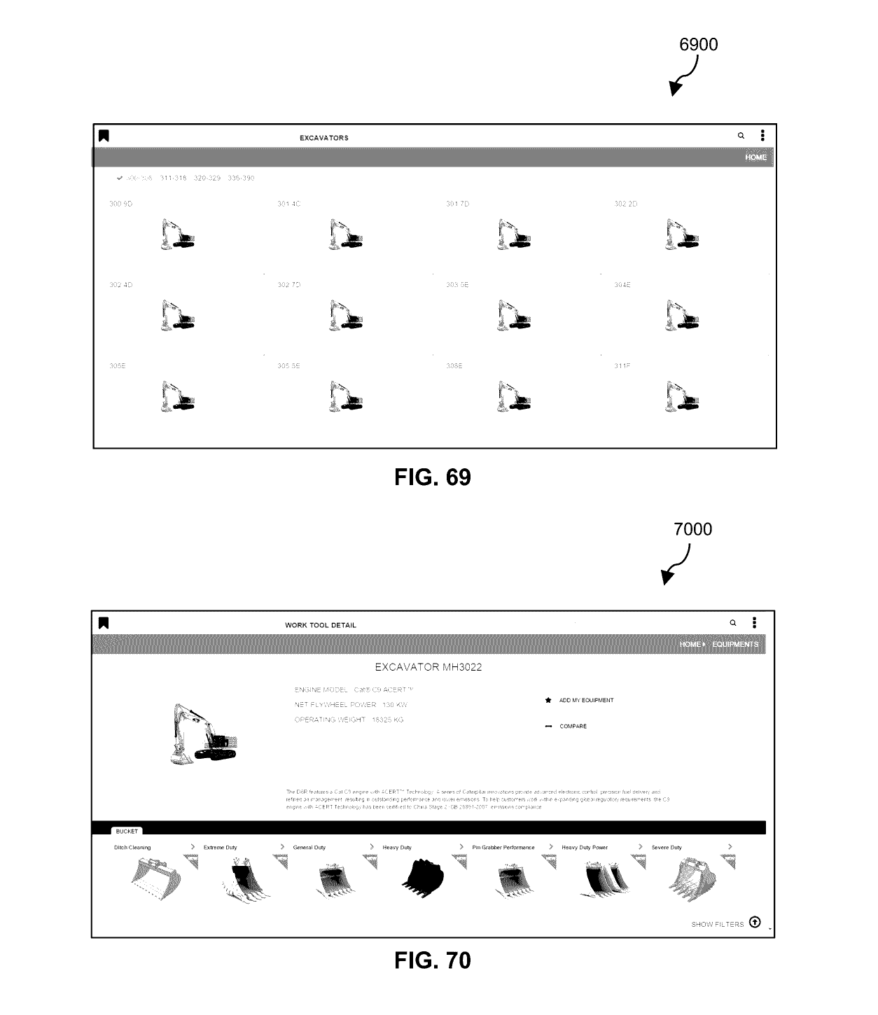

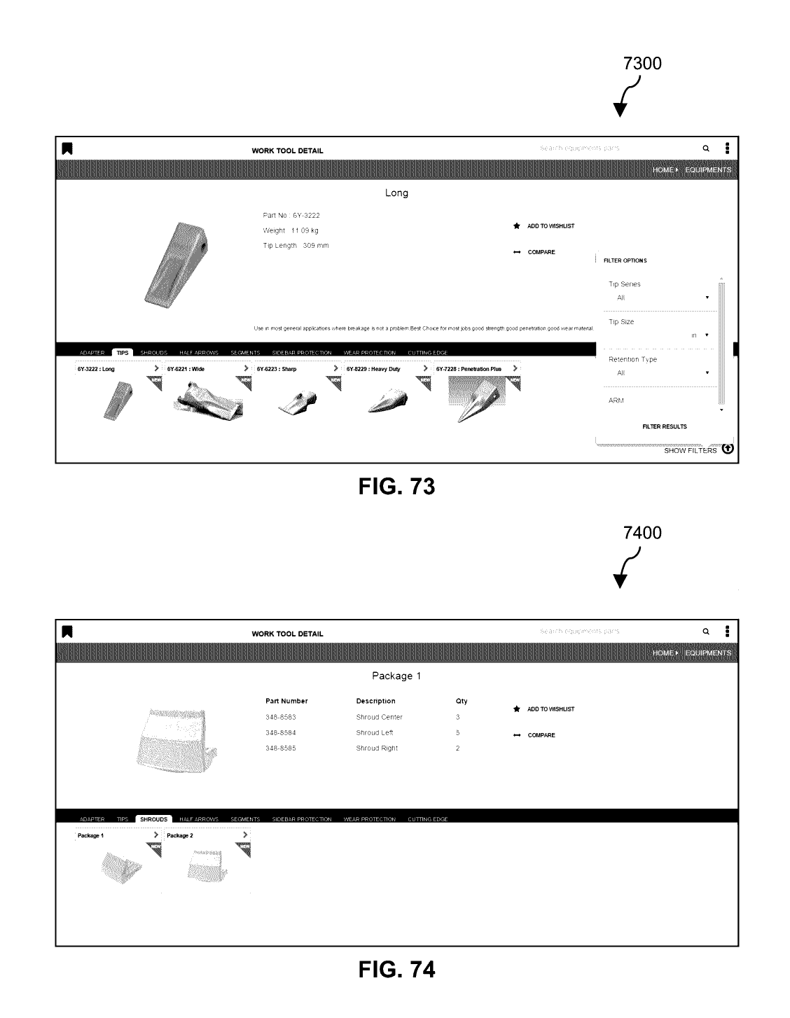

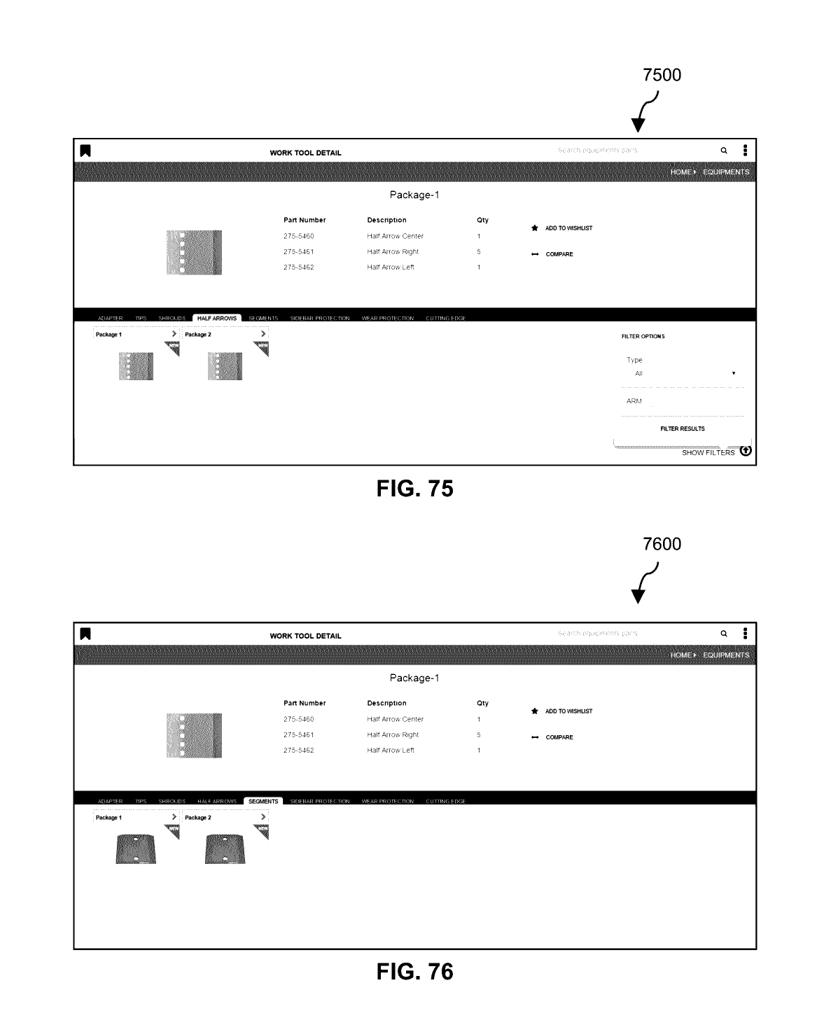

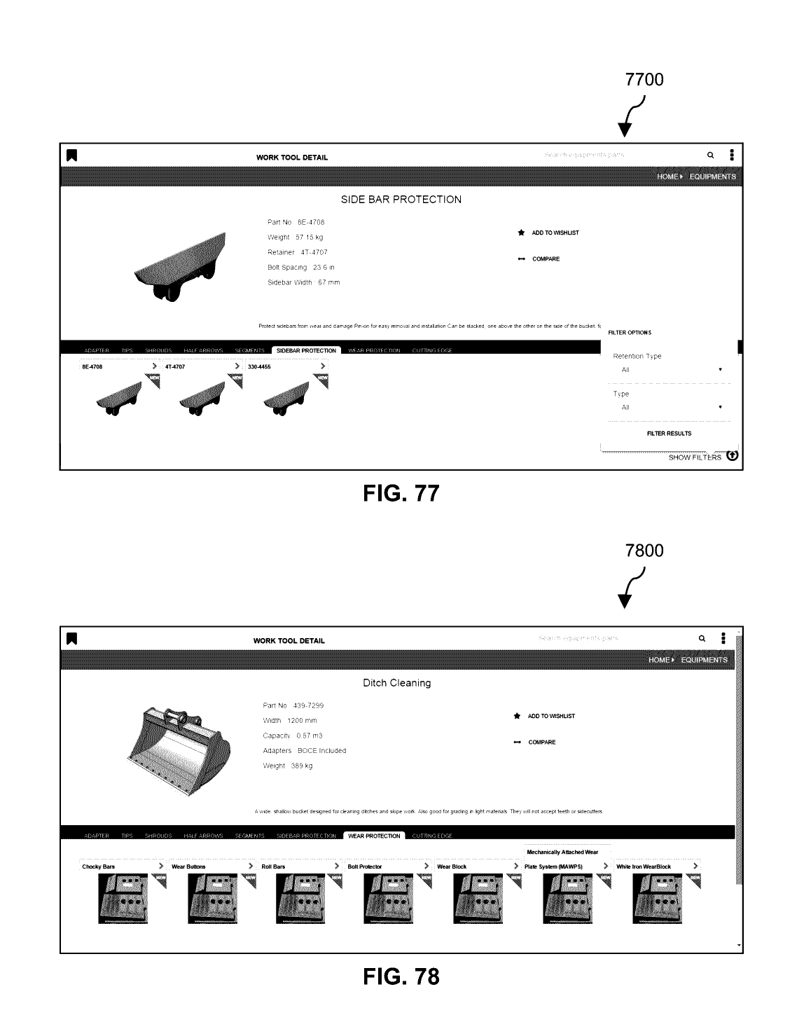

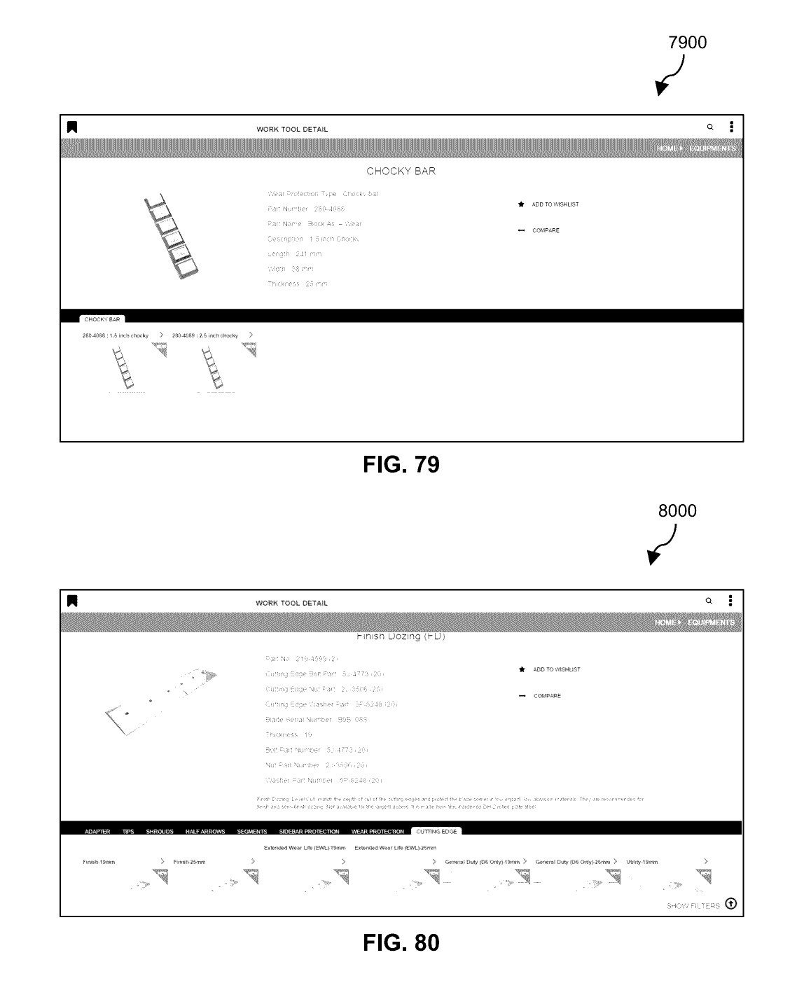

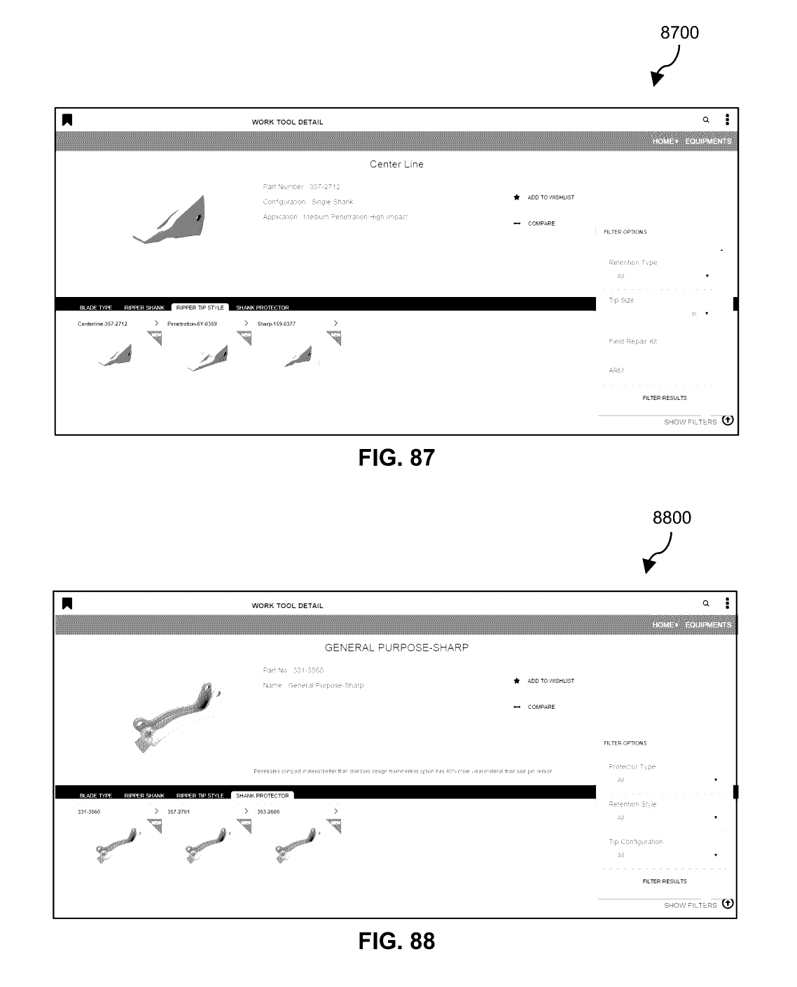

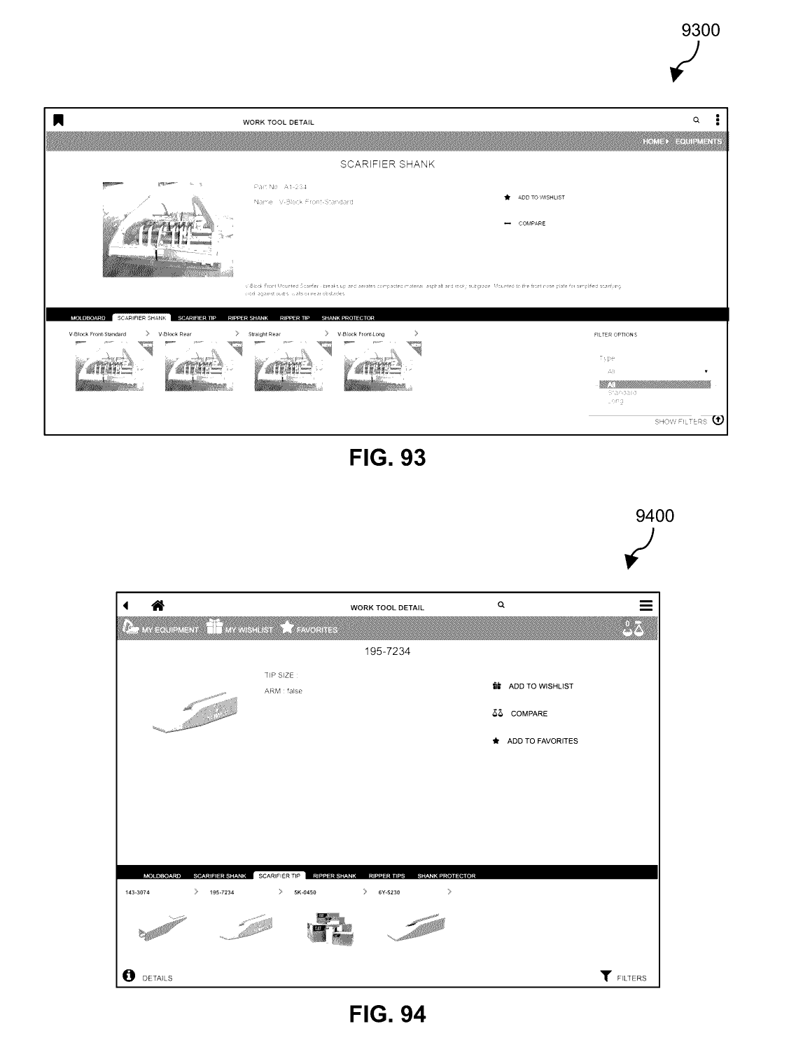

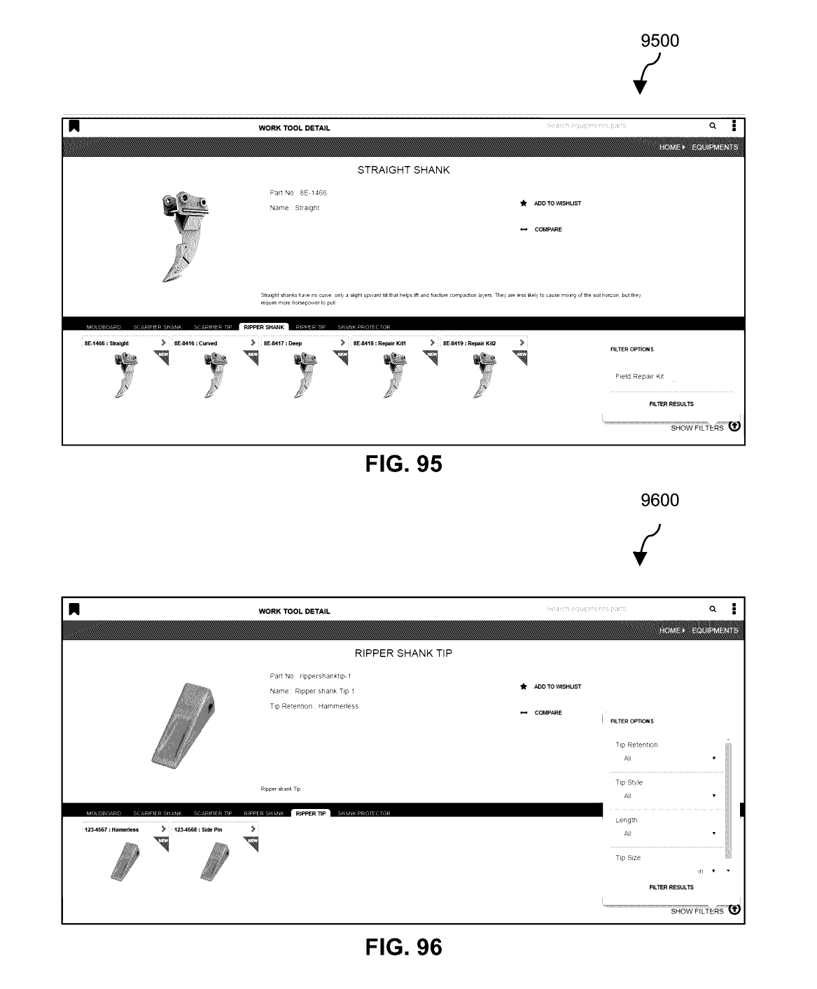

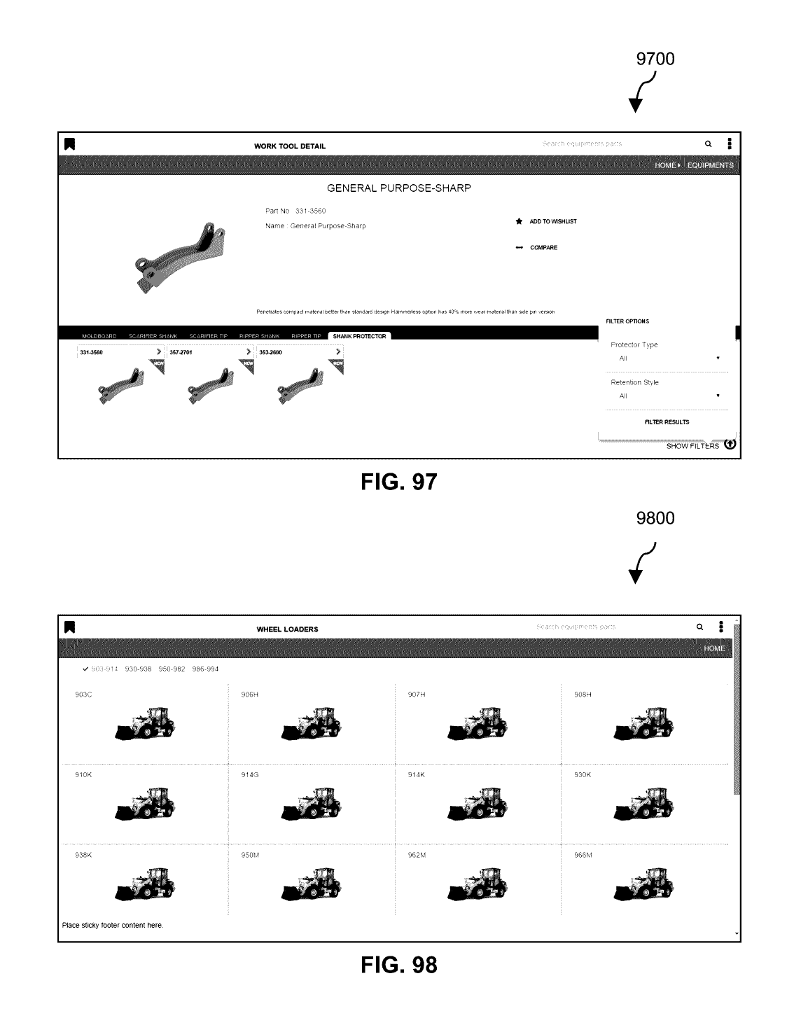

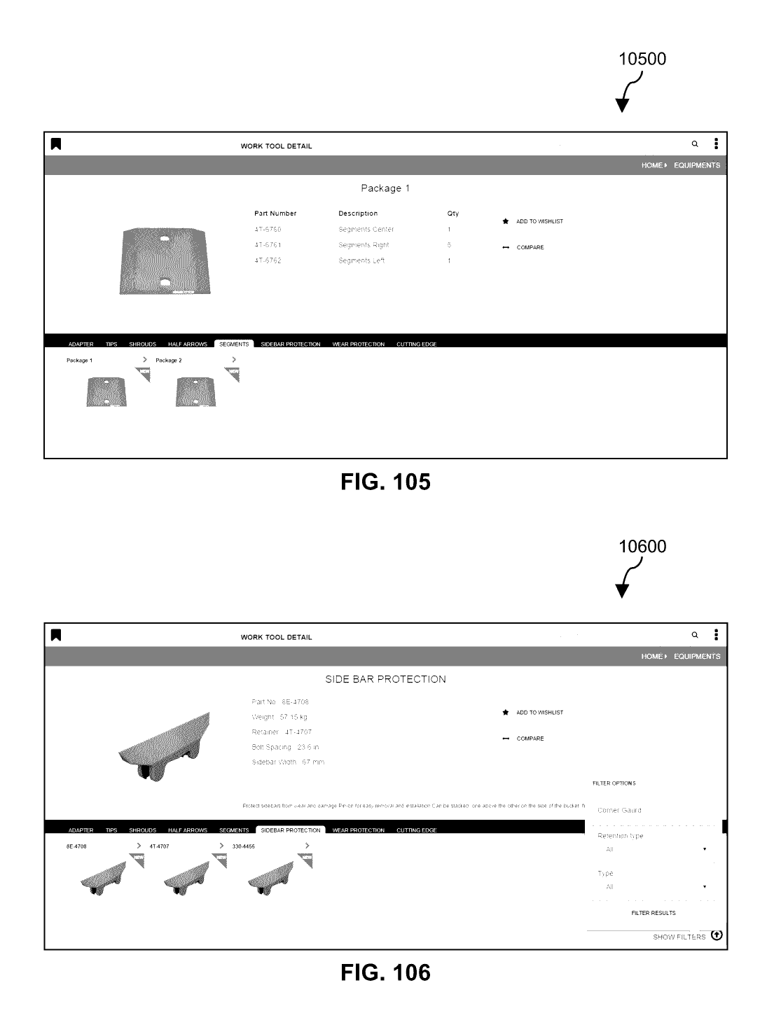

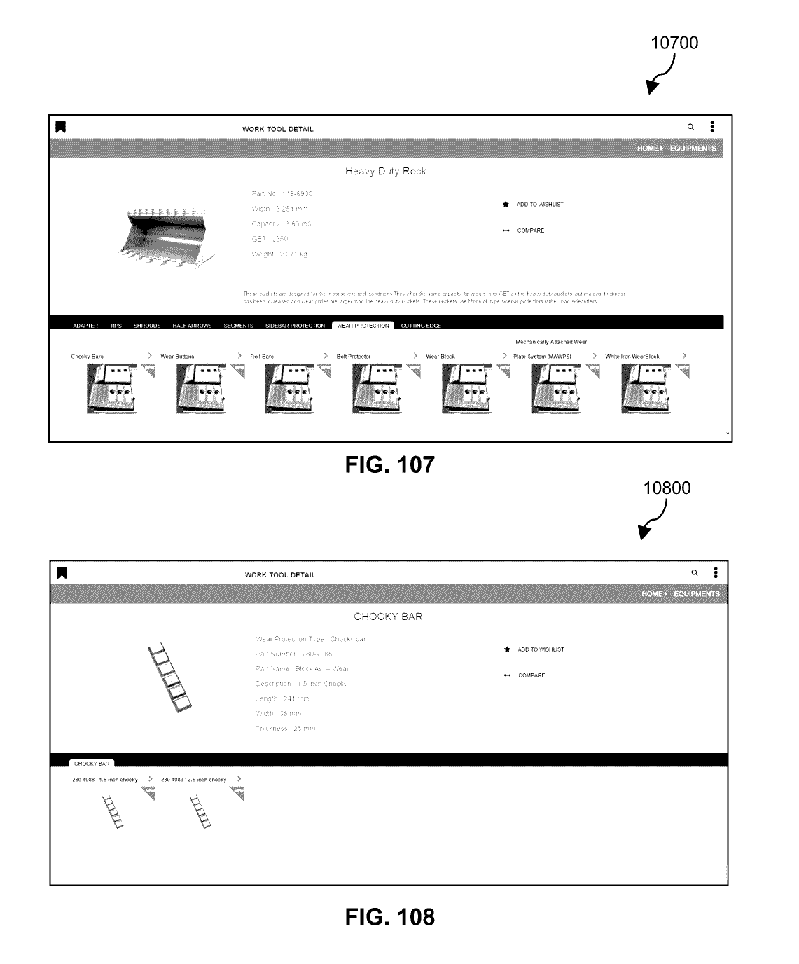

The taxonomy of the GET parts will now be discussed with reference to FIGS. 69-109, which show exemplary GUIs for interacting with the operator and displaying information based on different machine types. As discussed above with reference to step 520 of the flowchart 500, the operator may select the machine type, the model, and/or the attachment to narrow down, identify, and validate compatible GET parts. As described above, the machine types may include one or more of: excavator, motor grader, wheel loader, and track type tractor.

FIGS. 69-80 are GUI displays related to the excavator machine type. FIG. 69 shows GUI display 6900 which may show a grid of selectable excavators if the operator selects the excavator machine type in step 520. The operator may then choose, by clicking or tapping, one of the excavators shown in the grid depending on which model of excavator the operator is interest in conducting a search of GET parts for. In one aspect, the grid of selectable excavators may be displayed in a central pane of the display, and the grid may be scrolled up/down or left/right to reveal additional selectable excavators, if any.

Once a model has been selected by the operator, FIG. 70 shows GUI display 7000 which may be generated to show graphical and textual information relating to the selected model of excavator. The information relating to the selected model of excavator may be displayed in a central pane of the display. Attachments relating to the selected model may be displayed in a lower pane or section of the display. In one aspect, the attachments for excavators may include various bucket types, including but not limited to: ditch cleaning, extreme duty, general duty, heavy duty, pin grabber performance, heavy duty power, and severe duty. The operator may then choose, by clicking or tapping, one of the bucket types as part of step 520.

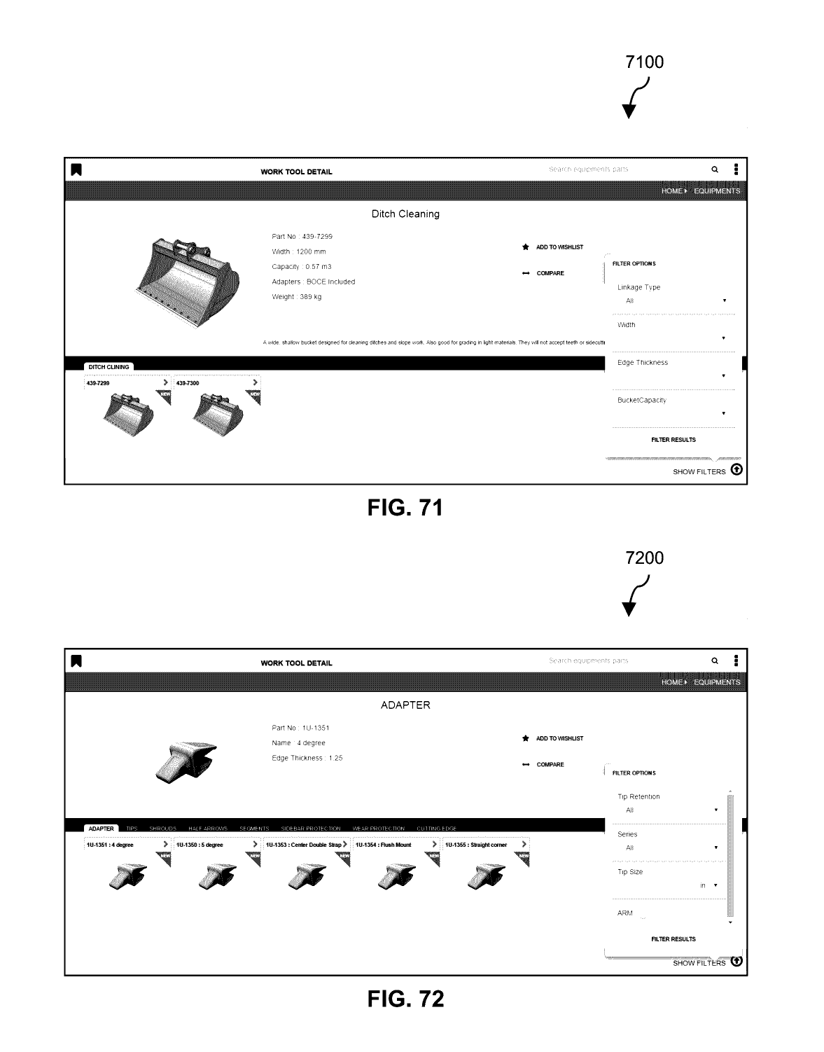

Once a bucket type has been selected by the operator, FIG. 71 shows GUI display 7100 which may be generated to show graphical and textual information relating to the selected bucket type. The information relating to the selected bucket type may be displayed in a central pane of the display. Models relating to the selected bucket type may be displayed in a lower pane or section of the display. The operator may then choose, by clicking or tapping, one of the bucket models from the lower pane or section of the display as part of step 520.

Once the bucket model has been selected by the operator, FIGS. 72-80 show GUI displays 7200, 7300, 7400, 7500, 7600, 7700, 7800, 7900, and 8000 which may be generated to show graphical and textual information relating to GET parts that are compatible based on the excavator model and bucket type information retrieved from the operator in step 520. The compatible GET parts may be displayed in a lower pane or section of the GUI displays 7200, 7300, 7400, 7500, 7600, 7700, 7800, 7900, and 8000. Where there are multiple categories of GET parts, the GET parts may be grouped under separate tabs associated with the lower pane or section of the display. In one aspect, the GET parts for excavators may include one or more of the follow GET parts categories and tabs: adapter, tips, shrouds, half arrows, segments, sidebar protection, wear protection, and cutting edge. In one aspect, as shown in FIGS. 74-76, certain GET parts may be bundled as a “package” to indicate to the operator all the replaceable parts that may be necessary for a complete replacement. The operator may then have the option to add the entire package to the wishlist or shopping cart, or selectively choose only the components from the package that the operator desires.

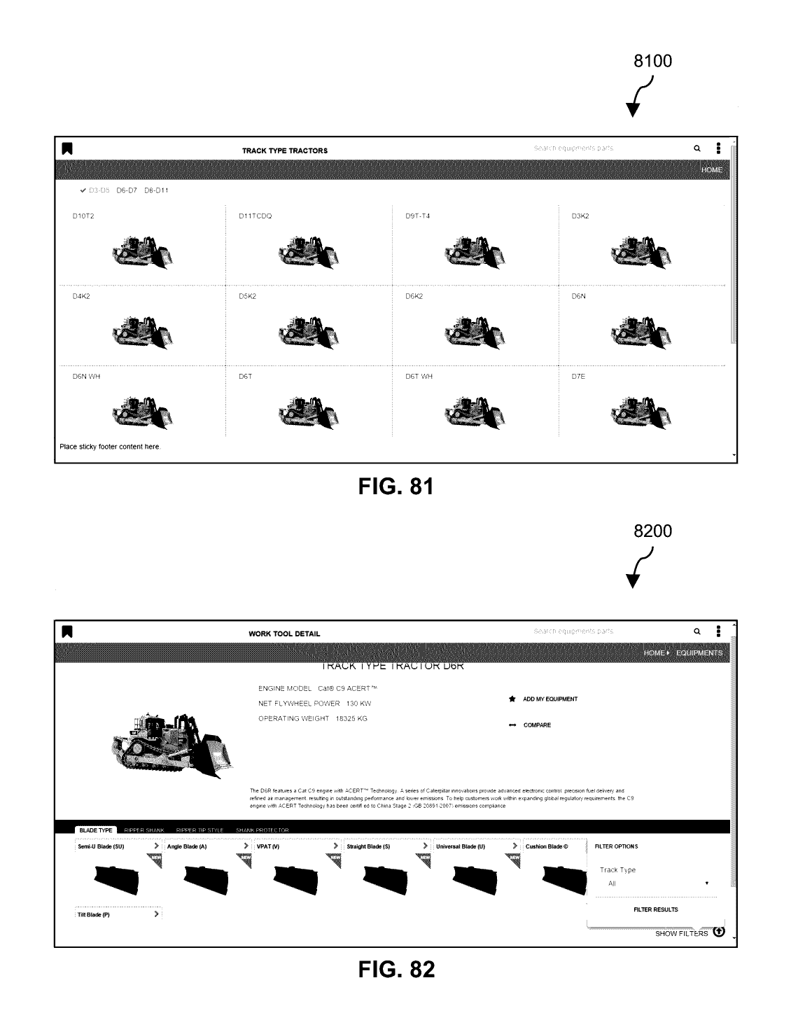

FIGS. 81-88 are GUI displays related to the track type tractors machine type. FIG. 81 shows GUI display 8100 which may include a grid of selectable track type tractors if the operator selects the track type tractor machine type in step 520. The operator may then choose, by clicking or tapping, one of the track type tractor shown in the grid depending on which model of track type tractor the operator is interest in conducting a search of GET parts for. In one aspect, the grid of selectable track type tractor may be displayed in a central pane of the display, and the grid may be scrolled up/down or left/right to reveal additional selectable track type tractor, if any.

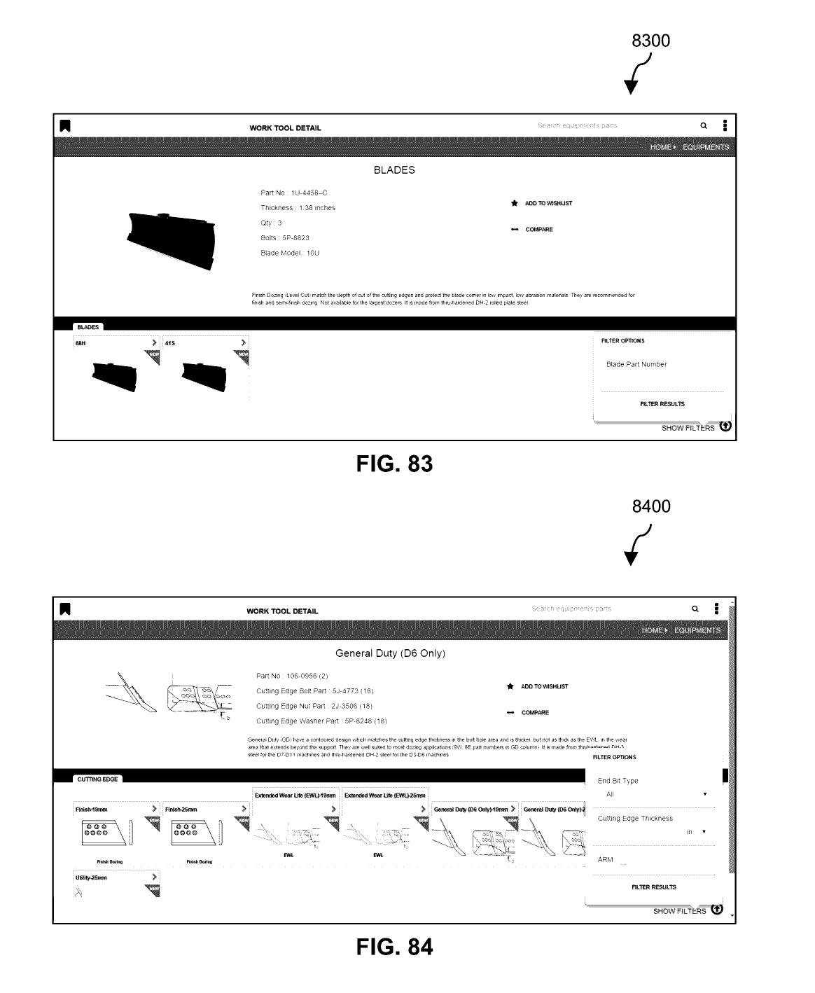

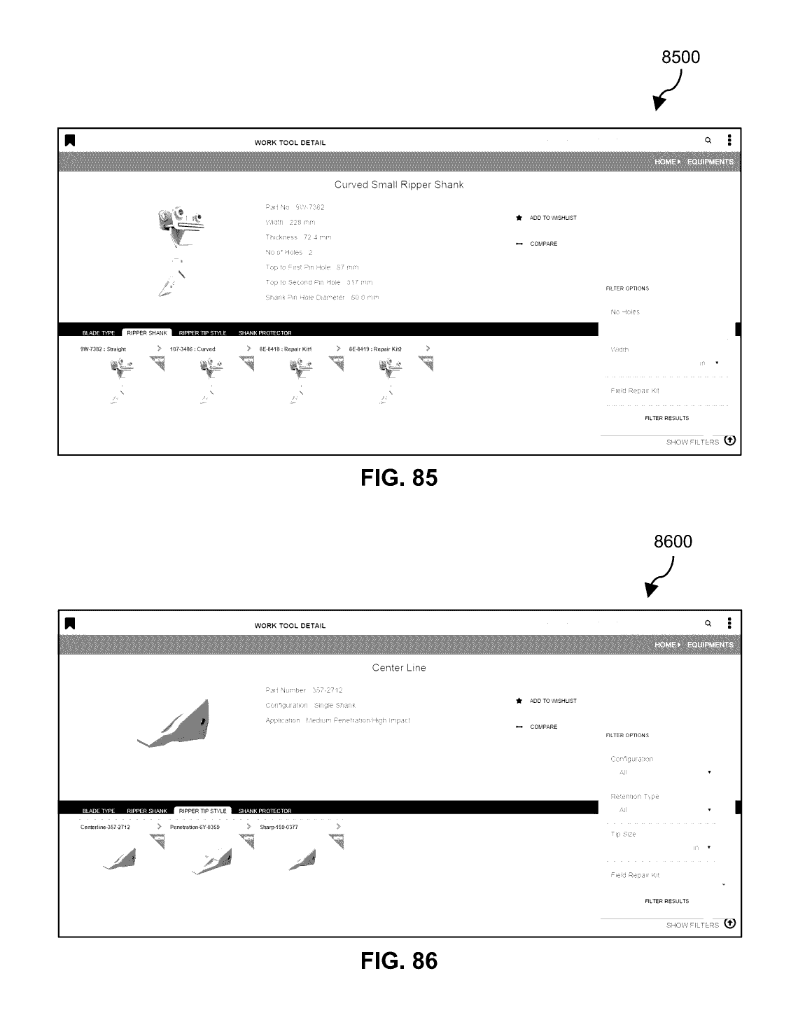

Once a model has been selected by the operator, FIG. 82 shows GUI display 8200 which may be generated to show graphical and textual information relating to the selected model of track type tractor. The information relating to the selected model of track type tractor may be displayed in a central pane of the display. Attachments relating to the selected model may be displayed in a lower pane or section of the display. In one aspect, as shown in FIG. 82, the attachments for track type tractors may include blades, including but not limited to: Semi-U Blade, Angle Blade, Variable Path (VPAT), Angle, and Tilt Blade, Straight Blade, Universal Blade, and Cushion Blade. In one aspect, as shown in FIGS. 85, 86, and 88, GUI displays 8500, 8600, and 8800 show that the attachments for track type tractors may include ripper shanks, ripper tips, and shank protectors. As with the blades of FIG. 82, the attachments may be displayed in a lower pane or section of the display. In the case of the blades of FIG. 82, the operator may have a further option of selecting a model of blade, as shown in GUI display 8300 of FIG. 83.

Once an attachment type and model, if applicable, has been selected by the operator, FIGS. 84-88 shows GUI displays 8400, 8500, 8600, 8700, and 8800 which may be generated to show graphical and textual information relating to GET parts that are compatible based on the track type tractor model and attachment information retrieved from the operator in step 520.

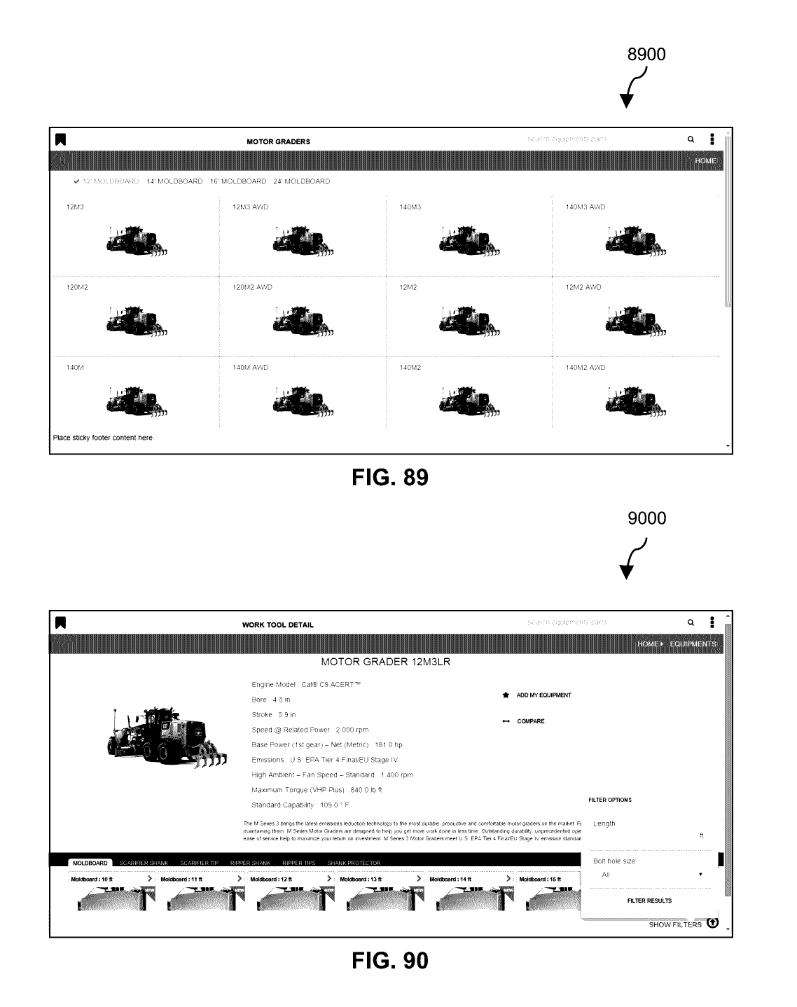

FIGS. 89-97 are GUI displays related to the motor grader machine type. FIG. 89 shows GUI display 8900 which may include a grid of selectable motor graders if the operator selects the motor grader machine type in step 520. The operator may then choose, by clicking or tapping, one of the motor graders shown in the grid depending on which model of motor grader the operator is interest in conducting a search of GET parts for. In one aspect, the grid of motor graders may be displayed in a central pane of the display, and the grid may be scrolled up/down or left/right to reveal additional motor graders, if any.

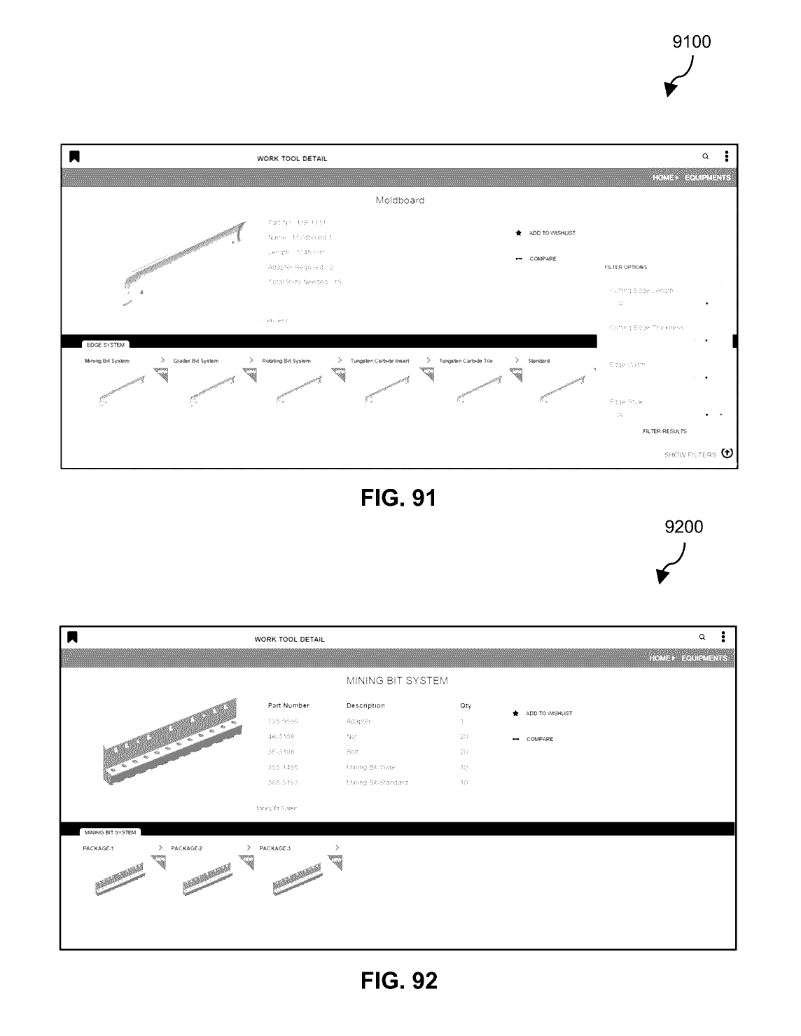

Once a model has been selected by the operator, FIG. 90 shows GUI display 9000 which may be generated to show graphical and textual information relating to the selected model of motor grader. The information relating to the selected model of motor grader may be displayed in a central pane of the display. Attachments relating to the selected model may be displayed in a lower pane or section of the display. In one aspect, as shown in FIGS. 90 and 93-97, GUI displays 9000, 9300, 9400, 9500, 9600, 9700 show that the attachments for motor graders may include: moldboard, scarifier shank, scarifier tip, ripper shank, ripper tips, and shank protector. For certain attachments, such as the moldboard shown in GUI displays 9100 and 9200 of FIGS. 91 and 92, additional model information may be retrieved from the operator in order to identify compatible GET parts and/or packages of parts.

Once an attachment type and model, if applicable, has been selected by the operator, GET parts displayed in the lower pane or section of the display may be selected to show graphical and textual information relating to GET parts that are compatible based on the motor grader model and attachment information retrieved from the operator in step 520

FIGS. 98-109 are GUI displays related to the wheel loader machine type. FIG. 98 shows GUI display 9800 which may include a grid of selectable wheel loaders if the operator selects the wheel loader type in step 520. The operator may then choose, by clicking or tapping, one of the wheel loader shown in the grid depending on which model of wheel loader the operator is interest in conducting a search of GET parts for. In one aspect, the grid of selectable wheel loaders may be displayed in a central pane of the display, and the grid may be scrolled up/down or left/right to reveal additional selectable excavators, if any.

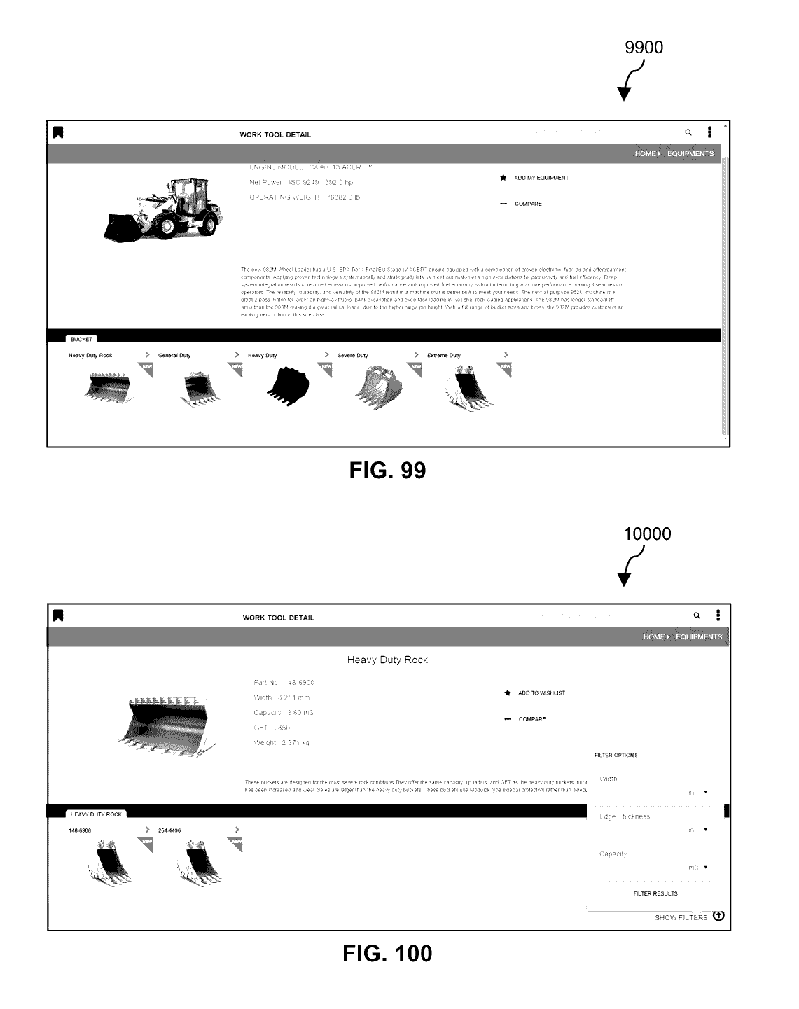

Once a model has been selected by the operator, FIG. 99 shows GUI display 9900 which may be generated to show graphical and textual information relating to the selected model of wheel loader. The information relating to the selected model of wheel loader may be displayed in a central pane of the display. Attachments relating to the selected model may be displayed in a lower pane or section of the display. In one aspect, the attachments for wheel loaders may include buckets, including but not limited to: heavy duty rock, general duty, heavy duty, severe duty, and extreme duty. The operator may then choose, by clicking or tapping, one of the bucket types as part of step 520.

Once a bucket type has been selected by the operator, FIG. 100 shows GUI display 10000 which may be generated to include graphical and textual information relating to the selected bucket type. The information relating to the selected bucket type may be displayed in a central pane of the display. Models relating to the selected bucket type may be displayed in a lower pane or section of the display. The operator may then choose, by clicking or tapping, one of the bucket models as part of step 520.

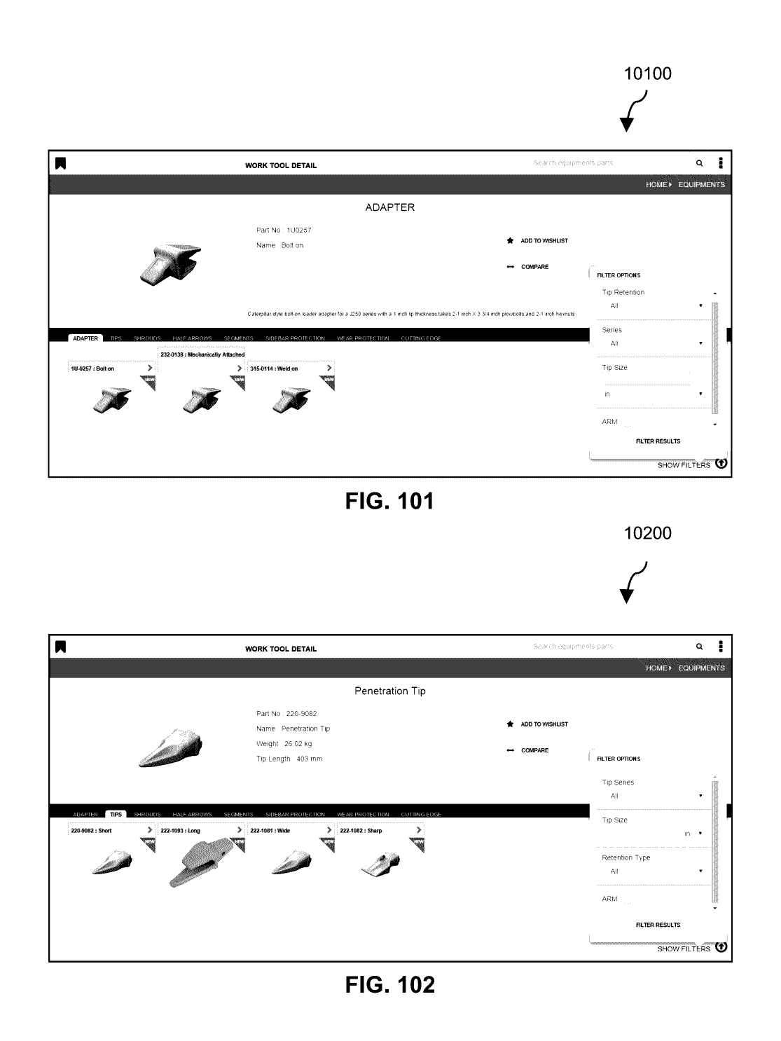

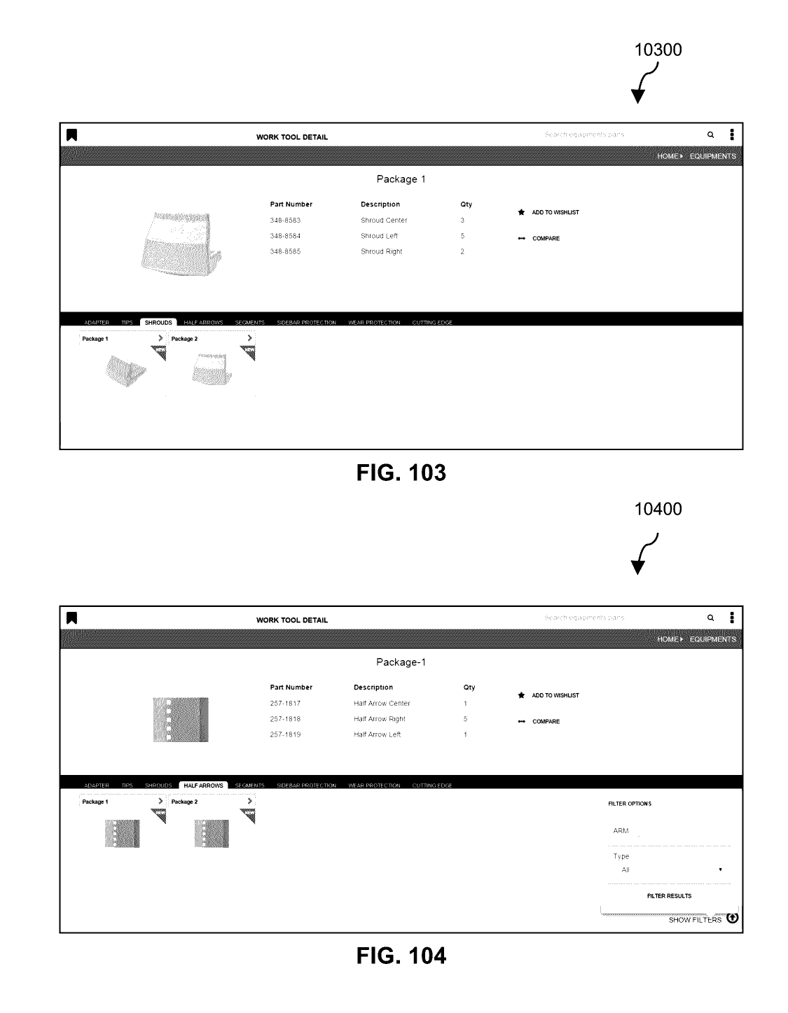

Once the bucket model has been selected by the operator, FIGS. 101-109 show GUI displays 10100, 10200, 10300, 10400, 10500, 10600, 10700, 10800, and 10900 which may be generated to show graphical and textual information relating to GET parts that are compatible based on the wheel loader model and bucket type information retrieved from the operator in step 520. The compatible GET parts may be displayed in a lower pane or section of the GUI displays 10100, 10200, 10300, 10400, 10500, 10600, 10700, 10800, and 10900. Where there are multiple categories of GET parts, the GET parts may be grouped under separate tabs associated with the lower pane or section of the display. In one aspect, the GET parts for wheel loader may include one or more of the follow GET parts categories and tabs: adapter, tips, shrouds, half arrows, segments, sidebar protection, wear protection, and cutting edge. In one aspect, as shown in FIGS. 103-105, certain GET parts may be bundled as a “package” to indicate to the operator all the replaceable parts that may be necessary for a complete replacement. The operator may then have the option to add the entire package to the wishlist or shopping cart, or selectively choose only the components from the package that the operator desires.

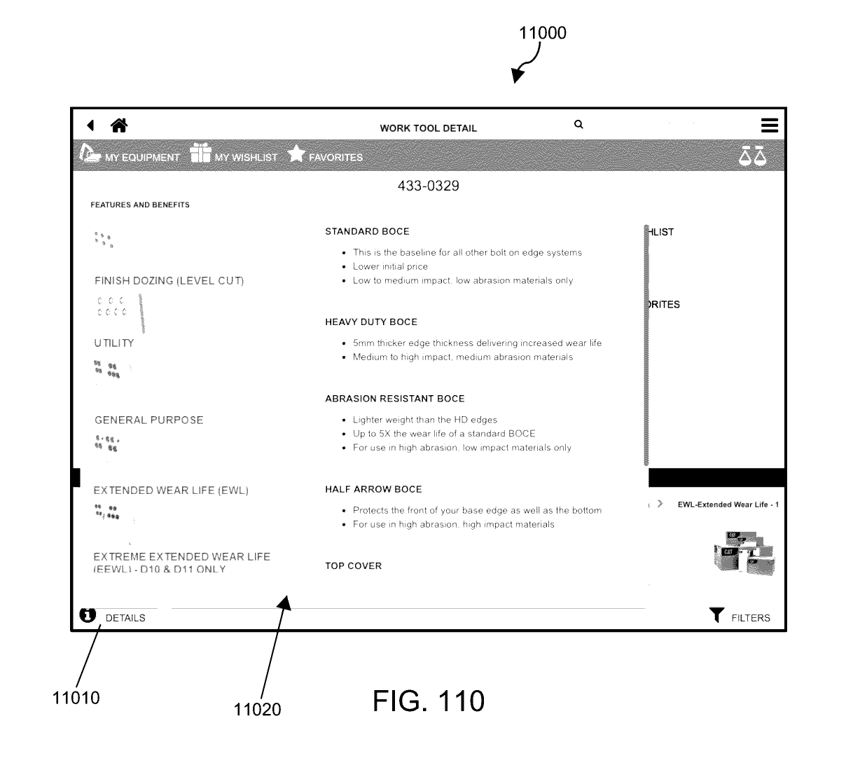

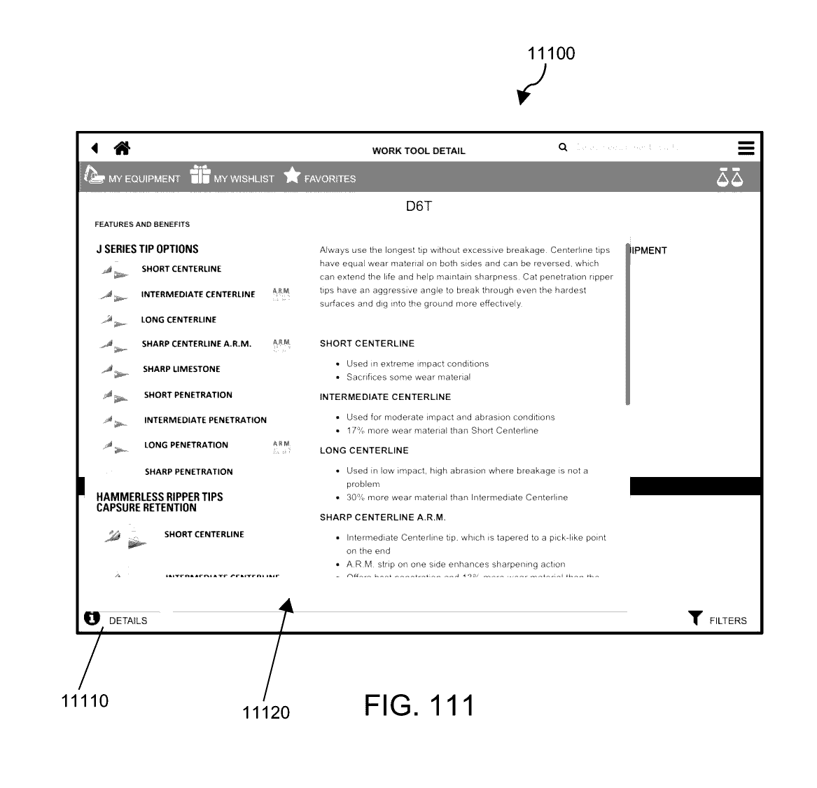

Turning to FIGS. 110 and 111, exemplary GUIs for interacting with the operator and for displaying information using an additional information feature will now be described. Similar to the GUIs generally shown in FIGS. 6-35, displays 11000 and 11100 may include an information icon or button 11010, 11110, which may be selected by the operator to open up an additional information panel 11020, 11120. In one aspect, the information panel may provide the operator with features and benefits information relating to various GET parts that are compatible with the currently selected attachment, work tool, and/or machine type. As shown in FIG. 110, various end bits and cutting edge options may be selectable to provide additional details, and these options may include one or more of: finish dozing (level cut), utility, general purpose, extended wear life (EWL), and extreme extended wear life (EEWL). As shown in FIG. 111, various tip options may be selectable to provide additional details, and these options may include one or more of: short centerline, intermediate centerline, long centerline, sharp centerline A.R.M., sharp limestone, short penetration, intermediate penetration, long penetration, and sharp penetration. In one aspect, selectable options may be presented on a left-hand portion of the additional information panel 11020, 11120, while features and benefits information may be presented on a right-hand portion of the additional information panel 11020, 11120.

### INDUSTRIAL APPLICABILITY

This disclosure is applicable to methods, systems, and user interfaces for identifying and validating compatible wear parts or components, and more particularly, to methods, systems, and user interfaces for identifying and validating compatible ground engaging tool parts for work machines.

For example, a work machine owner or operator may be interested in replacing a wear component of the work machine. However, due to passage of time or the work machine changing hands to new owners, original documentation listing the wear components may be lost. Furthermore, due to normal wear and tear on the wear component, part numbers that may originally be on the wear component may be lost or no longer legible. Due to the vast number of machine types, production generations, models, and configuration, equivalent or compatible replacement parts may be time consuming and difficult to identify.

In order to assist customers in identifying and validating compatible components, which may include GET parts, a parts validation and mobile sales application system may be employed to provide operators a simplified and efficient way for identifying and getting information on compatible components without relying on significant dealer support. The parts validation and mobile sales application may include computer instructions and/or a software application, such as a mobile software application, executable on the user device 130.

The user device 130, executing computer instructions, may receive inputs relating to the machine category, model, and/or attachment type. The received inputs may correspond with parameters of a particular work machine that the operator is seeking replacement parts for. The received inputs may be used as parameters for comparing and identifying relevant GET part entries which may be stored in the memory 135 of the user device 130, for example as parts data files, or may be retrieved on-demand from the server 120 by accessing the parts database.

The user device 130, executing computer instructions, may further receive filter inputs or attributes to narrow down relevant GET part entries. The filter inputs or attributes may be associated with a variable, tag, or status identifier provided with each GET parts entry and may enable the processor 131 of the user device 130 to sort and identify relevant GET part entries based on the received filter inputs or attributes. In one aspect, the user device 130 may provide graphical and/or textual information relating to the GET parts to assist the operator in identifying a compatible GET part. In one aspect, the filter inputs or attributes may enable the operator to identify physical attributes of their worn GET part. For example, the filter inputs or attributes may include a field for entry of a tip size or an edge thickness, which may be measured by the operator. By receiving details of the machine type, attachment, and/or GET part, the user device 130 may assist the operator in identifying and validating replacement GET parts directly without a third-party, thereby simplifying and speeding up the process. Furthermore, the parts validation and mobile sales application system may improve operator access to machine and parts information, thereby providing additional educational resources for the operators to make more informed choices in terms of finding the most ideal replacement part, particularly if there are multiple compatible parts available for a particular machine.

It will be appreciated that the foregoing description provides examples of methods, systems, and GUIs as implemented in a parts validation and mobile sales application system. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A method of identifying and validating a replacement part with an electronic device, the method comprising:
receiving, via an input of the electronic device, a first user data input including at least a work machine type;
retrieving, using a processor of the electronic device, machine attachment parts information associated with the work machine type in response to the first user data input;
displaying, using an output of the electronic device, the machine attachment parts information associated with the work machine type, wherein the displaying of the machine attachment parts information includes generating and showing at least one button representing at least one attachment part of the retrieved machine attachment parts information;
receiving, via the input of the electronic device, a second user data input based on a selection of one button of the at least one button representing the one attachment part;
retrieving, using the processor of the electronic device, ground engaging tool parts associated with the one attachment part in response to the second user data input; and
displaying, using the output of the electronic device, the ground engaging tool parts information associated with the one attachment part, wherein the displaying of the ground engaging tool parts information includes generating and showing at least one button representing one ground engaging tool part.

2. The method of claim 1, further comprising:
receiving, via the input of the electronic device, a third user data input including a physical attribute associated with the ground engaging tool information;
retrieving, using the processor of the electronic device, ground engaging tool parts having the physical attribute received in the third user data input; and
displaying, using the output of the electronic device, the ground engaging tool parts having the physical attribute received in the third user data input, the displaying of the ground engaging tool parts having the physical attributes includes generating and showing at least one button representing the ground engaging tool parts having the physical attribute.

3. The method of claim 2, wherein the third user data input, including the physical attribute associated with the ground engaging tool information, comprises one or more of a bucket width, a bucket edge thickness, a bucket capacity, a tip size, a cutting edge thickness, a number of shank holes, a shank width, a shank length, a shank tip size, a moldboard length, a motor grader bolt hole size, a moldboard cutting edge length, and a moldboard cutting edge width.

4. The method of claim 2, further comprising:
receiving, via the input of the electronic device, a fourth user data input based on a selection of the at least one button representing the ground engaging tool parts having the physical attribute; and
transmitting, via a transceiver of the electronic device, a quote or sales request based on the fourth user data input.

5. The method of claim 4, wherein the receiving the fourth user data input based on a selection of the at least one button representing the ground engaging tool parts having the physical attribute includes receiving a user selection of a request quote or purchase button.

6. The method of claim 4, wherein the transmitting includes sending information related to the ground engaging tool parts having the physical attribute associated with the fourth user data input.

7. The method of claim 1, wherein the displaying of the machine attachment parts information includes generating and showing a button for each attachment part of the retrieved machine attachment parts information.

8. The method of claim 1, wherein the displaying of the ground engaging tool parts information includes generating and showing a chart or list of a plurality of parts forming a package of parts.

9. The method of claim 1, wherein the first user data input comprises the work machine type and a work machine model.

10. The method of claim 9, wherein the work machine type is selected from the group consisting of excavators, track type tractors, motor graders, and wheel loaders.

11. An electronic device for identifying and validating a replacement part, the electronic device comprising:
an input unit to receive inputs from an operator;
an output unit to display information;
a storage unit or memory to store computer instructions; and
a processor coupled with the input unit, the output unit, and the storage unit or memory, the processor being configured to execute the computer instructions to:
receive, via the input unit, a first user data input including at least a work machine type,
retrieve, from the storage unit or memory, machine attachment parts information associated with the work machine type in response to the first user data input,
display, using an output unit, the machine attachment parts information associated with the work machine type, wherein the displaying of the machine attachment parts information includes generating and showing at least one button representing at least one attachment part of the retrieved machine attachment parts information,
receive, via the input unit, a second user data input based on a selection of one button of the at least one button representing the one attachment part,
retrieve, from the storage unit or memory, ground engaging tool parts associated with the one attachment part in response to the second user data input, and
display, using the output unit, the ground engaging tool parts information associated with the one attachment part, wherein the displaying of the ground engaging tool parts information includes generating and showing at least one button representing one ground engaging tool part.

12. The electronic device of claim 11, wherein the processor is further configured to:
receive, via the input unit, a third user data input including a physical attribute associated with the ground engaging tool information,
retrieve, from the storage unit or memory, ground engaging tool parts having the physical attribute received in the third user data input, and
display, using the output unit, the ground engaging tool parts having the physical attribute received in the third user data input, the displaying of the ground engaging tool parts having the physical attributes includes generating and showing at least one button representing the ground engaging tool parts having the physical attribute.

13. The electronic device of claim 12, wherein the third user data input comprises one or more a bucket width, a bucket edge thickness, a bucket capacity, a tip size, a cutting edge thickness, a number of shank holes, a shank width, a shank length, a shank tip size, a moldboard length, a motor grader bolt hole size, a moldboard cutting edge length, and a moldboard cutting edge width.

14. The electronic device of claim 12, wherein the processor is further configured to:
receive, via the input unit, a fourth user data input based on a selection of the at least one button representing the ground engaging tool parts having the physical attribute.

15. The electronic device of claim 14, further comprising a transceiver unit, and
wherein the processor is further configured to transmit, via the transceiver unit, a quote or sales request based on the fourth user data input.

16. The electronic device of claim 14, wherein the transmitting includes sending information related to the ground engaging tool parts having the physical attribute associated with the fourth user data input.

17. The electronic device of claim 11, the displaying of the ground engaging tool parts information includes generating and showing a chart or list of a plurality of parts forming a package of parts.

18. The electronic device of claim 11, wherein the input unit comprises one or more of a keyboard, a mouse, a touchscreen, a camera, and a microphone.

19. The electronic device of claim 11, wherein the output unit comprises one or more of display screen and an audio speaker.

20. The electronic device of claim 11, wherein the input unit is operable to receive data from a touchscreen display panel, and the output unit is operable to transmit data to the touchscreen display panel.
